(19) United States
(12) Patent Application Publication
(10) Pub. No.: US 2006/0184410 A1
(43) Pub. Date: Aug. 17, 2006

(54) SYSTEM AND METHOD FOR CAPTURE OF USER ACTIONS AND USE OF CAPTURE DATA IN BUSINESS PROCESSES

(76) Inventors: Shankar Ramamurthy, Saratoga, CA (US); Christopher W. Beall, San Jose, CA (US); Hitesh R. Shah, Santa Clara, CA (US); Rahul Saxena, Fremont, CA (US); Nagesh R. Vempaty, Piedmont, CA (US); Rajan Gangadharan, Cupertino, CA (US); Ravi Ramamurthy, Karnataka (IN); Chandrashekar Ramamurthy, Karnataka (IN)

Correspondence Address: SNELL & WILMER;ONE ARIZONA CENTER, 400 EAST VAN BUREN, PHOENIX, AZ, 85004-2202, US

(21) Appl. No.: 11/306,074

(22) Filed: Dec. 15, 2005

Related U.S. Application Data
(63) Continuation-in-part of application No. 10/748,970, filed on Dec. 30, 2003.
(63) Continuation-in-part of application No. 10/749,423, filed on Dec. 31, 2003.
(60) Provisional application No. 60/650,942, filed on Feb. 7, 2005.

(51) Int. Cl. G05B 19/418

(52) U.S. Cl. 705/8

(57) ABSTRACT

Systems and methods are disclosed for capturing data representative of user interactions with a desktop computer, and processing the capture data to identify and analyze business processes performed by the user. The disclosed system comprises listeners that capture key actuations, mouse-clicks, screen information, and other data representative of user interaction with a desktop computer. A desktop observer is provided to accept capture data from listeners, to temporarily store the capture data if necessary, and to pass the capture data to a process intelligence server. The process intelligence server includes a process discovery module the analyzes the capture data and identifies business processes corresponding to the capture data, or models business processes. A process data master storage is provided. A process analysis module is provided to determine performance metrics, best practices, application productivity impacts, compliance, and optimization analysis on the data stored in the process master storage. Methods are disclosed for capture, catalog, combination, correlation, change, compression, and certification.

### CROSS-REFERENCE TO RELATED APPLICATIONS

This application claims the benefit of the filing date of patent application Ser. No. 10/748,970, filed Dec. 30, 2003, entitled REMOTE PROCESS CAPTURE, IDENTIFICATION, CATALOGING AND MODELING, which is incorporated herein by reference in its entirety, patent application Ser. No. 10/749,423, filed Dec. 31, 2003, entitled AUTOMATIC OBJECT GENERATION AND USER INTERFACE TRANSFORMATION, which is incorporated herein by reference in its entirety, and provisional patent application Ser. No. 60/650,942, filed Feb. 7, 2005, entitled A SYSTEM AND METHOD FOR CAPTURING AND INTERVENING WITH USER INTERFACES, which is incorporated herein by reference in its entirety.

### COMPUTER PROGRAM LISTING SUBMISSION

Text files are submitted herewith containing computer program listings, and the entire contents of the computer program listings are incorporated herein by reference in their entirety. The files are named as numbered Tables, and correspond to Tables referenced in the detailed description herein. The text files are specified as follows:

| Name | Size in Bytes | Date of Creation |
|---|---|---|
| Table 1.txt | 4 KB | Dec. 14, 2005 |
| Table 2.txt | 8 KB | Dec. 14, 2005 |
| Table 3.txt | 6 KB | Dec. 14, 2005 |
| Table 4.txt | 134 KB | Dec. 14, 2005 |
| Table 5.txt | 4 KB | Dec. 14, 2005 |
| Table 6.txt | 2 KB | Dec. 14, 2005 |
| Table 7.txt | 4 KB | Dec. 14, 2005 |
| Table 8.txt | 3 KB | Dec. 14, 2005 |
| Table 9.txt | 5 KB | Dec. 14, 2005 |
| Table 10.txt | 3 KB | Dec. 14, 2005 |

### TECHNICAL FIELD

The present invention relates, generally, to methods and systems for the measurement and improvement of business processes, and specifically to software that can capture user actions on a computer, analyze them, and automatically generate improvements or assistance.

### BACKGROUND ART AND TECHNICAL PROBLEMS

Businesses and other enterprises often do not have an accurate picture of how their business processes operate. It takes too long for a business to find and fix process problems. As a result, most businesses face problems every day in their core business processes, such as customer service, that are difficult to identify and then devise solutions to improve the business process. Losses from business process problems may be far reaching, although the full extent of such losses may not be known to a business that cannot accurately assess the extent of the problem in the first place. Inefficient and ineffective business processes can irritate customers, grind down employee morale, and exasperate investors.

When a business found a problem and tried to fix it, they usually found that their process improvement team or external team of experts would take time to define the problem, design the fix, develop, and deploy the changes. The wheels of process improvement would grind slowly.

The effective management of business processes leads to strategic advantages as well as desirable gains in productivity, customer satisfaction and time to market. The value of continuous business process improvement has been driven home by the ascendance of manufacturing companies who had spent decades to hone quality management and continuous improvement practices to create world-beating manufacturing enterprises. Businesses in every industry across the world are continuing to invest in process and quality improvement both to keep up with the competition and to create competitive advantage.

Business enterprises that gain control of their business processes may gain a strategic advantage. This advantage comes from both their ability to run business processes efficiently and their ability to improve such processes so as to have such processes continue as a source of competitive advantage. The value of improvements to business processes can sometimes translate into increased profitability. Some estimates suggest that manufacturing companies can realize billions of dollars in incremental operating margin from improvements in their supply chain processes alone. Enterprise process improvement may produce business results in the form of increased throughput. For example, in a large telephone call center, one minute saved per call may in some instances result in $1 million saved over a year. Enterprise process improvement may reduce errors. For example, at a manufacturer, a 3% increase in order accuracy may in some instances result in a 1% increase in profit margin. Enterprise process improvement may reduce cycle time. For example, in an insurance company, a 12% reduction in underwriting cycle-time may increase the number of applications processed by as much as 60%.

Process improvement may be seen as a mechanism to close the gap between the current operations situation and a possible better situation. In addition, situations change as business changes. For example, the industry may change, regulations change, customer demands change, and the organization changes. Business changes constantly, so business processes need to adapt accordingly. Problems crop up like weeds, and new opportunities beckon. As a business insensibly adapts, “as-is” becomes “as-was”; the process documents become obsolete and the business is again left with no accurate picture of how its business processes currently operate. Continuous or repeated efforts are required to close the gap. A business needs to make rapid process changes, but the business runs up against chronic business process improvement problems.

In the past, the specification of the business process was difficult. Good process documents would rely upon extensive and detailed observation of the business processes. However, this was often difficult because in many cases the business activity consisted of rapid-fire typing into one computer screen after another, faster than the eye can see. The documents might not be right to start with due to deficiencies in data collection and analysis. In addition, the documents would become out-of-date as the business process evolved, policies were changed, applications were updated, and people used different ways of working. Often work would rarely be done exactly as documented. If a business cannot specify processes correctly, it cannot manage them. Specifications are used to check if the applications that automate the process are correctly configured, and to inspect the process instances to drive effective behavior from its users and managers. Such inspection is particularly important where the process needs to be tightly controlled, either for external reasons such as a financial-reporting control point or for competitive advantage.

In the past, automation was difficult. Many process improvement projects result in the deployment of additional IT infrastructure to automate the business process. Soon after the deployment, a business would find that the as-designed business processes differ from the as-is process realities. The application portfolio would often be out-of-synch with the actual business requirements. The IT portfolio mismatch would often show up in costs incurred to maintain unused applications and licenses and also in the demand for additional expenditures on IT to address unmet business needs. After applications are deployed, the greatest source of value is to have every employee use the application portfolio in the most effective “best practice” manner. This source of value is rendered inaccessible if a business cannot see if the best practices are being followed. In addition, a business needs to quickly find and exploit the emerging “next practices” that come from employee creativity in finding better ways to use existing systems.

In the past, visibility was difficult. If a business did have process reports, they would often be refreshed daily, weekly or monthly—not often enough to provide a business with the up-to-date information it needs. In addition, the reports would not drill down to the level where it was possible to see the underlying human activities that led up to a metric. Managers concerned with gaining process visibility faced a disjointed and highly dispersed set of processes executed in field offices, at back-office locations, and by outsourcers. Existing process specifications had to be reviewed and revalidated before they could be used as standards against which to inspect process performance and provide visibility into compliant or non-compliant behavior. If a business cannot track process performance, it will lose valuable time before it can find process problems and opportunities. As a result, a business would lose money every day from missed opportunities to reduce cycle time, increase throughput, reduce errors, and increase asset utilization. Legal regulations that require companies to monitor business processes would result in the implementation of monitoring practices that added cost through expensive manual compliance mechanisms.

In the past, achieving effective control was difficult. Process control features are rarely found in business processes. It is desirable to provide the ability to re-allocate work between work centers, re-prioritize work queues in a work center, assign work to individual performers or teams, and deliver new work instructions with each work item so that workers have the best practices for their work assignment available at their fingertips. New processes should be cut-in to production without disruption. In contrast, most managers find that any change to the process, allocation, priority, assignment, or work instructions would require them to go through a painful “process change” project cycle. If a business cannot control a process without going through a “process change” project cycle, the cost of process improvement is unnecessarily high. Project cost itself is high and is compounded by opportunity costs from delay in addressing the opportunities that do not justify the execution of a project cycle. When a project does get funded, it is loaded up with all the opportunities that queue up in the backlog, resulting in scope bloat that further drives project cost and risk.

In the past, time-and-motion studies have been used by businesses to obtain data on their business processes. This would involve a researcher looking over the shoulder of an employee with a stop watch and making observations of the employee's work activities. Such methods are expensive and time consuming. At best, it was done on a sporadic basis and by sampling employees who were assumed to be representative. Old manual time study methods also ran in a slow cycle, and significant delays could occur between the recognition of a problem, and the design and implementation of improved business processes to solve the problem.

In the past, business process improvement approaches were time-consuming and expensive. The design and deployment of process improvement using prior art approaches required a company to engage experts for each project. Process improvement teams would typically consist of (a) business analysts or business architects, who used process improvement methods such as Six Sigma, Lean, Business Process Reengineering, and Theory of Constraints; (b) information technology application specialists with expertise in business applications such as ERP/CRM (like SAP, Oracle Applications, or Siebel), BPM/EAI (such as IBM WebSphere or TIBCO), Service Oriented Architecture, and Business Intelligence; (c) information technology infrastructure specialists with expertise in hardware, networks, printers, application deployment, and information technology operations management; and (d) business managers, training experts, project managers, financial analysts and other key contributors. Projects would typically take months to complete. Each project would typically require weeks of analysis followed by process design, development, and deployment via user training often accompanied by changes to software, hardware and network infrastructure. Such approaches were expensive, because they would involve using several process experts, business-users time, and information technology expertise deployed over a period of months. In the absence of automation for the process improvement cycle, the process experts would typically work slowly and painstakingly to develop an accurate picture of the as-is situation, the to-be state, and the mechanisms to make the required changes.

Significant problems had to be solved in order to achieve automation of data capture and process improvement methods in accordance with the present invention. Although prior art software might have been able to record that a user of a computer clicked on a location on his or her screen that was 52 pixels from the top and 293 pixels from the left, it is desirable to identify what the user was actually doing when he or she clicked on any given position of a graphical user interface. For example, it would be important to know that the user was clicking on a button displayed on a graphical user interface that indicated a “yes” response to a question in a Microsoft® Word® word processing program when the user was asked if he or she wanted to close a document without saving it. The identification of the screen that a user had active and was using when the user had some interaction with the computer work station, and the identification of any value attached or associated with such screen, presented a technological problem that the prior art failed to adequately solve in the context of the present invention.

Another technological problem in the prior art was the inability to achieve contextual intervention with a user from a context outside a particular application. For example, it is important to be able to analyze what a user was doing across multiple software applications, and to be able to intervene with help or other appropriate actions based on the context in which the most current user interactions with the computer occurred.

Process identification by example represented yet another technological problem in the prior art. A given business process can involve several software applications and a number of different people. It is desirable to be able to define a process by example based upon information captured from one or more users' interaction with their computers. It is also desirable to have the capability to learn by example to automatically identify the business process that any user was engaged in at any particular time. It is desirable to be able to automatically determine that a pattern of user interactions is an identifiable business process, using data captured from a standpoint that is outside of a particular given software application or which spans several different software applications. A business process may include the simultaneous use of more than one software application which might not necessarily be related to each other, and may involve multiple users or employees who play a role in the process. For example, an order to ship business process might involve order entry by one user at a call center in a customer relationship management system, such as Siebel, and the shipment may be performed by a different user in a manufacturing resource planning system such as Server Application Programming (“SAP”).

An example of a desirable multiple application business process that could be improved might be a user who was using an inefficient method of re-typing addresses into a word processing program from a database program containing customer contact information. If such an inefficient business process could be detected and identified, the business process utilized by that user might be automatically improved by presenting the user with a pop-up window that provided help on how to export addresses from the customer database into the word processing program.

In the past, workflow management tools and business process management tools often used a predefined workflow model. A workflow model was defined in the tool to represent a business process. The tool would monitor the flow of work in a process instance by using a predefined model. Examples of such tools include TIBCO Staffware, TIBCO Business Works, IBM Flowmark, and Filenet Workflow. Business process monitoring tools and business activity monitoring tools might also work with workflows and messages in software applications to gather activities or events on a messaging bus. Such tools might enable monitoring and analysis by dimensions such as time, but were limited in that they only monitored messages on a messaging bus workflow management tool or business process management tool. TIBCO Business Activity Management and IBM Holosofx are two examples of such tools. In the past, electronic data interchange tools had the capability to monitor and manage files that were transferred between users and files stored data associated with transactions between users. Sterling Commerce GIS and Inovis Biz Manager are examples of such tools. Electronic data interchange tools only monitored electronic data interchange files being transmitted.

Prior art tools were limited to dealing with a single category of events contained in a priori knowledge of the actual flow of processes. The prior art was limited to predetermined flows and predetermined processes.

Although improvements in process improvement methods such as Six Sigma, Lean, BPR, might make business analysts more effective, they would only incrementally reduce the costs and cycle-time of process improvement. Prior art business process management systems may provide some analysis and control features that would reduce the cycle-time of business process improvement; however these efforts are restricted to occur within the domain of the business process management system.

Most business processes involve human agents using numerous IT, software and Internet applications, typically on desktop and laptop computers but also increasingly with handheld, mobile, body-wear or body embedded devices. This class of business processes may be referred to as IT enabled business processes, as opposed to business processes performed almost completely automated—such as a credit card's increase of credit limits. Businesses have a high level description and partial documentation of these processes. This serves the purpose to the extent that humans can perform these processes based on i) training and documentation, ii)supervisory or expert guidance, iii) work-arounds, and iv) experimentation, trial and error, v) non-completion or non-performance of process. Also there is an inbuilt fault tolerance when errors are made: v) human remediation or vi) losses sufferable.

There are key limitations (progressively more expensive, difficult and time consuming) with the current regime of operating, managing and improving business processes.

First, there is no automatic way in which one can consistently determine exactly the process performed by one or more humans—unlike with fully automated processes. Hence the potential to ascertain actual economic elements such as process cost, wastage, inefficiency, performance, compliance and consistency, customer experience is limited by manual methods and their approximation. Ergo, potential to improve on any of these fronts is severely limited by invisibility of the factors that govern these economic elements. This represents the next horizon for economic improvements to be sought by businesses and the bases and techniques to achieve them are not available.

Second, as new methods of performing business processes, IT applications, and Internet applications used to perform business processes are evolved, there is no way to consistently and automatically represent the change and the constituents of the change—unlike with a completely automated process changed by another in its place. Hence potential to ascertain the impact of any change in terms of the above economic elements is limited. Ergo, potential to make changes or optimize decisions regarding change based on economic factors is severely limited by invisibility of the factors that govern these economic elements. A new method of performing a business process may either substitute an IT enabled process with an automated process, another IT enabled process or a manual process; or an automated process with an IT enabled process or manual process. In each case the precise change will need to be documented in a fashion that can be consistently recognized and precise comparison conducted on a before and after basis.

Third, the problem of consistent and automated understanding of process is vastly exacerbated in multi-enterprise business process - when business processes cross enterprise boundaries, or when two or more enterprises merge. Hence potential to ascertain the economic elements of multi-enterprise business process or their change, or the impact of improvement or the ability to optimize is severely limited. In addition, there are severe limitations imposed on enterprises to autonomously perform improvements to a multi-enterprise business process. Businesses seeking to polarize the performance of their business process chain through their customer and supplier/partner organizations can do so only by virtue of their preexisting economic clout.

The essence of complexity in IT enabled business processes is their vast variability, and their impromptu, unpredictable and continuous invention. People often come up with business processes unnoticed to solve a problem.

It is desirable to have a capability of capturing information concerning a user's interaction with his or her computer work station that is substantially independent of a particular software application. This would avoid the need to write custom interface software for each particular third-party software application, which might require modification each time the third-party software was modified, upgraded, or otherwise changed or revised. It was desirable to utilize an available software API to facilitate data capture of a user's interactions, so that custom API's would not have to be provided for each vendor's software applications.

Another technological problem addressed by the present invention is the need to thread together events that refer to common data across multiple users and multiple applications.

Yet another technological problem in the prior art was the need for an effective web observer that is capable of determining what a user did on a given web page, and not just what links he or she clicked.

While time-and-motion studies have been used by businesses for many years, efforts in the past to provide data capture and business process improvements have not been altogether satisfactory. The piecemeal use of software applications to assist in such efforts failed to offer a comprehensive solution for business process improvement. There is a significant need for improved methods and procedures for systematic data capture and automatic determination of business process improvements which overcome some of the problems with the prior art methods and procedures. There is a need for a system that overcomes some or all of the technological problems described above.

There is a need for a system that can rapidly locate opportunities to find and fix process problems, to reduce cycle time, increase throughput, reduce errors, and increase capacity utilization so that a business can profit from process improvement on a fast and continual basis. There is a need for a system that can find and attack process problems caused by shortfalls in process specification and automation, as opposed to a bottom-up approach that could expend effort in non-productive pursuits. There is a need for a system that can provide a mechanism to track the uptake of process control actions and to adjust them as necessary. A process visibility system needs to provide enterprise-scale observation and process analysis down to the detailed level of human activity across the existing enterprise application portfolio of legacy applications.

There is a need for an automated tool to find opportunities and improve business processes that can be used to improve productivity and reduce project cycle time. Business applications and business process management systems would benefit by getting detailed and unambiguous specifications for business process automation. The process-monitoring or event-publishing features of these applications could be married to observations of human activity to provide a detailed and complete visibility into as-is process performance—a picture that could be mined to locate opportunities for improvement. Process control would allow managers to gain value from “best practice” usage of the applications by people. Automated process visibility and control would put the power of continuous process improvement in the hands of business managers. They would get a tool with which to take actions to find and address opportunities rapidly. In addition, better process visibility would serve to align the efforts of existing process improvement teams to align clearly with the business requirements. There is a need for a process control system that could locate and promulgate “best practices” for process execution across the user population involved in a business enterprise.

It is desirable to have a system or method for the automation of business process improvement that provides visibility into metrics and benchmarks with which to guide process management, and that provides managers with tools for continuous process improvement. With the present invention, it has now become possible to automate the continuous assessment of as-is performance, continually run analytics to find opportunities for business process improvement, and rapidly design and deploy process changes.

### SUMMARY OF ADVANTAGES OF THE INVENTION

The present invention provides a fast-cycle enterprise process improvement solution that overcomes prior art deficiencies associated with business process improvement methods and practices. In accordance with the present invention, automated observations of process activities in business applications are performed, and the data collected from such observations is used to conduct automated analysis of current business process performance on a substantially continuous basis. Information collected in accordance with the present invention may be used by managers to identify bottlenecks in business processes, to implement corrective action, and to ensure ongoing compliance with the improved business processes.

The present invention facilitates relentless observation of users and employees involved in the execution of business processes. A system in accordance with the present invention automates the effort required to observe worker activity, web-site users, and business applications to create a detailed record of all business process events. A system in accordance with the present invention can observe every user action on every application screen, delivering as-is process reports with unprecedented accuracy. A system in accordance with the present invention can observe business processes at this level of detail for thousands of people, across globally dispersed locations, in every application at all times. It replaces time-and-motion studies trying to keep up their stopwatch observations with fast-typing end-users. It replaces sampling and guesswork with comprehensive facts at the scale needed for effective process improvement.

The present invention allows a business to know how its business processes are running by providing current, continuously updated process visibility reports and alerts that show process performance with the ability to drill-down to the user-activity detail, by providing a comprehensive audit trail of each process participant's activity on a step-by-step basis, by providing individual users with the feedback they need to improve, and by providing objective performance metrics and comparisons with benchmark performance and peer-group performance.

By continually tracking process performance, the present invention enables a business to find process problems and opportunities, even where processes span multiple people and execute across many non-integrated applications.

The present invention allows a business to make scientific decisions based upon reliable data. A business may locate best practices from all relevant process performance instances. A business may assess the impact of changes such as adding overtime, increasing prices, etc., on business process capacity needs. A business may make optimal decisions regarding application rule changes, flow-definition and queues with on-line tools. A business is enabled to act fast and accurately with business process improvements.

A system in accordance with the present invention can facilitate pushing updated policy instructions, process flows and cheat-sheets or cue-cards to users just-in-time to help the users navigate business processes that have changed or that are unfamiliar to the users. In addition, a business is enabled to monitor, validate, and enforce process changes.

The present invention allows a business to take advantage of more opportunities, small and large, to ratchet up process performance. Measurement of results is immediate and factual, letting a business continuously correct and fine-tune process changes. This increases opportunities to profit from reductions in cycle time, increased throughput, reduction in errors, and increased asset utilization.

A system in accordance with the present invention can identify the active screen associated with a user interaction with a computer workstation, and can identify a value attached or associated with the screen or user action. For example, a determination can be made that the user clicked on “no” on a pop-up window in a particular identifiable screen associated with a particular application.

A system in accordance with the present invention can perform contextual intervention with a user, and can do so based upon a context determination that may be outside the environment of a particular application. With the present invention, it is possible to analyze what a user was doing across multiple software applications, and to intervene with help or other appropriate actions based on the overall multiapplicational context in which the user's interactions with the computer occurred. For purposes of this application, the term “multiapplicational context” used with reference to contextual intervention refers to an environment involving a plurality of software applications that may not be integrated, and which may be produced by unrelated third-parties, and which may be running on a network or on a user's workstation or personal computer, or both.

The present invention can perform process identification by example. In accordance with the present invention, a process can be defined by example based upon information captured from one or more users' interaction, and based on multiple software applications that are not integrated. A system in accordance with the present invention can learn by example to automatically identify the business process that a user was engaged in at a particular time. It is possible to automatically determine that a pattern of user interactions is an identifiable business process, using data captured from a standpoint that is outside of a particular given software application or which spans several different software applications. A process identification rule may be made in the form of a finite state machine description.

In accordance with the present invention, available software APIs are used to facilitate data capture of a user's interactions with a computer. Windows® messaging hooks may be used for data capture. Programming hooks provided for accessibility features for the handicap may be utilized as an API for data capture of user interactions in accordance with the present invention. In the present invention, Computer Based Training (“CBT”) hooks may be used as an API for such purposes. The invention offers the a capability of capturing information concerning a user's interaction with his or her computer workstation that is substantially independent of a particular software application. It is unnecessary to write custom interface software for each particular third-party software application.

A system in accordance with the present invention provides a capability to thread together events that refer to common data across multiple users and multiple applications.

A system in accordance with the present invention provides an effective web observer that is capable of determining what a user did on a given web page, and not just what links he or she clicked. Javascript may be embedded in a web page to provide statistics on user interaction with a web page that goes beyond user clicks on links.

In one aspect of the invention, human interactions with software applications running on a computer or workstation are captured and extracted remotely in the form of extensible markup language (“XML”) scripts as the user is performing tasks. The XML scripts of the process are representations of human interactions with the software application at a level of specificity and detail such that the XML script can be streamed back into the application software and thereby masquerade as a human operator performing the process. The capture and modeling can be accomplished for just one software application or for several applications, and capture and modeling can be accomplished for one user or several users. Alternatively, captured data relating to a business process may be stored in Business Process Modeling Language (“BPML”) format, and can be exported to other formats as well. Data stored in an XML file format may be translated to the BPML format by conventional translation software.

According to another aspect of the invention, one embodiment of the invention creates virtual footprints in the software application to serve as a real-time context determination, in the form of context points, that identify when the user is interacting with the software application. The virtual footprint identifies where in the software the user has been so that the steps being taken by the user may be identified and the items being performed placed into context. The virtual footprints and context points are used in the present method for the process capture and modeling, and may also be used by third party systems or in other software, processes and systems to integrate disparate systems and content and to fuse knowledge into processes based upon a user's specific goal. The context capture may also use “listeners”, which monitor and record communications between components of the software and/or the operating system.

Another aspect of the present invention provides that audio and/or video recordings are made to capture activities, such as the activity of the user and others, that are not directly the result of interacting with a software application on the computer or workstation. For example, the telephone discussions by the user, meetings in which the user participates and physical activities by the user in performing the tasks may be captured, preferably as XML components or elements to contextualize the relevance and relationship of a user's interaction with a software application being used in connection with a business process. The recording preferrably includes context markers and time stamps to aid in matching and synchronizing different recorded portions with other captured data. This capture of the manual elements of the user's process may also use other recording and/or capturing measures in addition to or in place of the audio and/or video recording.

XML scripts representative of captured data concerning associated user interactions are stored in a repository. In a preferred embodiment, the repository may be an enterprise specific database. The processes can be reviewed, edited and enriched, for example, using a presentation software, such as Microsoft® PowerPoint® software to display the process information. The display of captured process information may be in a self-organized hierarchy with self-created text in any desired language. The presentation system may also display related annotations, images and graphics of the user and the application interactions combined with the captured audio and video data of the activities surrounding and relating to the user interaction or process. A presentation system may be used to present together all of the captured data relating to a business process, no matter how captured or in what form.

In yet another aspect of the present invention, data relating to captured processes may be used to model existing business processes, sometimes referred to as “as is” processes. Such data may also be used to develop modified or improved business processes, sometimes referred to as “to be” processes. The modeling provided in accordance with the present invention allows multiple levels of the processes to be modeled. The processes can be linked to other external process models at various levels.

In accordance with the present invention, specific processes may be extracted automatically as a user performs various operations. In a preferred embodiment, process definition is a rule based XML process standard. Process definition is applied to remotely captured files so as to yield details of the processes that are being performed by the user.

A comparison or benchmarking may be performed between business processes. For example, best practices may be compared with either the “as is” processes or the “to be” processes. Current practices of a particular user may be compared with either an “as is” or a “to be” processed. Other comparisons or benchmarking may be performed as well.

A remote administrator may be used to determine capture settings for the process to be captured. In particular, the administrator may be used to determine what to capture, what not to capture, and when to capture the processes. The remote administrator may be linked to the capture site by a network or any other suitable communication path. The administrator may set the capture settings in real time or just prior to the process capture, or preferably well in advance of the capture. It is also within the scope of the present invention that the administrator may be local to the capture site, or to at least one of a plurality of capture sites.

A cataloging of the processes is performed automatically. The cataloging is performed by pattern matching between the processes being performed by the user and the process definition. A match in the patterns results in an identification of the process. After cataloging, the process is available for analysis and modeling. For example, the cataloged processes are preferably made available on a server. The information on the processes is preferably automatically uploaded to the server.

In a preferred embodiment, the processes that are currently in use are identified or determined. The present invention analyzes the performance of the processes, and may be used to develop a best practice processes, develop “to be” processes. The present invention provides a capability of benchmarking the performance of “to be” processes against best practices.

The present invention is used by users of various categories, including users whose actions are to be captured as input for further analysis and modeling. Examples of users include employees of a business or organization, members of internal departments of a business or organization, users in partners of a business or organization, customers or users employed by customers of a business or organization, etc. In this way, the business or organization can track the processes and the changes thereto not only within the enterprise but also its effects outside the enterprise. The users may be users of the above-noted applications and operating systems, although it is of course possible to apply the present invention to other applications and operating systems. Analysts also use the present invention, in particular the process modeler and analyzer, to develop the “as is” and “to be” processes and the best practice models based on the captured processes of the users. An administrator also is involved in the operation of the present system, and defines the capture parameters, including whom to capture, when to capture, what to capture and what not to capture.

A system or method in accordance with the invention helps to capture event information from a variety of sources in a variety of formats. It can work with no a priori knowledge or a partial knowledge of processes being executed. It reconstructs process trails by correlating one or more types of observed events. The data obtained from an event observation includes one or more of time, date, location, origination, destination, user, business, etc. It can operate by being trained on examples or by learning from example instances or by preprogrammed behavior of process flows.

### SUMMARY OF THE INVENTION

In accordance with an exemplary embodiment of the present invention, a system and method for capturing data indicative of user interactions with a computer workstation, and a system and method for improving and optimizing associated business systems based upon the analysis of such captured data, are provided.

A core capability of the present invention includes two pieces. First, the present invention includes the employment of a universal and objective standard of a process unit as composed of interactions with a field within a screen, or a data item, or a set of keystrokes and mouse-clicks. The process unit is described as that collection and sequence of component parts that is consistently machine verifiable and can describe every IT enabled business process by merely repeating themselves or other process units. This in turn allows large scale universal classification and cataloguing of processes, that may be called a Universal Bill of Process, to help multi-enterprise business processes autonomously drive value. Second, the present invention performs the collection of such component parts of business processes automatically, and performs others in a highly automated manner making it possible to simultaneously handle extremely large volumes of data and reducing them to their essence without loss of reliable representativeness of complex business processes.

The present invention presents a method of systematically performing Capture, Catalog, Combination, Correlation, Change, Compression, and Certification of business processes in a fashion that can overcome the above mentioned limitations. The first three take data from the wild and refine them, while the last three make use of that understanding to create business applications. Correlation links the two. Each of these components may be described in more detail.

Capture—All physical observations relating to IT enabled business processes, and extendable to other automated methods of observing human or other “mechanical” activity, extracted at a level of detail where objective equivalence or precise difference between any two sets of observation can be automatically established. They include time stamps, specific interaction with field in a screen, keystrokes/mouseclicks, or manual activity for each interaction, semantics of the screen, controls and other visually observable data, system events in response to interaction, back end data sniffing from network, middleware and databases.

Catalog—Extracting patterns from Captured information, catalogs of all screens based on patterns of screen signatures, catalogs of virtual screens that represent the controls and fields actually used for different processes, catalogs of process units, catalogs of process behavior constructs—analyst evolved. A catalog is a frequency distribution of instances.

Combination—Combination is done with catalogs using combinatorial and sequence sets (that is a set consisting of different catalog combinations, occasionally permutations, and a sequences of these sets). “Combination” of process units would mean mapping process units to a business process used in process modeling or business conversations (such as creating a new purchase order for EDI transmittal). “Combination” of screens would mean mapping a screens to business process used in process modeling or business conversations.

Correlation—Correlation represents the act of constructing a bill of process from Combinations above as well as the act of extracting ongoing Capture to determine which and where in the thread of a bill of process a user is engaged in (context determination). Correlation maintains BOP integrity as BOP undergoes ongoing Change, new processes are discovered, or processes undergo “compression” and “certification”, and maintains integrity with different BOP views adopted such as reference BOP or a benchmark BOP as useful subsets of the Universal BOP. Correlation also allows to compare two different processes (whether benchmark related or actual representations of two isotope processes in different organizations, or parts of organization)

Change—Change represents new process that substitutes an existing piece of a bill of process. This may be a simple change in process, change in process due to change in underlying software or system application or vice versa, introduction of a new set of processes, or sunsetting some processes in a merger/acquisition of businesses.

Compression—Compression represents discovery of opportunity to compress work done from observed work (through Capture), essentially through automation, using external programmatic methods as well as native automation of repetitive activity.

Certification—Certification for Compliance uses observed deviations from established benchmark or reference process to report or alert the deviation, and help business processes gain certification for compliance.

One embodiment of the invention comprises a method of uniquely identifying screens displayed on a user workstation while the user is interacting with various applications, and associating such screens with capture data or business processes that are defined based upon patterns in the capture data.

One embodiment of the invention comprises a method of providing contextual intervention to a user by comparing a screen ID with a map of content corresponding to a predetermined context associated with such screen.

Another embodiment of the invention comprises a web observer implemented by embedding ajavascript in a web page that captures user interaction data including information concerning a user's navigation inside a web page that will not be contained in a web server log.

### BRIEF DESCRIPTION OF THE DRAWINGS

The present invention will hereinafter be described in conjunction with the appended drawing figures, wherein like numerals denote like elements:

FIG. 1 is block diagram depicting components of a preferred embodiment of the present invention;

FIG. 2 is a block diagram showing details of process capture according to a preferred embodiment of the present invention;

FIG. 3 is a flowchart for the operation of a desktop observer;

FIG. 4 is a block diagram showing details of software components that run on a user's desktop computer;

FIG. 5 is a block diagram depicting components of a preferred embodiment of the present invention;

FIG. 6 is a block diagram showing details of a preferred embodiment of a process intelligence server;

FIG. 7 is a schematic illustration showing the life cycle of the data that has been captured during the capture portion;

FIG. 8 is a branching block diagram showing an instance of a process to be captured and modeled;

FIG. 9 is a block diagram showing relationships between levels of abstraction in the process model;

FIG. 10 is a is a block diagram showing the process analysis and modeling of the present invention;

FIG. 11 is a block diagram of utilization of modeled process with a user;

FIG. 12 is a table of the information captured while a user is interacting with an application, showing the workflow header information;

FIG. 13 is a table of the information captured while a user is interacting with an application, showing the a first portion of the basic step information;

FIG. 14 is a table of the information captured while a user is interacting with an application, showing the a second portion of the basic step information;

FIG. 15 is a flow diagram of a sample process according to the present invention;

FIG. 16 is a flow diagram of a sample process according to the present invention;

FIG. 17 is a flow diagram of a sample process according to the present invention;

FIG. 18 is a schematic diagram showing the relationship of the present method in the operation of a company;

FIG. 19 illustrates a decision tree depicting considerations for selecting a preferred implementation of a user desktop component;

FIG. 20 illustrates a hierarchy for listeners used for observation and event collection in accordance with the present invention;

FIG. 21 is a screen shot of an example screen to illustrate how a screen can be uniquely identified in accordance with the present invention;

FIG. 22 is a chart depicting an approach to contextual intervention in accordance with the present invention;

FIG. 23 is a screen shot of an example screen to further illustrate how a screen can be uniquely identified in accordance with the present invention;

FIG. 24 is a schematic diagram of the infrastructure of a desktop agent in accordance with the present invention;

FIG. 25 is a block diagram depicting elements of the Tapestry, Spring, and Hibernate components;

FIG. 26 is a block diagram that illustrates synchronization of manual and computer tasks;

FIG. 27 is a block diagram of an additional embodiment of a computer network system;

FIG. 28 is a flowchart of an example of a process for correlating events by time;

FIG. 29 is a flowchart depicting an example of a monitoring process using correlated data;

FIG. 30 is a flow chart of an example of a process for pruning unlikely matches to improve performance and storage requirements;

FIG. 31 is a block diagram showing data capture according to an alternative embodiment of the present invention;

FIG. 32 is a block diagram of a process development environment;

FIG. 33 is a schematic illustration of different levels of data capture;

FIG. 34 is a functional block diagram of a process capture, identification, cataloging and modeling system according to the principles of the present invention;

FIG. 35 is a block diagram showing data definitions;

FIG. 36 is a block diagram illustrating data relationships and hierarchy;

FIG. 37 is a flow chart for a method of screen activity identification;

FIG. 38 is an example of a graphical display of capture data;

FIG. 39 is an example of an alternative graphical display of the capture data displayed in FIG. 38;

FIG. 40 is a graphical display of capture data taken from FIG. 39 but limited to data related to a single application;

FIG. 41 is a graphical display of certain capture data of interest shown in FIG. 40;

FIG. 42 is a detailed graphical display of certain capture data shown in FIG. 41 with identifying information displayed for individual screens or nodes; and

FIG. 43 depicts the graphical display shown in FIG. 42 with certain nodes highlighted.

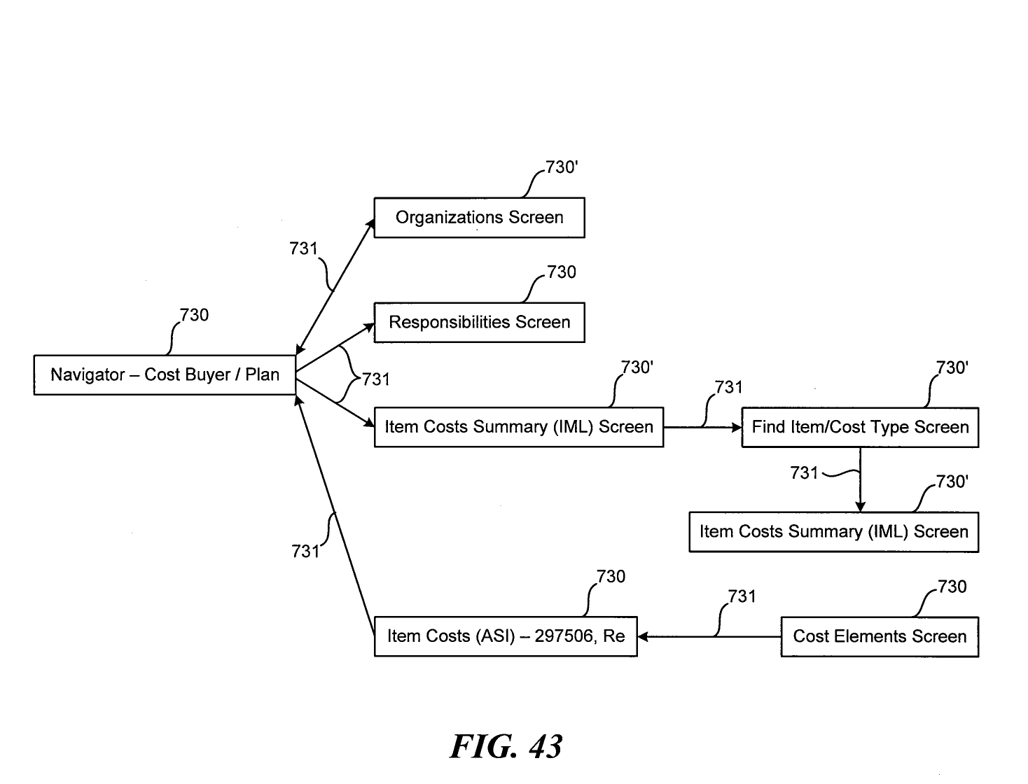

### DETAILED DESCRIPTION OF PREFERRED EXEMPLARY EMBODIMENTS

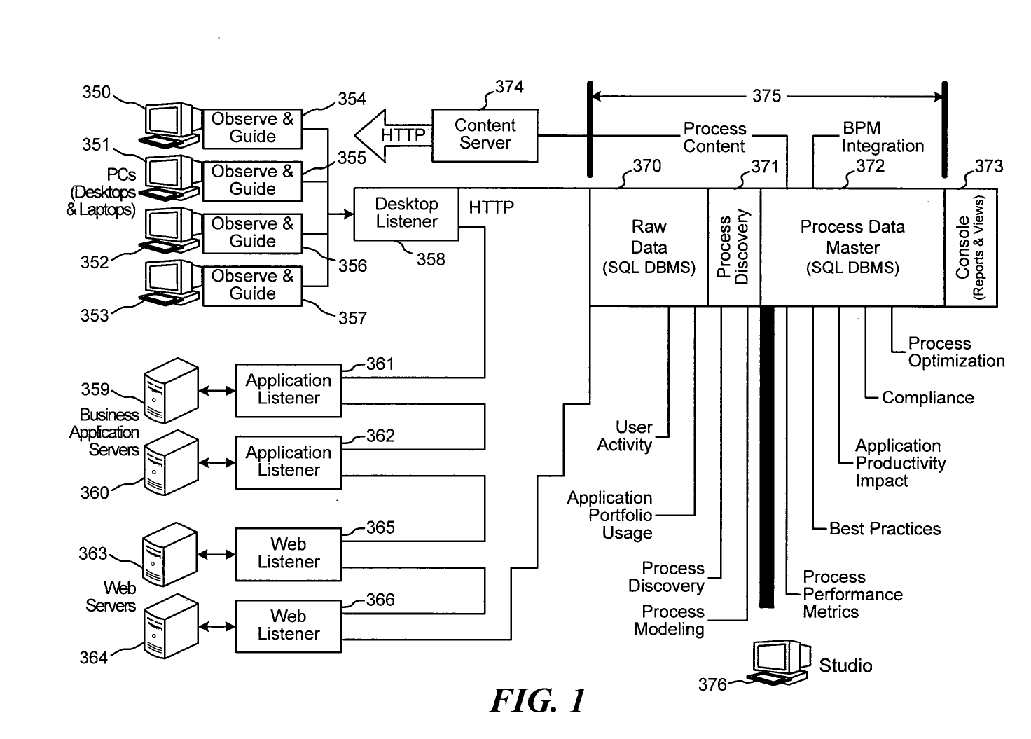

FIG. 1 shows a block diagram of a preferred system architecture. User workstations 350, 351, 352 and 353 have software agents 354, 355, 356 and 357 installed or downloaded onto the desktops or laptops. The agents include application observers 354, 355, 356 and 357 that capture and record data indicative of user interactions with the user's workstations 350, 351, 352 and 353, respectively. User interaction data is captured by a desktop listener 358, as shown in FIG. 1. In addition, data is captured from business application servers 359 and 360 using application listeners 361 and 362, respectively. A web observer or web listener 365 is used to capture data concerning a user's interaction with a web page maintained on a web server 363.

User workstations 350, 351, 352 and 353 have software agents 354, 355, 356 and 357 installed or downloaded onto the desktops. The agents include application observers 354, 355, 356 and 357 that capture and record data indicative of user interactions with the user's workstation 350, 351, 352 and 353, respectively. As shown in FIG. 1, captured data is fed into a desktop listener 358.

Data may be captured from business application servers 359 and 360 using application listeners 361 and 362, respectively. A web observer 365 is used to capture data relating to a user's interaction with a web page maintained on a web server 363.

A process intelligence server 375 is provided to process user interaction data. The process intelligence server 375 comprises a raw data store 370, a process discovery software module 371, and a process master data store 372.

Referring to FIG. 1, process content may be fed back to a content server 374 that can be provided to a user 350, 351, 352 or 353 at an appropriate time and in a relevant context. The content server 374 produces contextual intervention with a user 350, 351, 352 or 353.

User interaction data from desktop listener 358, from application listeners 361 and 362, and from web listeners 365 and 366, is copied to the raw data store 370. A process discovery software module 371 is provided for interpreting and modeling the raw data contained in the data store 370. In a preferred embodiment, the process discovery software module 371 includes a finite state machine definition that results from selecting relevant steps of a business process for a learn-by-example method. Information relating to business processes identified or specified by the process discovery module 371 is communicated or transmitted to the process master data store 372.

A system console 373 is provided to provide for configuring and deploying desktop listeners 358, software agents 354, 355, 356 and 357, application listeners 361 and 362, and web listeners 365 and 366. Referring to FIG. 1, a studio 376 is provided to provide views of the capture data, and to identify, define, test, and install rules for identifying business processes in the capture data.

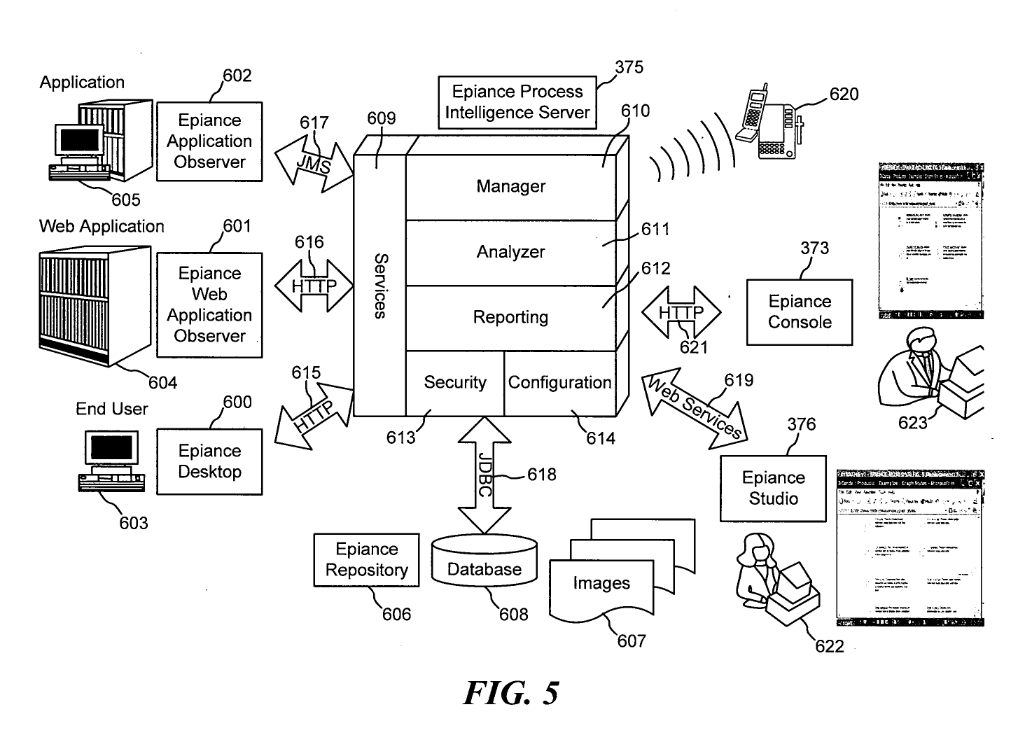

The functional operation of the preferred embodiment shown in FIG. 1 will be described in more detail below. Turning now to FIG. 5, a block diagram of a preferred embodiment depicts a desktop component 600 that runs on a user desktop 603, and which is operative to capture data concerning user interactions with applications used to perform business processes. Captured user interaction data is communicated from the desktop component 600 to the process intelligence server 375 using http protocol over a network link 615. A web application observer 601 is operative to capture user interaction data for web applications 604. Captured user interaction data is communicated from the web application observer 601 to the process intelligence server 375 using http protocol over a network link 616. An application observer 602 is operative to capture data concerning interactions with applications 605. Interaction data is communicated from the application observer 602 to the process intelligence server 375 using JMS messaging over a network link 617. The remote process capture system is preferrably implemented with a desktop observer or agent 557 operative on each user's PC or workstation, and is preferrably used to collect user interaction data from all users in a company, and across all software applications in use at the company.

The remote process capture system shown in FIG. 5 provides for the automated capture of information relating to user processes by detecting and recording data representative of human interactions with a user's computer workstation, desk top computer, or laptop. Captured user interaction data is preferrably converted to extensible markup language (“XML”) elements that are stored in a XML format. User interaction data from the remote process capture system is stored in a data repository 606. In addition to capturing information such as mouse clicks and actuations of a user's keyboard which are stored in a database 608, images 607 of screen shots and active windows on a graphical user interface are also recorded and associated with related user interaction data.

A business process analyzer 611 identifies business processes based on the user interaction data 608 captured by the remote process capture system 600, 601 and 602. Process identification is facilitated using learn by example techniques. The business process analyzer 611 generates models of business processes. The operation of the business process analyzer 611 is described in more detail below.

Data Capture

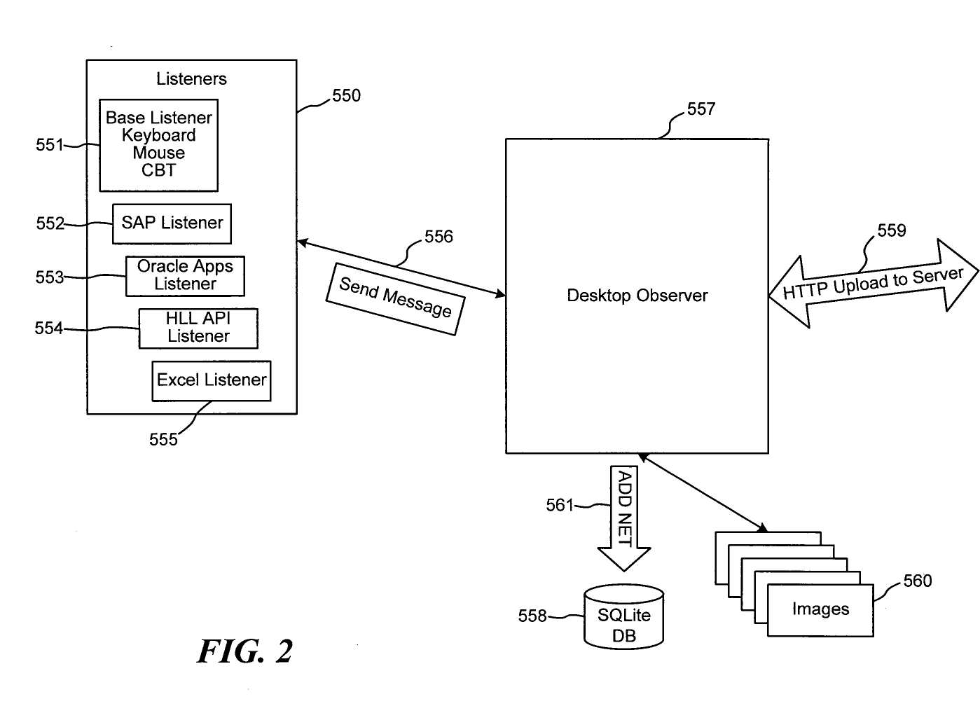

FIG. 2 illustrates components that run on the user desktop 350 in a preferred embodiment of a remote process capture system. User interaction data is detected and recorded that is representative of actions taken by a user while performing actions in the course of a business process. User interaction information may be obtained from a number of sources. For example, data may be captured based upon user interaction with a keyboard, a mouse or cursor pointing device, menus, toolbars, and dialog controls that provide data representative of user actions in performing one or more business processes.

In the present invention, observations at a desktop 350 are in the form of data that is representative of events that are collected from desktop applications. Components of the desktop agent responsible for collecting events are called listeners 550. In particular, a listener 550 is a component of the capture technology which captures user interaction events in raw form. The listeners 550 are preferrably installed on the desktop computer 350 of the user. The invention has sophisticated listeners 550 which can listen to data exchanges within and between various kinds of applications, such as Internet Explorer® based applications, Windows® applications, or java applications.

A base listener 551 is provided that uses the functionality provided by Microsoft Active Accessibility (“MSAA”). The base listener 551 may be used for all 32-bit software applications running in a Windows® environment. The MSAA API provides standard mouse and keyboard hooks that can be exploited for purposes of data capture. Hooks provided for Computer Based Training (“CBT”) may be used for data capture by the base listener 551. Standard keyboard and mouse hooks are used by the listener 551 to listen to user interactions with any 32-bit Windows® software application. These hooks provide an application programming interface (“API”) that may be used to intercept data for purposes of capturing the data representative of user interaction with the user's computer 350. The technique for collecting the desired data is described in more detail below.

In some instances, it is desirable to have application specific listeners. An SAP application specific listener 552 is provided for server application programming (“SAP”) events. An Oracle listener 553 is provided for Oracle® applications. An Excel listener 550 is provided for listening to Microsoft® Excel® spreadsheet software. In addition, a HLLAPI listener 554 is used for certain terminal emulator applications that comply with a HLL application programming interface or API, such as NetManage Rumba software.

A detailed description of the attachment of an Excel listener 550 that will be readily understood by a skilled programmer is provided in the computer program listing of Table 5, which is submitted herewith as a separate text file and is incorporated herein by reference.

A detailed description of event collection by the Excel listener 550 that will be readily understood by a skilled programmer is provided in the computer program listing of Table 6, which is submitted herewith as a separate text file and is incorporated herein by reference. The computer software listing is also set forth below:

```
public void OnWorkbookActivate(Microsoft.Office.Interop.Excel.Workbook Wb)
  {
      try
      {
```

//This is called when a workbook is activated in

Microsoft.Office.Interop.Excel.

| | |
|---|---|
| // | string eventDescription = |

String.Format(resManager.GetString(Default.OnBookActivateDescription), Wb.Name);

string eventDescription = “ ”;
Utils.Control control = new Utils.Control(Wb.Name, “ ”, Wb.Name,

Constants.XL_ROLE_WORKBOOK, “ ”, “ ”, “ ”, null);

ExcelEventData xlData = new ExcelEventData(“ ”, “ ”, “ ”, Wb.Name,

Wb.FullName);

Utils.EventData eventData =

PopulateEventData(Constants.XL_WorkbookActivate, control, xlData);

SendMessageToCapture(Constants.XL_WorkbookActivate,

```
eventDescription, Utils.Helper.GetXML( eventData ));
      }
      catch(Exception e)
      {
```

if (logger.IsErrorEnabled)
{
logger.Error(“OnWorkbookActivate failed : “ + e.Message + ”

: ” + e.StackTrace);

ExceptionPolicy.HandleException(e,

Utils.Constants.EXCEPTION_POLICY);

}

```
      }
  }
```

As described above, an SAP application specific listener 552 is provided for server application programming (“SAP”) events. A detailed description of the attachment of an SAP application specific listener 552 that will be readily understood by a skilled programmer is provided in the computer program listing of Table 7, which is submitted herewith as a separate text file and is incorporated herein by reference.

A detailed description of event collection by the SAP application specific listener 552 that will be readily understood by a skilled programmer is provided in the computer program listing of Table 8, which is submitted herewith as a separate text file and is incorporated herein by reference. The computer software listing is also set forth below:

```
‘ This is used to Process events received by SAP Listener and send them to Desktop Observer for
storing.
  ‘ 1. Get the Desktopserver.capture object
  ‘ 2. Fill in the proper eventname and description
  ‘ 3. send it for storage
  Public Sub ProcessEvent(ByRef p_xmldata As String, ByVal p_msgId As Integer, ByVal
p_strCaption As String)
    On Error GoTo Err_handler
    Dim l_userName As String
    Dim l_captureEvent As DesktopServer.Model.CaptureEvent
    Dim l_strProcName As String
    Dim l_exitpoint As Integer
    l_strProcName = “Listener.ProcessEvent”
    l_exitpoint = 0
    If m_captureApp Is Nothing Then
      m_captureApp =
System.Runtime.InteropServices.Marshal.GetActiveObject(“DesktopServer.Capture”)
      If (m_captureApp Is Nothing) Then
        Err.Raise(vbObjectError + 521, “Listener.ProcessEvent”, “Could not acquire the
Desktop Capture object from ROT”)
      End If
    End If
    l_exitpoint = 1
    l_captureEvent = New DesktopServer.Model.CaptureEvent
    l_captureEvent.Application = SAP_EXENAME
    Select Case p_msgId
      Case SAP_IDSessionStartRequest
        l_captureEvent.Description = SAP_SessionStartRequest
        l_captureEvent.EventName = SAP_SessionStartRequest
      Case SAP_IDSessionEndRequest
        l_captureEvent.Description = SAP_SessionEndRequest
        l_captureEvent.EventName = SAP_SessionEndRequest
      Case SAP_IDSessionChange
        l_captureEvent.Description = SAP_SessionChange
        l_captureEvent.EventName = SAP_SessionChange
      Case SAP_IDSessionCreate
        l_captureEvent.Description = SAP_CreateSession
        l_captureEvent.EventName = SAP_CreateSession
      Case SAP_IDSessionDestroy
        l_captureEvent.Description = SAP_DestroySession
        l_captureEvent.EventName = SAP_DestroySession
    End Select
    l_captureEvent.EventData = p_xmldata
    ‘ l_captureEvent.eventId = SAP_IDSessionStartRequest
    l_captureEvent.ScreenCaption = p_strCaption
    l_captureEvent.UserName = m_userName
    l_captureEvent.TimeStamp = GetTickCount()
    l_exitpoint = 2
    Call m_captureApp.QueueEvent(l_capturcEvcnt)
    Exit Sub
Err_handler:
    m_captureApp = Nothing
    Call WriteError(l_strProcName, l_exitpoint)
    Exit Sub
  End Sub
```

A web application observer 601 may employ an Internet Explorer listener for data capture. In addition, an Internet Explorer listener may be advantageously used in other circumstances as well, as will be apparent to those skilled in the art after having the benefit of this disclosure. A detailed description of the attachment of an Internet Explorer listener that will be readily understood by a skilled programmer is provided in the computer program listing of Table 9, which is submitted herewith as a separate text file and is incorporated herein by reference.

A detailed description of event collection by an Internet Explorer listener that will be readily understood by a skilled programmer is provided in the computer program listing of Table 10, which is submitted herewith as a separate text file and is incorporated herein by reference.

Raw data collected by the listeners 550 is provided as messages 556 to a desktop observer or agent 557. In addition, images of screens 560 are also captured. The desktop observer 557 receives user interaction data from the listeners 550 and uploads the data to the process intelligence server 375 over a network using http protocol 559. Detailed information concerning the schema used in the process intelligence server 375 is provided in the computer program listing of Table 4. Table 4 is a computer program listing submitted separately as a text file, and is incorporated herein by reference. Table 4 provides a disclosure of the schema used in the process intelligence server 375 that will be readily understood by a skilled programmer.

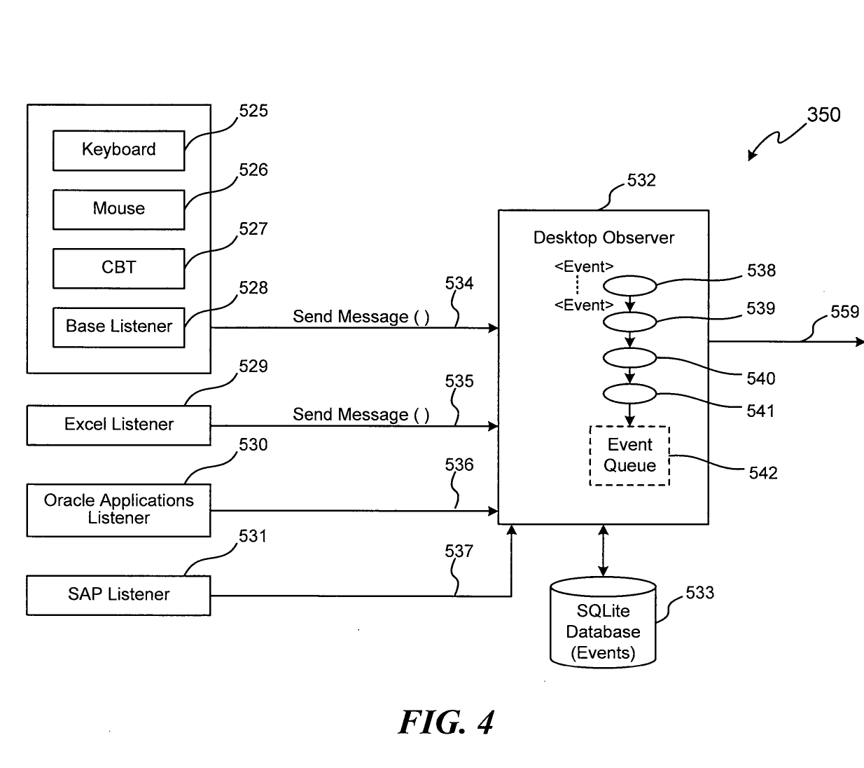

FIG. 4 further illustrates the software components on a user desktop 350. The base listener 528 captures data from a keyboard 525, a mouse 526, and data obtained via the CBT API 527, and sends messages 534 containing such raw data to the desktop observer 532. Excel listener 529, Oracle listener 530, and SAP listener 531 send messages 535, 536 and 537, respectively, to the desktop agent 532. Those messages comprise events 538, 539, 540, and 541 that are placed in an event queue 542 for transmission over network 559 to the server 375. Events may be stored in a database 533 until they can be transmitted over the network 559.

It is desirable to have the user desktop or laptop 350 continue to capture user interaction data even while the laptop 350 is being operated in a stand alone configuration, or while a network connection 559 to the server 375 is down or otherwise unavailable. The desktop agent 557 includes a local event queue subcomponent 463 that provides a temporary data store 558 on the user's computer 350. While all event data processing happens on the server 375, in normal operation there may be times the agent 557 needs to persist data locally, such as when the desktop 350 is in a disconnected mode, communications are down, etc. An embedded open source in-memory database 558 is used to provide temporary storage of events 477 locally on the desktop or laptop 350. In a preferred embodiment, SQLite 471 is used for local memory database store 558 on the desktop 350. This approach has certain advantages in that local storage becomes a one line insert statement, all failure and error handling built into SQLite 471 may be utilized to significantly reduce the lines of code required, and the “SQL”ness of local storage allows for sophisticated querying and processing of data. In a preferred embodiment, ADO.NET Microsoft data access technology is used to access the database 558 in a .NET environment that is interoperable with XML.

Local storage on the user desktop 350 is also used to temporarily store images 560. The desktop agent 557 will not transmit images 560 to the server 375 over the network 559 until the network is idle and such transmission will not interfere with the operation of the user desktop 350.

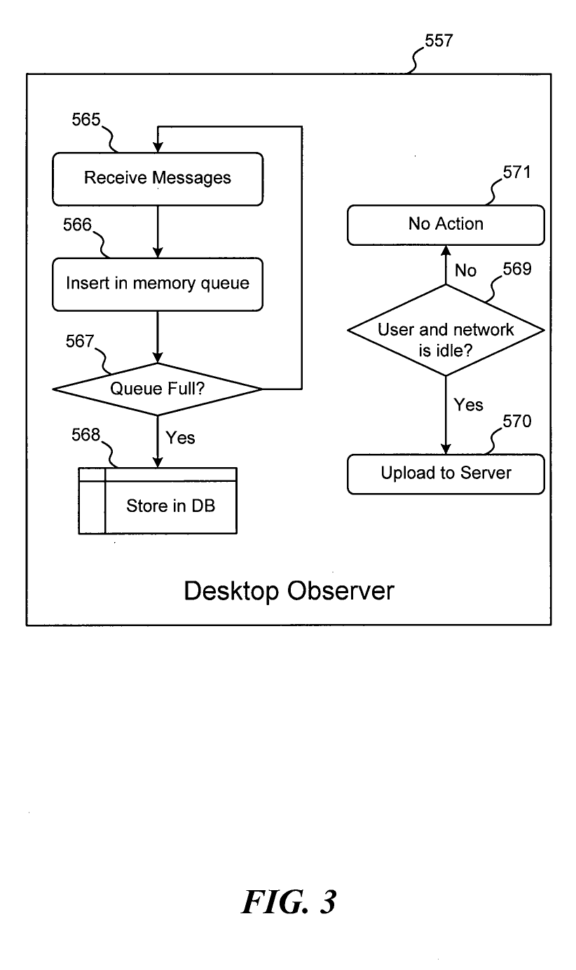

Details of the operation of the desktop agent 557 are depicted in the flowchart shown in FIG. 3. In step 565, the desktop observer 557 receives messages from the listeners 550. Messages are inserted into a memory queue in step 566. The desktop observer 557 checks the queue to determine whether it is full in step 567. If the queue is not full, the desktop observer 557 continues to receive messages by looping back to step 565. If the queue is full in step 567, then in step 568 the messages will be temporarily stored in the local database store 558 on the desktop 350. The desktop observer 557 will check to determine whether the user desktop 350 and the network are idle in step 569. If the network is not idle, no action will be taken 571 and the agent 557 will wait to transmit the captured data. Only if the network and user desktop are found to be idle in step 569, will the desktop agent 557 proceed to step 570 and upload data to the server 375.

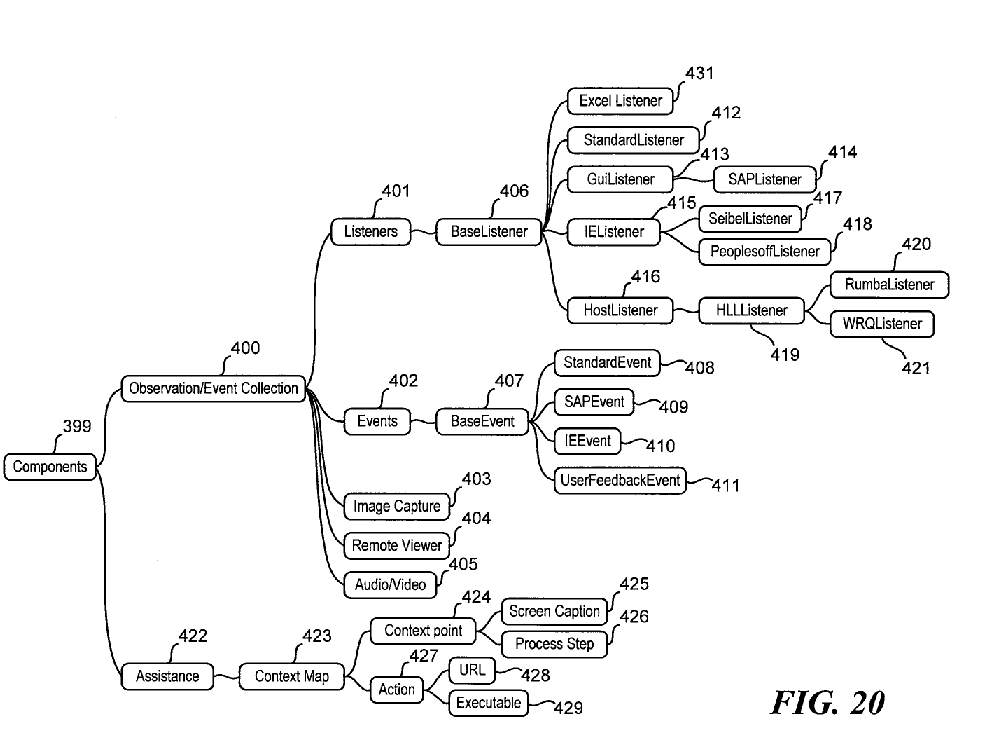

Listeners 550 are organized in a hierarchy as illustrated in FIG. 20. Observation and event collection 400 are performed by listeners 401. One advantage of taking a hierarchical approach to listener design is that any generic functionality can be captured in a higher level listener 406 and any application specific behavior can be handled at a subclass listener level 415, 414, 417, 418, 431.

A preferred embodiment of the present invention uses the functionality provided by Microsoft Active Accessibility (“MSAA”) for a standard listener or base listener 412. The standard MSAA listener 412 may be used for all 32-bit software applications running in a Windows® environment. The MSAA API provides standard mouse and keyboard hooks that can be exploited for purposes of data capture. Standard keyboard and mouse hooks are used to listen to user interactions with any 32-bit Windows® software application. The technique for collecting the desired data involves a query of control information using the MSAA API. On receiving the user events using the standard mouse and keyboard hooks, the MSAA API is used to query the control/user interface element that the user is interacting with in the subject Windows® software application.

As an example, sample XML data for one event may be as follows:

```
    <MOUSE>
    <EVENTNAME>MSAA_RBUTTONDOWN</EVENTNAME>
    <CONTROL NAME=‘EPIANCE DESKTOP’ VALUE=” ROLE=”
STATE=‘128’ LOCATION=‘779,744,797,762’ KEYSTATUS=‘0’
    PARENTNAME=” PARENTVALUE=” PARENTROLE=”
PARENTSTATE=” PARENTLOCATION=”/>
    </MOUSE>
```

This technique can be employed to listen to all applications. However, if a particular software application is not MSAA compliant, then the quality of data captured will be impaired. The MSAA listener 412 also captures screen entry and screen exit ScreenData. Screen entry ScreenData is captured on a first user action after a window activate event. Screen exit ScreenData is captured on specific key strokes like “enter,” “esc,” and “Ctrl+F4.” Screen exit ScreenData is also captured on mouse clicks on specific controls like a button or a “close” option on a drop down menu.

A detailed description of how a base listener or standard listener 412 is attached so it can capture data is provided below in the following code:

```
CAPTURECONTROL_API int setHook(unsigned int iHooksToInstall, HWND hWindow)
{
  const int RET_SUCCESS = 1;
  const int RET_FAILURE = 0;
  int retVal = RET_SUCCESS;
  //
  // Hook already set, do not set once more
  //
  if (g_hWndCapture != NULL)
  {
    return RET_FAILURE;
  }
  Config::Init( );
  g_dwCaptureProcessId = GetCurrentProcessId( );
  if( (iHooksToInstall & cHOOK_MOUSE) != 0)
  {
    g_mouseHook = SetWindowsHookEx(WH_MOUSE, (HOOKPROC)MouseProc,
hInstance, 0);
    if(g_mouseHook == NULL)
    {
      retVal = RET_FAILURE;
    }
  }
  if( (iHooksToInstall & cHOOK_KEYBOARD ) != 0)
  {
    g_keyHook = SetWindowsHookEx(WH_KEYBOARD, (HOOKPROC)KeyProc,
hInstance, 0);
    if(g_keyHook == NULL)
    {
      retVal = RET_FAILURE;
    }
  }
  if( (iHooksToInstall & cHOOK_CBT ) != 0)
  {
    g_cbtHook = SetWindowsHookEx(WH_CBT, (HOOKPROC)CBTProc, hInstance,
0);
    if(g_cbtHook == NULL)
    {
      retVal = RET_FAILURE;
    }
  }
  if( (iHooksToInstall & cHOOK_CALLWNDPROC ) != 0)
  {
    g_callWndHook = SetWindowsHookEx(WH_CALLWNDPROC,
(HOOKPROC)CallWndProc, hInstance, 0);
    if(g_callWndHook == NULL)
    {
      retVal = RET_FAILURE;
    }
  }
  WCHAR szLogEntry[255];
  StringCchPrintf(szLogEntry, 255, L“hooksToInstall=%d,cbT=%d,mouse=%d,key=%d”,
iHooksToInstall, g_cbtHook, g_mouseHook, g_keyHook);
  MSAAUtil::WriteToLog(L“hookhandle”, szLogEntry, cLOG_INFO);
  TCHAR functionName[20];
  StringCchCopy(functionName,20/sizeof(TCHAR),L“setHook”);
  CheckError(functionName);
  g_hWndCapture = hWindow;
  return retVal;
}
/// <summary>
/// Find out if we are running in Desktop Observer process space
/// </summary>
BOOL IsCurrentProcessCapture( )
{
  if(GetCurrentProcessId( ) == g_dwCaptureProcessId)
  {
    return TRUE;
  }
  return FALSE;
}
/******************************************
*  cleartHook
* Inputs:
* Result: BOOL
*  TRUE if successful
*  FALSE if error
* Effect:
*  Sets the hook
******************************************/
CAPTURECONTROL_API BOOL clearHook(HWND hWindow)
{
  BOOL unhooked = TRUE;
  if( g_mouseHook != NULL && UnhookWindowsHookEx(g_mouseHook) == FALSE)
  {
    unhooked = FALSE;
  }
  if( g_keyHook != NULL && UnhookWindowsHookEx(g_keyHook) == FALSE)
  {
    unhooked = FALSE;
  }
  if( g_cbtHook != NULL && UnhookWindowsHookEx(g_cbtHook) == FALSE)
  {
    unhooked = FALSE;
  }
  if( g_callWndHook != NULL && UnhookWindowsHookEx(g_callWndHook) == FALSE)
  {
    unhooked = FALSE;
  }
  TCHAR functionName[20];
  StringCchCopy(functionName,20/sizeof(TCHAR),L“clearHook”);
  CheckError(functionName);
  g_hWndCapture = NULL;
  g_cbtHook = NULL;
  g_mouseHook = NULL;
  g_keyHook = NULL;
  g_callWndHook = NULL;
  return unhooked;
}
```

A detailed description of base listener or standard listener 412 event collection is provided in the code set forth below:

```
static LRESULT CALLBACK CBTProc(UINT nCode, WPARAM wParam, LPARAM lParam)
{
  if (nCode<0)
  {
    return CallNextHookEx(g_cbtHook, nCode, wParam, lParam);
  }
  if(IsCurrentProcessCapture( ) == TRUE)
  {
    // Don't capture messages on captureApp
    return CallNextHookEx(g_cbtHook, nCode, wParam, lParam);
  }
  TCHAR szCode[128];
  TCHAR szWinText[255]=L“\0”;
  CaptureEvent event;
  COPYDATASTRUCT cds;
  cds.dwData = wParam;
  cds.cbData = sizeof(event);
  Convert(WH_CBT, nCode, szCode);
  if(IsMessageToBeProcessed(nCode, wParam, lParam) == TRUE)
  {
    WCHAR szLog[255];
    StringCchPrintf(szLog, 255,
L“CBTProc:hook=%d,nCode=%d,wParam=%d,lParam=%d”, g_cbtHook, nCode, wParam,
lParam);
    MSAAUtil::WriteToLog(L“Hooks”, szLog, cLOG_INFO);
    HWND hWndAction = reinterpret_cast<HWND>(wParam);
    if(Window::IsTopLevelWindowWithTitle(hWndAction) == TRUE)
    {
      MSAAUtil::WriteToLog(L“Hooks”, L“Window has title”, cLOG_INFO);
      if(Config::IsBlackListedExe( ) == TRUE)
      {
        MSAAUtil::WriteToLog(L“Hooks”, L“App is blacklisted”,
cLOG_INFO);
        return CallNextHookExWrapper(g_cbtHook, nCode, wParam,
lParam);
      }
      MSAAUtil::WriteToLog(L“Hooks”, L“app is not blacklisted”, cLOG_INFO);
      //MSAAManager::MSAACaptureWrapper(g_cbtHook, nCode, wParam,
lParam);
      MSAAUtil::WriteToLog(L“Hooks”, L“after msaa wrapper call”,
cLOG_INFO);
      int result = GetWindowText(hWndAction, szWinText, 254);
      MSAAUtil::WriteToLog(L“Hooks”, L“after getwindowtext”, cLOG_INFO);
      event.eventId = g_iCounter++;
      StringCchPrintf(event.timeStamp, MAX_SIZE, L“%d”, GetTickCount( ));
      StringCchPrintf(event.eventName, MAX_SIZE, L“%s”, szCode);
      StringCchPrintf(event.windowCaption, MAX_SIZE, L“%s”, szWinText);
      MSAAUtil::UpdatePacketId( );
      event.lPacketId = g_lPacketId;
      _try
      {
        ConstructEvent(event, szCode, szWinText, L“window”, L“”, L“”);
      }
      _except (GetExceptionCode( ) == EXCEPTION_ACCESS_VIOLATION?
          EXCEPTION_EXECUTE_HANDLER :
          EXCEPTION_EXECUTE_HANDLER )
      {
        WCHAR szException[200];
        StringCchPrintf(szException, 200, L“%d - cbt hook, exception”,
GetExceptionCode( ));
        MSAAUtil::WriteToLog(L“Hooks”, szException, cLOG_ERROR);
      }
      MSAAUtil::WriteToLog(L“Hooks”, L“bef getmodulefilename”,
cLOG_INFO);
      GetModuleFileName(NULL, event.application, MAX_SIZE);
      MSAAUtil::WriteToLog(L“Hooks”, L“after getmodulefilename”,
cLOG_INFO);
      cds.lpData = &event;
      SendMessage(g_hWndCapture, WM_COPYDATA,
(WPARAM)SENDERID, (LPARAM)&cds);
    }
    return CallNextHookExWrapper(g_cbtHook, nCode, wParam, lParam);
  }
  return CallNextHookEx(g_cbtHook, nCode, wParam, lParam);
} // CBTProc
Skilled
```

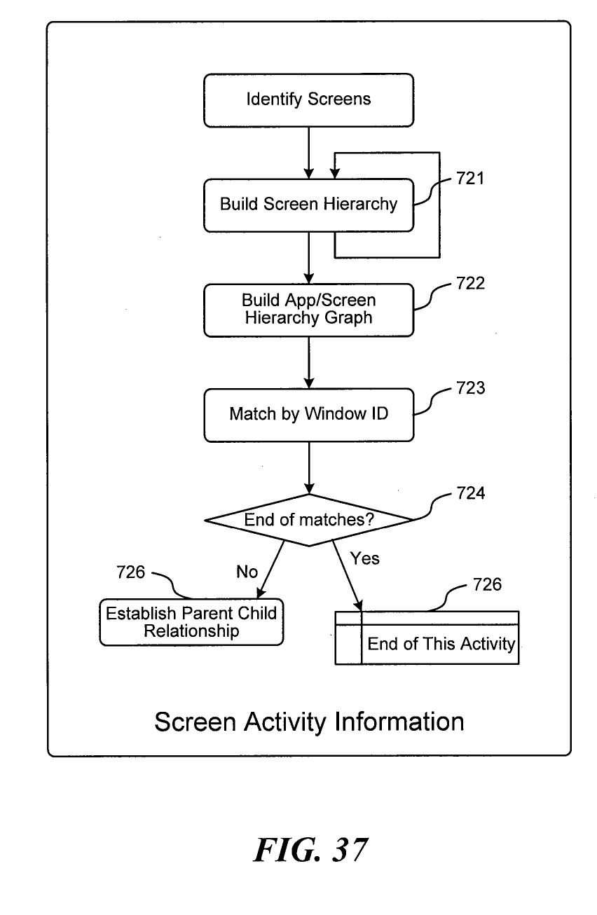

Screen activity identification for MSAA listener 412 reported events may be accomplished in the manner described below, and illustrated in FIG. 37. A method of screen activity identification preferably begins with the step of identifying a screen that is active on the user's computer whose data is being captured. A screen hierarchy is built in step 721. Then the step of building an app/screen hierarchy graph 722 is performed. A match is performed by screen ID in step 723. A determination is made whether there are any more matches in step 724, and if not, parent-child relationships in the hierarchical orginazition of screens is established in step 725. The end of the activity is designated by step 726 in FIG. 37.

Screen activities (including screen clusters) may be identified using a method in which the step of identifying the Screen ID 720 for each screen is performed, and a screen hierarchy is built 721, followed by the step of building an App->Screen hierarchy graph 722. The method includes the step of building a screen flow graph again at the application level connecting nodes at the same tree level based on observer screen transitions.

The step of building an App->Screen hierarchy graph 722 may be further broken down into the following steps:

a. For each application, for a process instance at a user desktop, build a app->screen hierarchy in step 722 using the hierarchy of windows built in step 721 within the Windows Environment for the process ID. Process the desktop capture events in App->User->Process ID->Event ID order.

b. Whenever the application changes, create a new app hierarchy in step 722 for the new application.

c. Whenever a process ID or user changes, cleanup the Windows to screen ID hash maps maintained for a process ID.

d. Get screen entry/screen exit records.

e. Check whether a screen-ID is part of the app hierarchy. If not, add it to the app hierarchy in step 722.

f. Build a hash map of windows to screen-IDs for that process ID to permit matching by Window ID in step 723.

g. If the current window handle has a parent window, check whether the parent window handle has a screen ID. If yes, build a screen-ID hierarchy in step 721 between the two.

The identification of process instance IDs is preferably performed as follows:

1. For a particular screen ID, select the distinct window handles for a particular user/process ID combination.

2. For each distinct window handle, select the first event that matches the window handle/screen-ID combination in step 724.

3. In step 724, look for the last event that matches the window handle/screen-ID combination or any of its child window handles/child screen-IDs. In some cases closing the application will close all the windows. That is the end of that screen activity instance 726.

In some cases, windows are hidden and reactivated internally while the user might think that he or she is starting a new instance. In such situations, there will be only one instance identified for a process ID. In addition, a user might perform multiple process instances on the same screen, and it is desirable to differentiate between them.

Each tree node in the app->screen hierarchy may have certain attributes. Each tree node has an associated screen-ID whose label will correspond to the name of the process. Tree nodes can have multiple parents, which implies that a particular node is the root of a process which can be invoked from multiple places. Such tree nodes can be reported independently, or in the context of the parent node which invoked it. Process metrics can be reported at the node level or at a combination of node and edges. Process metrics can be reported at any level.

The step of building a screen flow graph at the application level is based on observer screen transitions, but this time nodes are connected at the same tree level. This step may be further broken down into the following steps:

a. Cycles between screens within the graph are identified. These cycles can be broken if the analyst determines them to be completely independent processes.

b. Create a big STRING pattern of all these screen ID transitions for each process-ID and user combination and conduct a pattern search. Some patterns that are useful to be identified include a node with an incoming node and followed by an outgoing node. If there is no outgoing, then this indicates the likelihood that the process may have been terminated. Such a node is an ideal candidate for getting merged as part of a bigger process.

The above description of a MSAA listener 412 is intended as an example only. MSAA technology is being complemented with other accessibility technology in future versions of the Windows® operating system. It will be desirable to provide an additional corresponding listener based on the corresponding APIs provided for such accessibility technology. As additional APIs are provided for new accessibility technology, one or more corresponding listeners may be added to capture data using those APIs.

An application specific subclass listener 414 is preferably provided for server application programming (“SAP”) events. An application specific listener 415 may be provided for Internet Explorer® based applications. A Siebel application specific subclass listener 417 may be provided; and a Peoplesoft application specific subclass listener 418 may be provided. An application specific listener 431 is also preferably provided for Microsoft Excel® applications. Listeners 401 in accordance with the present invention satisfy the following design goals: the listeners 401 are non-intrusive and their existence is transparent to end user interactions with the applications; the listeners 401 are highly configurable in that they can be tuned to listen to different levels of detail based on a configuration parameter. A suitable configuration parameter might be “listenDetail.” This configurability allows for listeners to be intrusive only to the extent needed while serving the business need.

The preferred event model 402 used in connection with the present invention follows a similar hierarchical design for similar reasons. Generic events can be observed and captured in a higher level event observer 407, and any application specific event behavior can be handled by a subclass event observer 409, 41 0. A SAP event observer 409 is preferably provided. In addition, an internet explorer event observer 41 0 is also provided.

The SAP application specific listener 414 that may suitably be used to listen and capture user interaction data for SAP version 6.2 and SAP version 6.4 may use the technique of subscribing to events published by the SAPGUI front end when scripting is enabled. The events are published every time a request a made to the server. The server responds with a response and changes are made on a screen. A “knob” parameter is preferably used to stop captures of detail information for screens with certain titles in modal dialog boxes. In a preferred SAP application specific listener 414 in accordance with the present invention, captures of changes made on a screen can be turned on or off. This functionality is preferred since changes are not a well tested feature for stability.

The SAP application specific listener 414 provides the following information: generic session level information in terms of SAP connection parameters; transaction based information such as response time and data interpretation time; and transaction level data such as the data transmitted from the server, including all of the label information and the data within it. In a preferred SAP application specific listener 414, some controls which have too much data such as tables are not captured; and it may not be desirable to listen to SAP user interface events (button clicks).

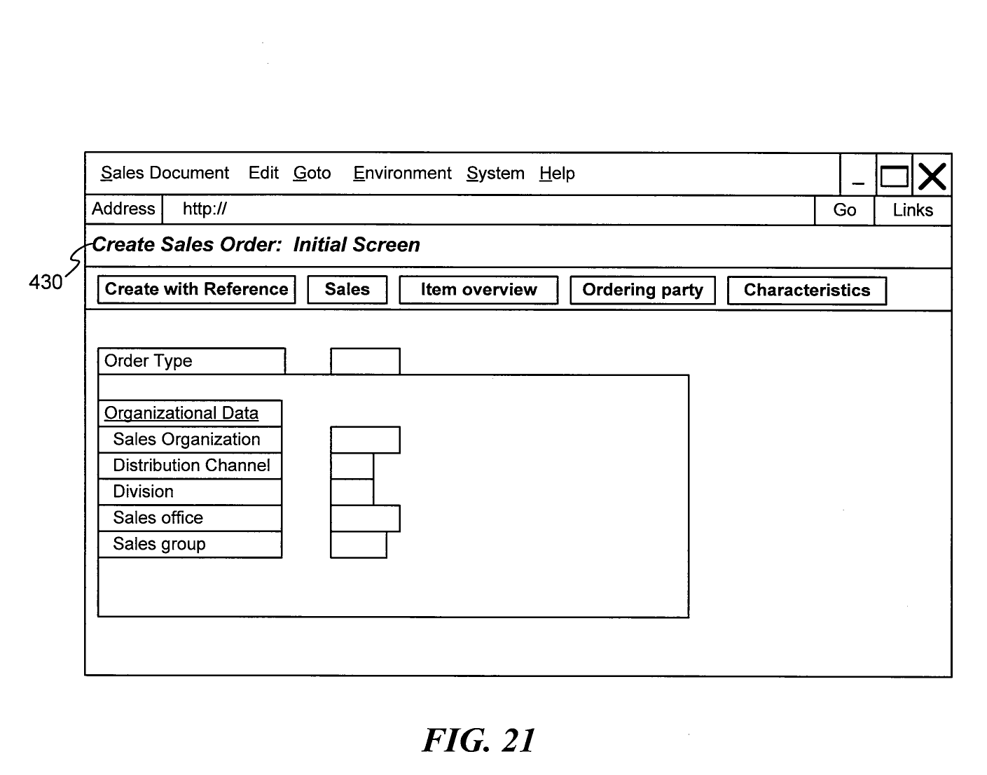

FIG. 21 illustrates an example of a screen, and the following event data or constructs would typically be provided by the SAP application specific listener 414 in this example:

```
    <?xml version=“1.0” encoding=“utf-8” ?>
    <SES>
    <SESINF>
    <CONSTR>/SAP_CODEPAGE=1100  /FULLMENU  192.168.1.61  00  /3
/UPDOWNLOAD_CP=1160</CONSTR>
    <CONID>/APP/CON[0]</CONID>
    <SESNUM>1</SESNUM>
    <SCRNBR>101</SCRNBR>
    <CDEPAG>1160</CDEPAG>
    <TRN>VA01</TRN>
    <PGM>SAPMV45A</PGM>
    <RSPTIM>31</RSPTIM>
    <INTTIM>31</INTTIM>
    <FLU>0</FLU>
    <RNDTRP>1</RNDTRP>
    </SESINF>
    <ACTWND>
    <MAINWND><NAM>/WND[0]</NAM><VAL>CREATE SALES ORDER: INITIAL
SCREEN</VAL></MAINWND>
    <OKCFLD><NAM>/OKCD</NAM><VAL /></OKCFLD>
    <TTLBAR><NAM>/TITL</NAM><VAL>CREATE SALES ORDER: INITIAL
SCREEN</VAL></TTLBAR>
    <TXTFLD><NAM>/TXTRV45A-TXT_AUART</NAM><VAL>ORDER
TYPE</VAL></TXTFLD>
    <CTXFLD><NAM>/CTXTVBAK-AUART</NAM><VAL /></CTXFLD>
    <TXTFLD><NAM>/TXTTVAKT-BEZEI</NAM><VAL /></TXTFLD>
    <BOX><NAM>/BOXTEXT</NAM><VAL>ORGANIZATIONAL
DATA</VAL></BOX>
    <LBL><NAM>/LBLVBAK-VKORG</NAM><VAL>SALES
ORGANIZATION</VAL></LBL>
    <CTXFLD><NAM>/CTXTVBAK-VKORG</NAM><VAL /></CTXFLD>
    <TXTFLD><NAM>/TXTTVKOT-VTEXT</NAM><VAL /></TXTFLD>
    <LBL><NAM>/LBLVBAK-VTWEG</NAM><VAL>DISTRIBUTION
CHANNEL</VAL></LBL>
    <CTXFLD><NAM>/CTXTVBAK-VTWEG</NAM><VAL /></CTXFLD>
    <TXTFLD><NAM>/TXTTVTWT-VTEXT</NAM><VAL /></TXTFLD>
    <LBL><NAM>/LBLVBAK-SPART</NAM><VAL>DIVISION</VAL></LBL>
    <CTXFLD><NAM>/CTXTVBAK-SPART</NAM><VAL /></CTXFLD>
    <TXTFLD><NAM>/TXTTSPAT-VTEXT</NAM><VAL /></TXTFLD>
    <LBL><NAM>/LBLVBAK-VKBUR</NAM><VAL>SALES OFFICE</VAL></LBL>
    <CTXFLD><NAM>/CTXTVBAK-VKBUR</NAM><VAL /></CTXFLD>
    <TXTFLD><NAM>/TXTTVKBT-BEZEI</NAM><VAL /></TXTFLD>
    <LBL><NAM>/LBLVBAK-VKGRP</NAM><VAL>SALES GROUP</VAL></LBL>
    <CTXFLD><NAM>/CTXTVBAK-VKGRP</NAM><VAL /></CTXFLD>
    <TXTFLD><NAM>/TXTTVGRT-BEZEI</NAM><VAL/></TXTFLD>
    <STSBAR><NAM>/SBAR</NAM><VAL>,,</VAL></STSBAR>
    </ACTWND>
    </SES>
```

Note that the value “<VAL>” for the main window is provided as “CREATE SALES ORDER: INITIAL SCREEN” in the above event data, and this corresponds to the information 430 displayed on the screen shown in FIG. 21.

Referring to FIG. 20, an Excel application specific listener 431 may suitably be used to listen and capture user interaction data for Microsoft® Excel® spreadsheet software by taking advantage of Visual Basic application functionality in Excel XP and 2003 versions. The preferred technique is to use event delegates. A listener specific data model may provide an event name that is “XL-CELLCHANGE” and event data in XML format would be as follows:

<RANGE>$H$19</RANGE>
<WORKSHEET>SHEET1</WORKSHEET>
<WORKBOOK>BOOK1</WORKBOOK>
<CELLDATA>SDFASFDSDF</CELLDATA>

In the Excel application specific listener 431, high level events like cell change, worksheet switch, and workbook activate are raised by Excel. The Excel application specific listener 431 listens to these events through event delegates. ScreenData is not captured by the preferred Excel application specific listener 431. The approach described herein for the preferred Excel application specific listener 431 is useful for process discovery since the listener reports only changes made to the workbook. However, the low level interactions like key and mouse actions are not listened to by the preferred Excel application specific listener 431. Instead a generic listener 412 using the functionality provided by Microsoft Active Accessibility (“MSAA”) would be required for such purposes. The preferred Excel application specific listener 431 does not listen to dialog, menu, or toolbar interactions within Excel®. Only events that cause the worksheet to undergo changes are listened to by the preferred Excel application specific listener 431.

An Internet Explorer® application specific listener 415 may be used to listen to browser events that occur in connection with the Internet Explorer® software application. This listener 415 is always on when the Internet Explorer® application is being used by the user. The data model is as follows: <data><input type=“”value=“”name=“”/></data>. The Internet Explorer® application specific listener 415 captures browser events.

In addition, third party applications can use the listeners 550 to listen to events, and utilize the observation and event data collection functionality available in the desktop agent 532. For example, a third party security application may use the listener functionality to obtain user interaction data representative of a user's interaction with the keyboard on his or her desktop 350. Historic user interaction data from a data store 370 may be used to determine characteristic patterns of the user's interaction with the desktop keyboard. The current user interaction capture data may be used to determine characteristic patterns of the user's current interaction with the desktop keyboard. The current characteristic pattern may be compared against the historic characteristic pattern, and if the characteristic user pattern does not match, a determination may be made that the actual user accessing the network from such desktop 350 is not authentic and does not match the username and password used to log onto the network. In that event, access to the network may be denied to the desktop 350. Alternatively, an alert may be transmitted to security personnel 620 as shown in FIG. 5, or other security alert actions taken.

In general, listeners may be used to detect communications between the operating system and the user's applications. A listener may be advantageously positioned between the operating system and the user, and may listen to all traffic between the user's applications and various input devices that are being actuated by the user in the course of performing a business process. Listeners may be positioned on the server side of a client-server system, and can listen to database events and other server events.

A user working at a task on a workstation will activate one or more of the input devices in the course of performing the task. As shown in FIG. 2, listeners receive raw information representative of mouse clicks, key actuations, and so forth, and provides such raw information to the desktop observer 557. The listeners 550 may capture all control information on the screen, the control data, screen images, and control images. In a preferred embodiment, the raw data is assembled or packaged into an XML format and stored in the form of XML scripts or sentences in memory 558. In addition, audio may be simultaneously recorded from an audio input while user interactions are occurring and user interaction data is being captured. For example, a user engaged in a business activity involving receiving telephone orders and entering information obtained from a caller into a database on a computer may have audio from the telephone conversation recorded in addition to the user interaction data from the various input devices. Similarly, video depicting the user's activities may also be recorded by a camera.

In a preferred embodiment, the overhead imposed on a user desktop by data capture software is reduced by selectively capturing only a subset of the potentially available user interaction data. A preferred implementation captures (1) information identifying the software application that was in use by a user in the performance of a business process; (2) information representative of data in data fields on a screen that was being used by the user in that application; and (3) a screen identification value determined based upon control array information corresponding to the screen. Every user mouse click and every user key press on a keyboard need not be captured. Data representative of key actuation events and mouse click events that took place while the user was using a screen may be obtained as a consequence of the capture of the previously discussed information.

Attempting to capture every key stroke on a keyboard and every mouse event significantly increases the intrusiveness of the capture software, and potentially impacts the operation and performance of the user's desktop and the applications in use. Attempting to capture every possible user interaction event would typically require the use of a relatively large number of hooks that are used to intercept keyboard and mouse events. The greater number of interception points increases the potential for software crashes or interference with data input into an application. A preferred trade off is made between stability and high fidelity data. Lower resolution data is still satisfactory for purposes of the present invention, while reducing the potential for interference with the operation of the user software application. In addition, it may be more difficult to recognize the business process that was being used by a user at any given time from the relatively large amounts of data that results from capturing every possible event. In a sense, the forest may be difficult to see due to all of the trees. Limiting data capture to essential information, or more significant information, may reduce the complexity of algorithms used for the discovery or identification of business processes.

In a preferred embodiment, desktop observation is nonintrusive to the extent all observation on the desktop 350 is transparent to the end user. In other words, collection of observation events should add only a trivial overhead to a Windows® operating system. This is achieved through a variety of levels of sophistications and techniques employed in the present invention.

Referring to FIG. 4, significant features of the present invention contribute to nonintrusive operation of the desktop agent 532 and data capture on the desktop 350. The amount of work needed to collect the user interaction data is minimized by the Windows® hook callbacks that are employed by the listeners 550. One way this is achieved is that only messages of interest are interpreted. Otherwise the hook callback returns early. This may be appreciated by examination of the following excerpt of software code utilized in connection with the present invention:

static LRESULT CALLBACK MouseProc(UINT nCode,
WPARAM wParam, LPARAM lParam)
{
if (nCode != HC_ACTION || nCode == HC_NOREMOVE )
{
return CallNextHookEx(g_mouseHook, nCode, wParam, lParam);
}
if(IsCurrentProcessCapture( ) == TRUE)
{
// Don't capture messages on captureApp
return CallNextHookEx(g_mouseHook, nCode, wParam, lParam);
}
//
// Process only Mouse Down messages
//
switch(wParam)
{
case WM_LBUTTONDOWN:
case WM_MBUTTONDOWN:
case WM_RBUTTONDOWN:
case WM_NCLBUTTONDOWN:
case WM_NCMBUTTONDOWN:
case WM_NCRBUTTONDOWN:
case WM_LBUTTONDBLCLK:
case WM_MBUTTONDBLCLK:
case WM_RBUTTONDBLCLK:
case WM_NCLBUTTONDBLCLK:
case WM_NCMBUTTONDBLCLK:
case WM_NCRBUTTONDBLCLK:
break;
default:
return CallNextHookEx(g_mouseHook, nCode, wParam, lParam);
}
....
}

Another significant feature of the present invention that contributes to nonintrusive operation is in the use of thread pools in queuing events in the desktop observer 557 when messages are submitted via various listeners 550. Use of a thread pool optimizes asynchronicity of event queuing and allows for the hook callbacks to return immediately allowing for further processing of Windows® messages without any perceptible delay to the end user. This may be better appreciated by an examination of the following excerpt of code used in the present invention:

if(bWriteToDB)
{
ArrayList tempList = (ArrayList)eventList.Clone( );
eventList.Clear( );
syncEvent.Reset( );
string
threadPool=EpiConfigurationSettings.Instance.AppSettings.Get(Utils.Constants.THREAD
POOL_IMPLEMENTATION);
if (threadPool==null ||!threadPool.Equals(“TOUB_MANAGED_THREAD_POOL”))
{
ThreadPool.QueueUserWorkItem(new WaitCallback(Insert), tempList);
}
else
{
Toub.Threading.ManagedThreadPool.QueueUserWorkItem(new
WaitCallback(Insert),tempList);
}
if (bQuitting)
{
//
// If a EPI_QUIT message is sent we need to ensure that
// all queued events are writtent to database before
// we close DesktopObserver.
//
logger.Debug(“before epiquit event”);
string waitFor =
EpiConfigurationSettings.Instance.AppSettings.Get(Utils.Constants.QUEUED_EVENTS
_TO_DB_DURATION);
int waitDuration = 10000;
if(waitFor != null) { waitDuration = Convert.ToInt32(waitFor);}
syncEvent.WaitOne(waitDuration, false);
logger.Debug(“after epiquit event”);
bQuitting = false;
}
}

Yet another significant feature of the present invention that contributes to nonintrusive operation is that events are only uploaded to the server when the user's computer 350 is idle. This allows for perceived network latency to be minimum while allowing for large amounts of data including images 560 to be uploaded to the server 375. In addition to the flowchart shown in FIG. 3, the following software code used in the present invention illustrates how the invention operates:

{
string imgUploadString =
EpiConfigurationSettings.Instance.AppSettings.Get(Utils.Constants.IMAGE_UPLOAD_{—}
THREAD_DURATION);
if(imgUploadString != null) { imgUploadDuration =
Convert.ToInt32(imgUploadString);}
while(true)
{
if( Helper.GetLastInputTime() >= imgUploadDuration)
{
logger.Debug(“Uploading Images : ” + imagePath);
UploadImages(imagePath);
}
Thread.Sleep(imgUploadDuration);
}
}
catch(Exception ex)
{
//
// If thread is being aborted then the Sleep statement will
// throw an exception. Not catching the exception would trigger
// WatchDog, which is not desirable. At the same time adding
// any extra code here would still cause an exception in WatchDog
// because thread is aborted.
//
logger.Error(“In UploadImages ” + ex.Message + “:” + ex.StackTrace);
ExceptionPolicy.HandleException(ex, Utils.Constants.EXCEPTION_POLICY);
}

A communication link 559 is provided to transmit data from the user desktop 350 to the storage and/or analysis components associated with the server 375. The communication link 559 is preferrably a network connection, such as an office local area network. Any communication link capable of transporting data may be employed, however. Examples of useable communication paths include wireless digital connections, point-to-point dial-up connections, direct links via CATS cable, radio links, wide area networks, the Internet, fiber optic links, and other data paths. It is preferred that an http protocol 559 be provided for communication between the sever component 375 and the client component 557.

Web Application Observer

The web observer component 365 resides on the web application server 363 and observes and reports on interactions between external users and web applications. The web observer 365 is capable of determining what a user did on a given web page, and not just what links he or she clicked. Javascript is embedded in a web page to provide statistics on user interaction with the web page. The user interaction data that is captured is not limited to information about clicks on links.

Conventional web analytic tools operate on web server log files, thus limiting visibility into end user interactions with web pages to page to page transitions. Due to the inherent nature of how the web works in the Internet, web server logs cannot contain the kind of information that it is desirable to have for use in connection with the present invention. It is desirable to have the ability to measure the amount of time that a user spends on individual fields or controls in a web page. It is desirable to have the ability to see how many times a particular control was visited or refilled by a user. Web server logs only contain information about interactions that require the end user's browser to contact the web server. However, for navigation inside a web page, the browser does not contact the web server. Therefore, information concerning a user's navigation inside a web page will not be contained in web server logs.

The present invention focuses on providing a relatively fine granularity of useful information describing user experience within web applications. Captured data preferrably includes navigational and input facts at the keystroke and mouse click level, yielding intra-page and inter-field latencies, precise navigational pathways among fields, failure paths, partial or abandoned data entry at the field level, and editing behaviour within text fields. The higher level reporting, such as time spent on a page, is a straightforward rollup of the level of detail provided by a web observer component 365 in accordance with the present invention.

There are two alternative embodiments of methods to deploy the web observer component 365. In a first embodiment, a web master in accordance with the present invention injects a piece of JavaScript code into the header page of a web application 365. In a second embodiment, a proxy server is deployed between the end user and the web application so that the web application pages can be instrumented with JavaScript at runtime.

In a preferred embodiment, JavaScript loads when a web page is loaded into the end user browser through the following mechanism:

```
//Attach Our event handling code at self load time.
if(self.attachEvent)
{
  self.attachEvent(“onload”, epianceLoadHandler);//IE
}
else if(self.addEventListener)
{
  self.addEventListener(“load”, epianceLoadHandler, false);//Gecko
compatible
}
else if(self.onload !=null)
{
  var OL = (self.onload) ? self.onload :function ( ) { };
  self.onload = function(stdEvent)
  {
    OL(stdEvent);
    epianceLoadHandler( );
  }
}
else
{
  //lastChance
  self.onload = epianceLoadHandler;
}
```

Once this JavaScript is attached to a web page, the web observer 361 can gather all types of user interaction events (focus gain/lose, button click etc.) and send information representative of such user interaction events to the process intelligence server 375 similar to the manner in which capture data is sent to the process intelligence server 375 by the user desktop component 354. ExemplaryJavaScript to accomplish this function is as follows:

```
function epiancePostData (peventData) {
      if (!_epianceGiveUp) {
      try {
      _epianceXmlhttp.open(“POST”, epianceServer, true);
      _epianceXmlhttp.onreadystatechange=function( ) {
        if (_epianceXmlhttp.readyState==4) {
          if (_epianceXmlhttp.responseText != “success”) {
            alert(_epianceXmlhttp.responseText);
            _epianceGiveUp=true;
          }
        }
      }
      _epianceXmlhttp.setRequestHeader(“Man”,
“POST “+epianceServer+” HTTP/1.1”);
      _epianceXmlhttp.setRequestHeader(“MessageType”, “CALL”);
      _epianceXmlhttp.setRequestHeader(“Content-Type”, “text/xml”);
      _epianceXmlhttp.send(epianceEncode64(peventData));
    } catch (E) {
      alert(E);
      _epianceGiveUp=true;
    }
  }
}
```

In order to not compromise end user experience with web applications, the web observer 361 preferrably will only submit data at page unload time when the user is finished interacting with the web page.

Application Observer

Referring to FIG. 5, the application observer component 602 observes and reports on relevant interactions between applications 605 and back end resources, such as application servers, communication buses, web services, and databases. Application observer 602 complements desktop observations from the desktop observer 532 with data from transactional data sources. Since transactional data in enterprise systems tends to be more amenable to straight processing for interpretation, it is used to correlate data from human computer interactions to the application transaction.

The application observer 602 resides on application database or application log file system. The application observer 602 collects information on interactions between an application 605 and an application server. The application observer 602 observes information concerning interactions between an application 605 and web services or databases. In addition, the application observer 602 observes and reports on interactions between an application 605 and communication buses. Application observation is achieved through server log analysis or a message bus (such as JMS 617) typically implemented by EAI vendors, or which may be custom developed. All application observation messages are converted into XML representing events, and are sent to the process intelligence server 375 for analysis just like desktop events.

Details of Captured Data

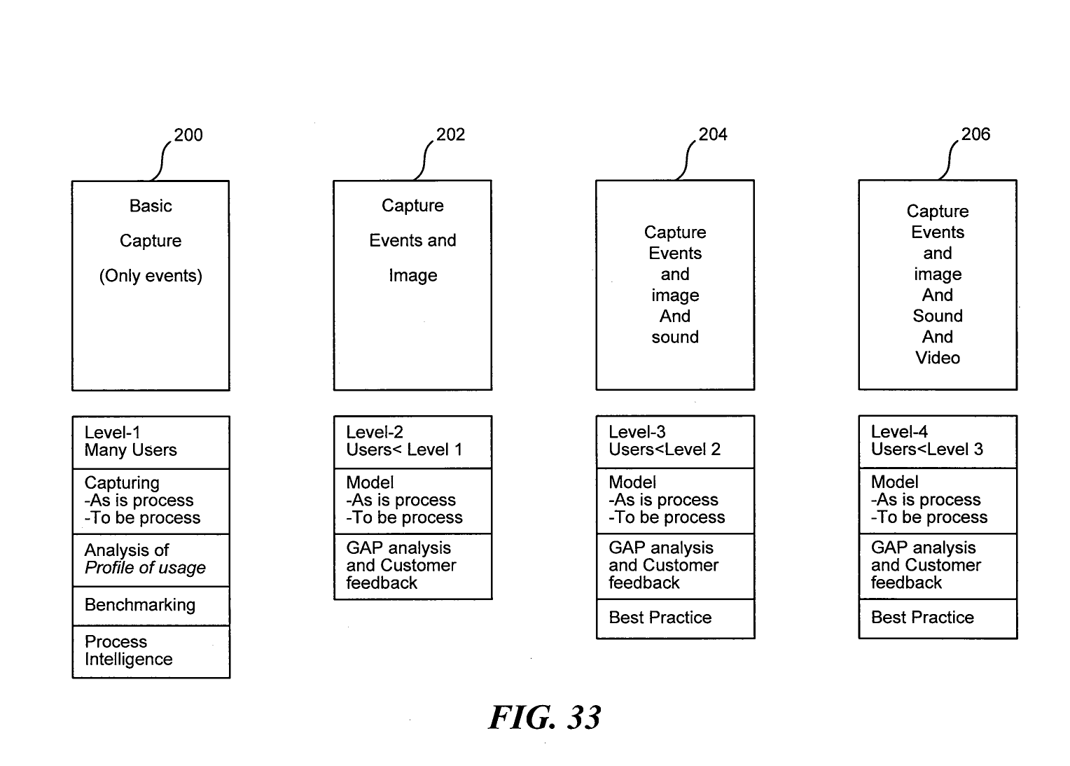

FIG. 33 illustrates various levels of capture. At the left hand side is shown the basic capture 200 (only events and no images/sound/video) which may be used to determine the “as is” processes that are being used. The second level of capture 202 involves events and images. Images may be captured, for example, when customer feedback is being sought. At the third level of capture 204 events, images and audio may be captured. This level of information may be useful to formulate the best practice or to determine the gap between a best practice and the process that is actually followed. The fourth level capture 206 provides the most comprehensive amount of capture data. Level four 206 and level three 204 capture are useful when it is desirable to determine the manual activities that are followed as a part of the process.

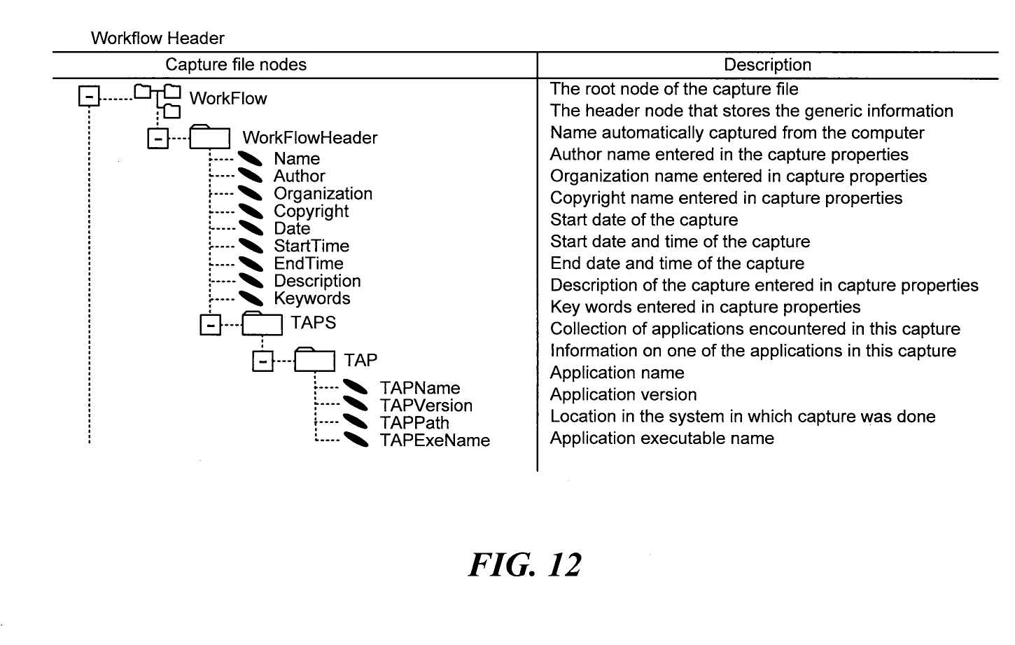

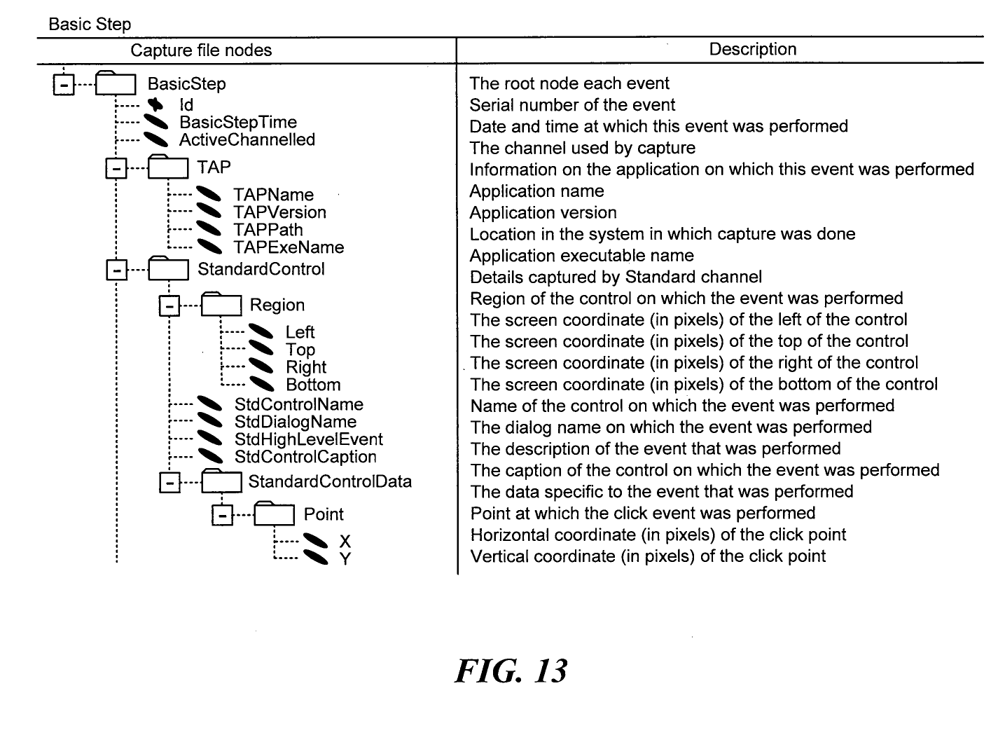

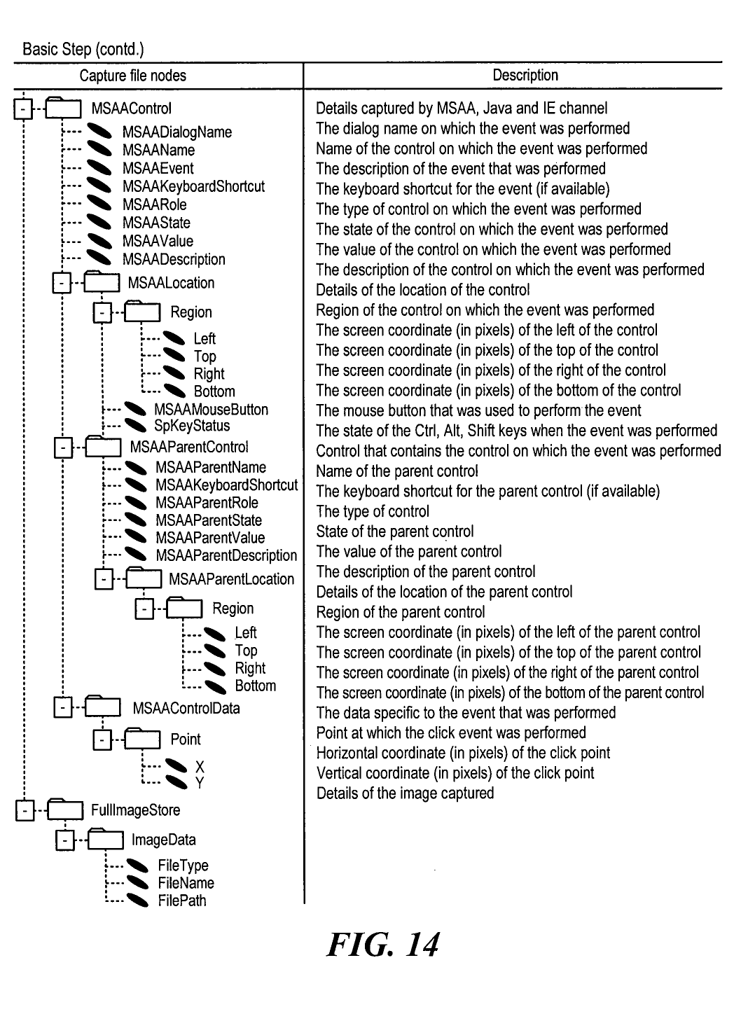

An example of an XML file in which captured information is stored is shown in FIGS. 12, 13 and 14. The illustrated capture file is divided into two sections, the workflow header (FIG. 12) that has generic information about the capture, and a series of basic steps (FIGS. 13 and 14). Each basic step represents an event that was performed and has information specific to that event. The tables of FIGS. 12, 13 and 14 describe the nodes in the workflow header and basic steps, including setting forth the capture file nodes and the description.

The following is a general description of information that is captured in an XML file. In addition to the information detailed below, the following attributes are captured in the XML file: Window ID; Parent Window ID; Thread ID; Process ID; and Modality. An example of such data as it is preferably captured in an XML file is as follows:

<FgrndWnd>460238</FgrndWnd><FgrndParent>0
</FgrndParent><FgrndModal>false</FgrndModal>
<ThreadId>3464</ThreadId><ProcessId>3612</ProcessId>

There are four types of data that may be captured in an XML file: user information, basic capture information, application information, and step information. The following user information may be captured:

(1) The name of the user, which is automatically captured from the computer.

(2) Author name entered in the processor properties.

(3) Organization name as per the license

(4) Copyright as entered in the processor properties. 24

For basic capture information, the following may be captured:

(1) Start date and time of capture

(2) End date and time of capture

(3) Description of the capture file entered in the Properties of processor

(4) Keywords—This can be used for search purposes. Again entered through the processor.

For application information, the following may be captured:

(1) Application version

(2) Application path

(3) Application name

(4) Application executable name

For step information, the following may be captured:

(1) Serial ID of the step

(2) Date and time when the event was performed. In one embodiment this is Year-Month-Day-Hour-Min-Sec-Millisecond.

(3) The channel used for capture—In one embodiment this includes the following channels
Java
MSAA
IE Based applications
Standard applications
16 bit applications
Any other adapter such as SAP etc

(4) Region of control—Gives the top, left, right and bottom of the control which with the user interacted.

(5) Control name—name of the control

(6) Dialog name—The dialog in which the control is present.

(7) High level event such as click, double click, etc.

(8) Caption of the control as shown in the label of the control

(9) Point X, Y where the click or double-click happened

(10) Keyboard Shortcut for the control if any

(11) Role of the control (Button, Checkbox etc.). This basically gives the type of control.

(12) State of the control—This can be checked, unchecked, etc.

(13) Value of the control—Applicable only for textbox, list or combo.

(14) Description of the control which is sometimes present.

(15) Mouse Button used—right, left or middle button that was used.

(16) Special key status with which the mouse action was performed—such as Alt, Ctrl, Shift, etc.

(17) Control data—gives the keys that were pressed or data in the control.

(18) Parent control name—A control may have a parent.

(19) Parent control role

(20) Parent control state

(21) Parent control value

(22) Parent control description

(23) Parent control location—Left, top, right and bottom

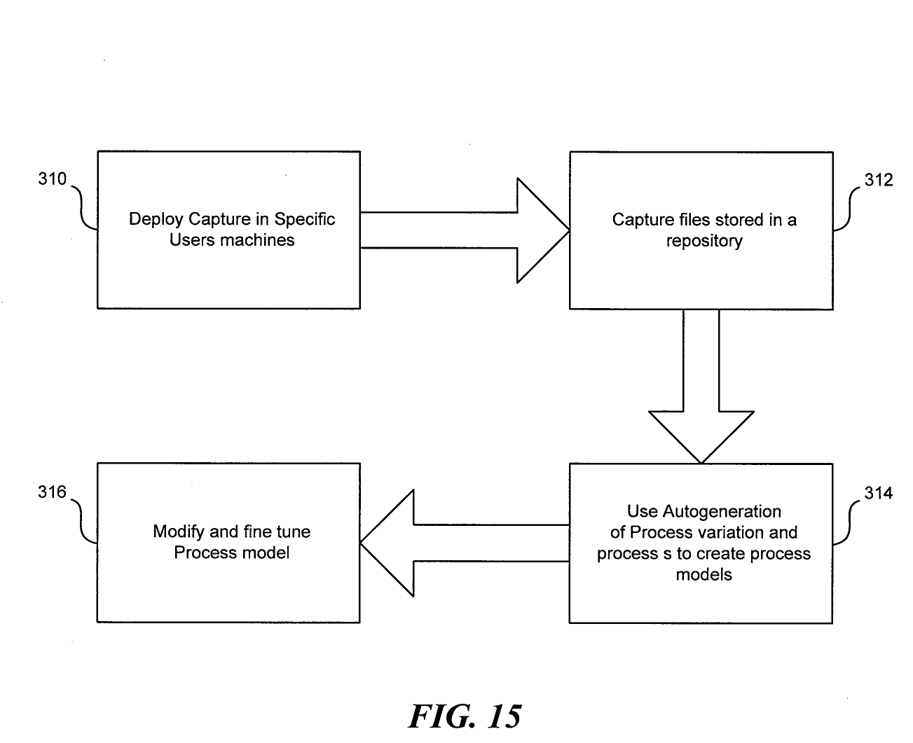

A method of data capture is shown in FIG. 15. Remote capture is deployed on specific users' machines in step 310. The duration of capture, the period of capture, and the applications to be captured are specified. Captured data is stored in a repository in step 312. Autogeneration of process variation and processes is used to create process models in step 314. The process model may be modified and fine tuned in step 316.

In summary, the remote capture includes automated capture of events. The captures may include still images, audio and video. The capture is based in target definitions, including scheduling of the capture, identification of applications to capture, identification of processes to capture and identification of events to rapture. The remote capture provides automatic capture of business processes, particularly those that employ software applications for a significant portion of the process. The capture coverage is extensive, and can provide continuous process observation and monitoring. The captured events are cataloged at various levels, on-line and in real time. Alternately, the events are captured off line and in batch mode. The capture data is analyzed according to the process definitions.

An upload of the captured material is performed on a schedule or during idle time. The capture is based on security definitions so that there may be defined items which are not to be captured. This is defined based on privacy definitions and on privacy acts.

System for Processing Captured Data

The data captured based upon user interactions with their workstations is processed to develop improved business processes and to provide useful output to guide or teach users. The data captured may also be used to monitor compliance, to detect unauthorized usage, to measure system responsiveness from a user's perspective, to determine actual costs of using certain applications or features and functionalities of certain applications, to improve the usability of applications, to detect usage of new application functionality, to maintain records or an inventory of actual application usage, and for many other useful purposes.

FIG. 1 depicts an overall block diagram of a preferred system architecture. The presently preferred architectural foundation provides for building out new functionalities. Individual products may be implemented as software modules that conceptually plug on top of a common back-plane. This preferred approach provides dual advantages to leverage both technology infrastructure and services across product suites while maintaining a consistent user experience.

As shown in FIG. 1, user workstations 350, 351, 352 and 353 have software agents 354, 355, 356 and 357 installed or downloaded onto the desktops. The agents include application observers 354, 355, 356 and 357 that capture and record data indicative of user interactions with the user's workstation 350, 351, 352 and 353, respectively. Captured data is fed into a desktop listener 358, as shown in FIG. 1.

In addition, data is captured from business application servers 359 and 360 using application listeners 361 and 362, respectively. A novel web observer or web listener 365 is used to capture data concerning a user's interaction with a web page maintained on a web server 363. The web observer 365 comprises Javascript embedded in a web page, and provides data concerning what a user did in connection with a web page, not just what links the user clicked on. The Javascript produces statistics and data concerning as user's interaction with a web page on server 363. Web observer or web listener 366 functions in similar fashion for web pages associated with web server 364.

A preferred embodiment includes a process intelligence server 375. The process intelligence server 375 comprises a raw data store 370, a process discovery software module 371, and a process master data store 372. The process intelligence server 375 processes user interaction data.

User interaction data from desktop listener 358, from application listeners 361 and 362, and from web listeners 365 and 366, is transmitted or otherwise communicated to the raw data store 370 as shown in FIG. 1. In a preferred embodiment, raw data store 370 may comprise an SQL database management system. Raw data store includes information concerning user activity and information containing application portfolio usage.

A process discovery software module 371 is provided for interpreting and modeling the raw data contained in the data store 370. The process discovery module 371 includes functionality that can interpret the raw data and identify business processes or subprocesses that users are performing on their workstations 350, 351, 352 and 353. The process discovery module 371 can learn by example to automatically identify the business process that any user was engaged in at any particular time. The process discovery module 371 can automatically determine that a pattern of user interactions is an identifiable business process, using capture data that spans several different software applications, and is not limited to identification of processes within the context of a particular software application. The process discovery module 371 can identify a business process that may include the simultaneous use of more than one software application which might be unrelated to each other, and can identify a business process that may involve multiple users 350, 351, 352 and 353 participating in the business process. The process discovery module 371 performs process modeling and process discovery.

Information relating to business processes identified or specified by the process discovery module 371 is communicated or transmitted to the process master data store 372. In a preferred embodiment, the process master data store 372 may comprise an SQL database management system. The process data store 372 processes information relating to business processes derived from captured user interaction data and processes it to provide process performance metrics, identify or specify best practices, determine application productivity impact, determine compliance, and achieve process optimization. Referring to FIG. 1, process content may be fed back to a content server 374 that can be provided to a user 350, 351, 352 or 353 at an appropriate time and in a relevant context. The content server 374 produces contextual intervention with a user 350, 351, 352 or 353, which may be from a context outside a particular application. A user's interactions can be analyzed across multiple software applications. The content server 374 can intervene with help or other appropriate actions based on the context in which the most current user interactions with the user's workstation 350, 351, 352 or 353. Thus, a user desktop module 350 comprises data capture functionality together with contextual intervention functionality.

A system console 373 is provided to provide reports and views of process data or user capture data, typically as an aide to management responsible for the performance of the business enterprise. A studio 376 is optionally provided that comprises a user desktop for software modules such as a Process Workbench, Modeler Workbench, Alerts Workbench, Content Workbench, Integrator Workbench, and Reporter Workbench, which are described more fully below.

Referring to FIG. 5, the process intelligence server 375 comprises a manager 610, an analyzer 611, and a reporting module 612. A services component 609 is also provided. A security unit 613 and a configuration unit 614 may also be provided.

User Desktop Module

Referring to FIG. 1, the user desktop component or agent 354 resides on a user's desktop 350 and functions to provide information or data representative of observations of the end user activities, and this information or data that is captured at the desktop 350 may be expressed in various document formats suitable for generating end user documentation and business process analysis. The user desktop component 354 communicates captured data to the raw data server 370 for further processing and analysis. The user desktop component 354 also provides contextual intervention and end user assistance from content server 374. The user desktop component 354 provides a highly configurable environment where level and detail of capture can be easily changed by settings that may be set from the server side.

The user desktop component 354 is non-intrusive in terms of memory and CPU footprint. In a preferred embodiment the user desktop component 354 should be stable, because any instability on its part will directly impact the end user's ability to perform critical business processes. The user desktop component 354 preferrably manages its storage requirements as it resides on a user desktop 350 to minimize any impact on the user's use of the desktop 350. Although the above description has been with reference to desktop 350 and desktop agent 354, it will be understood that the description applies equally to the plurality of illustrated desktops 350, 351, 352 and 353, and the plurality of desktop agents 354, 355, 356 and 357, respectively, shown in FIG. 1.

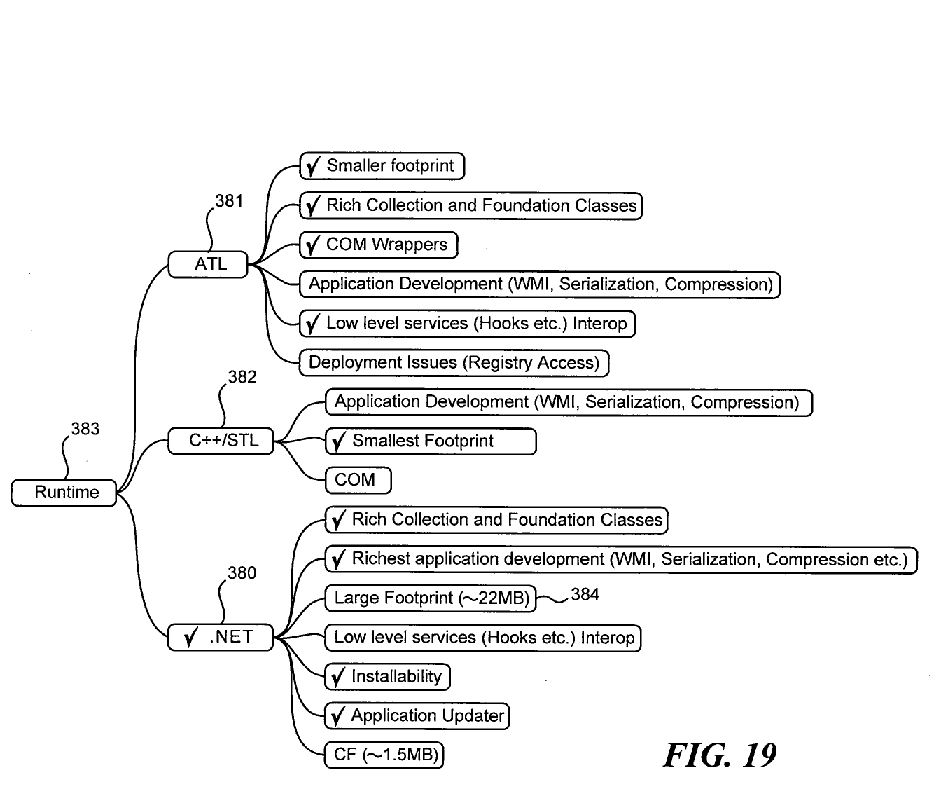

FIG. 19 illustrates a decision tree concerning considerations for selecting a preferred implementation of the user desktop component 354. The preferred platform of .NET 380 is used for development of the desktop component 354. As among the STL platform 382, the ATL platform 381, and the .NET platform 380 shown in FIG. 19, the .NET platform 380 provides the richest application development environment. The only downside to using .NET for the runtime environment 383 is its potentially large footprint indicated by reference numeral 384. This is not an issue on desktops on which .NET runtime is installed already, in which case the need for an installer to carry it around is obviated.

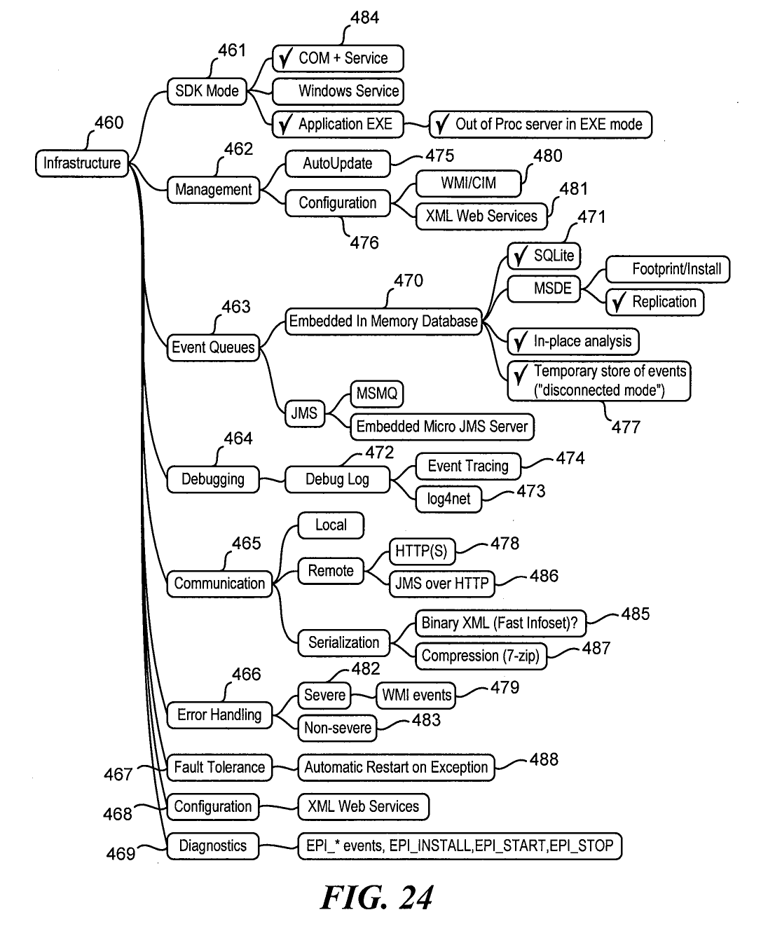

A preferred infrastructure for the desktop agent 354 is shown schematically in FIG. 24. The agent 354 is responsible for providing all infrastructure services 460 to the desktop components 354. In a preferred embodiment, the event collection framework is kept relatively thin, and common infrastructure services 460 are shared across the various desktop components. Shared components provided by the desktop agent 354 include a communication subcomponent 465. In a preferred embodiment, the communication subcomponent 465 uses http and https protocol 478 for communication with the server 375 and the server 374. Security in communications is achieved using https for sensitive data transfers. Standard http is used where the overhead of using https overweighs the data sensitivity. Use of http based communication is preferred because it is firewall friendly. Data is mostly sent between the desktop 350 and the server 375 in XML format with compression. Alternatively, data may be sent in binary XML format 485, with the choice of formats being made depending on needs, for example, considerations of speed or data size. Those skilled in the art will appreciate, after having the benefit of this disclosure, that other formats and protocols may be used, such as JMS over http 486, or alternative compression schemes 487.

The infrastructure 460 provided by the desktop agent 354 includes a management subcomponent 462. The management subcomponent 462 functions to automatically update the desktop components 354 based on server configuration parameters provided to a configuration management component 476. For example, if there is a newer version of the desktop module 354, or subcomponents thereof, available on the server 375, the management subcomponent 462 will engage an autoupdate component 475 to download the respective updated files and incorporate new functionality in the desktop component 354. In a preferred embodiment, the management subcomponent 462 employs WMI techniques 480 for enterprise management (WBEM). Alternatively, XML web services 481 could be used.

In a preferred configuration mode, a data capture or observation system is deployed in two steps. In a first step, a system administrator configures the capture in an initial configuration mode where all observations of the captured data are reported back to the server 375. Once the screens are identified and certain fields within the system are marked as being of interest, a second step of the configuration is performed, and second configuration information is now pushed out to the observers 354, 355, 356 and 357 through a heartbeat mechanism. Once second configuration information is received, the listeners 358, 361, 362, 365 and 366 switch to a “deploy” mode wherein only a predetermined set of configured fields are observed. This method makes the capture non-intrusive and reduces the amount of data that needs to be carried from the observer 354 to the server 375.

The preferred infrastructure provided by the desktop agent 354 includes an error handling subcomponent 466. The operation of the error handling subcomponent 466 depends on the nature of an error encountered during execution. In the case of a non-severe error 483, the agent 354 logs the error and continues execution. In the case of a severe error 482, the agent 354 terminates execution. In a preferred embodiment, Windows® Exception Management Application Block 479 is used to flexibly publish all exceptions in a manner known to those skilled in the art. The desktop agent 354 also includes a debugging subcomponent 464. In order to aid field debugging of the desktop agent 354, a debug log 472 is maintained by the debugging subcomponent 464. In a preferred embodiment, a configurable logging framework employing log4net 473 is used. Alternatively, event tracing 474 may be used in the debug log 472. A fault tolerance subcomponent 467 is provided. Unhandled exceptions will be bubbled all the way to the top and logged. Once an exception is logged, an automatic restart on exception component 488 is invoked to restart the agent 354 in order to prevent service interruption.

It is desirable for functionality that is available on the desktop agent 354 to be made available to third party applications. If other software developers must write their own software code to perform certain functions, the user desktop 350 will have resources unnecessarily consumed by each individual software program providing redundant software code to perform the same function. In a preferred embodiment of the present invention, functionality available from the desktop agent 354 or its subcomponents 462, 463, 464, 465, 466, 467, 468, and 469, is made available externally using a software developers kit (“SDK”) mode 461. In one example of the present invention, the SDK mode 461 of the desktop agent 354 exposes all third party useable functionality or consumable functionality for use by other software modules through COM Interop services 484. A COM+ service API 484 may be provided for third party software to invoke functionality available from the agent 354, so that the third party software need not provide its own redundant code to perform such functions.

The desktop agent 354 includes a configuration subcomponent 468. The configuration subcomponent 468 is operative to download configuration settings and configuration information from the server 375. The configuration subcomponent 468 may also provide configuration information to other desktop subcomponents 462, 463, 464, 465, 466, 467, 469, and 461 internally. For example, there may be certain security environments in which it is desirable to disable the SDK mode 461. The configuration subcomponent 468 may provide the ability to configure the agent 354 such that internal functionality may not be accessed by third party applications (perhaps for security reasons).

Process Intelligence Server

Referring to FIG. 1, the process intelligence server component 375 resides on a high-end server node, which is preferably used to deploy new software modules and updates to software modules. The process intelligence server 375 includes the raw data store 370, the process discovery software module 371, and the process master data store 372. The process intelligence server 375 provides the business logic for process analysis. The process intelligence server 375 provides access to a transactional database 370 and services for manipulating and accessing transaction data and business entities. The process intelligence server 375 also provides security services for the system. Alerting and notification services are provided by the process intelligence server 375. In addition, the process intelligence server 375 provides content management and versioning. The generation of reports for analysis and enactment is another function of the process intelligence server 375.

In a preferred embodiment, J2EE is chosen as the platform for the process intelligence server component 375. One reason J2EE is presently preferred is because it is the most prevalent enterprise development and deployment platform. Enterprise applications are built using J2EE for easier integration and deployment in the enterprise. In addition, J2EE containers provide sophisticated services of state management and inter-object communication that can easily be leveraged by components of the process intelligence server 375. While ‘page’ oriented systems such as PERL and PHP do provide highly scalable deployment platforms for web applications, such systems lack enterprise aspects such as server state and connectivity in terms of being able to integrate and communicate with other enterprise applications using messaging. Most third party integration toolkits (logging, build management, reporting, scheduling etc.) are Java based, which allows external utilities to be leveraged for many commonly used tasks.

The process intelligence server 375 preferably includes architectural layers in the main component of the server comprising a presentation layer, a business logic layer, and an EIS and data layer. Layering allows independent functioning, assembly and separation of concerns. This aids in easy maintenance and provides the capability to swap technologies and tools independently of each other. For implementing each architectural layer, a suitable framework is chosen. Frameworks are very powerful in that they enforce best practices based on many years of collective experience of the authors. This improves developer productivity and enforces good design.

Use of Enterprise JavaBeans (“EJBs”) are preferably avoided. While the EJB specification may have started out in the right direction, it has drawn serious criticism for its implementation complexity and lack of standardization among application server vendors. Instead, a preferred embodiment should rely on true and tried frameworks like Spring 510 that provide similar services while being lightweight and highly scalable. Notifications provide a standard way for beans within the Spring container 510 to interact with each other. This is used to create local publish subscribe notifications within the Spring container 510. Spring 510 provides a simple mechanism for sending and receiving events between beans. To receive an event, a bean implements the ApplicationListener interface and to publish an event, the publishEvent method of ApplicationContext is used.

Several patterns of enterprise application architecture have been applied while building the architecture. Some of them are implicitly incorporated by the framework or tool of choice, while others will be explicitly incorporated in the design. The preferred patterns are layering, MVC, Loc/Dependency Injection, data access objects, composite, adapter, facade, and chain of responsibility.

In the process intelligence server 375, the presentation layer has been implemented using Tapestry 519. Tapestry 519 offers advantages in web application development in terms of objects, methods and properties instead of URLs and query parameters. User interface components are validated using Tapestry's validators that encapsulate specific validation rules. Both server side validation and client side validation using JavaScript is preferrably enabled using Tapestry's inbuilt validators.

Business objects are preferrably implemented as Plain Old Java Objects (“POJOs”). These will be exposed as remote objects using Spring's support for Axis web services. These objects preferrably interact with the database repository 370, 372 using the ORM layer of Hibernate 518 and interact with other classes using the Spring framework 510. Transaction and security support for the POJOs are achieved using the declarative intercepting mechanism of Spring AOP 510 and ACEGI 508.

JMS is the preferred messaging framework used in connection with the process intelligence server 375. Spring 510 provides aJMS abstraction framework using the JMS template class that is used for integrating JMS into the application. Integration with other naming providers for security, such as LDAP, is achieved using ACEGI 508. Authentication, instance level security using RBAC and authorization of secure resources at the application level is achieved using the ACEGI framework 508. Integration with other applications is over JMS or web services depending on the available messaging paradigm. Web services is used for request-reply interactions, and messaging is used for external notifications and inbound communications. The business components are exposed as web services using Axis (SOAP over HTTP) for the non-Tapestry user interface interactions. The business logic implemented within the process intelligence server 375 is accessible to external applications as web services. All of the Tapestry user interface interactions are made over HTTP and do not use web services. The process intelligence server 375 will publish appropriate JMS events based on configuration settings.

For communication of large amounts of data between user desktops 350 and the server 375, such as image files and out-of-band files, scheduled transfers are preferred rather than communicating large image files along with capture data files. In order to improve performance, compromises are preferrably made in deciding how much of the capture information is to be made real time and how much of it should be made available in offline batch mode.

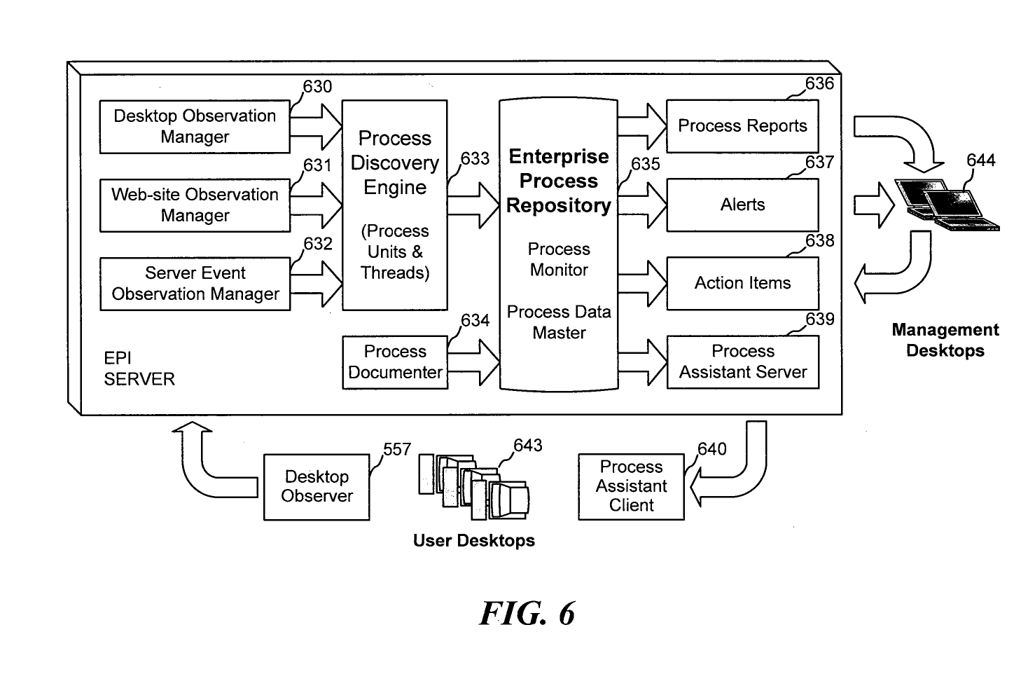

FIG. 6 shows further details of the process intelligence server 375. The desktop observation manager 630, the web-site observation manager 631, and the server event observation manager 632 provide the input of user interaction data to a process discovery engine 633. User interaction data may be obtained from a desktop observer 557 as previously described. It is desirable to process the user interaction data to define business process units and threads.

The process discovery engine 633 creates and stores activities and threads along with screen-shots and event descriptions in the enterprise process repository 635. A process documenter 634 is provided that assembles information about the execution of any selected activity or thread to generate a human-readable document describing the performance of the activity or thread. An activity document is a combination of event descriptions and screen-shots in time-sequence order. A thread document is a combination of event descriptions and screen-shots in time-sequence order. This document is an XML document interchangeable with other editors using XMI. Activity documents and thread documents are stored in the enterprise process repository 635.

The desktop observer 557 constantly creates a stream of observed events based on the activity of a user on a PC. A process assistant 640 uses the event data as a set of search parameters to locate content relevant to the user, and presents the results to the user in two modes. Results may be presented on demand, i.e., when a user requests the results to be displayed. In addition, results may be presented automatically, i.e., the results are always displayed in a window. Since the results presented to the user are based on a search that uses parameters that define the work context, the effect is to deliver “contextual intervention” to people in a “just in time” way as they perform their work.

A preferred implementation of the process assistant 640 uses a search engine such as Lucene. This engine will have a process assistant server component 639 that will search and index the enterprise process repository 635 to create a map of contexts and associated content. The enterprise process repository 635 can store content created by the process documenter 634 or any other content, such as multimedia files, documents, etc.

During initialization, an agent running on the user desktop downloads a map of contexts and associated content. During user interactions, whenever a mapped context is triggered, it launches the associated content. For example, a mapped context may be triggered and launch a help screen for the user to assist the user with instructions for performing a particular business process. This may be better understood by considering the following snippet of the map of contexts and associated content:

<InterventionContext>
<Trigger><Type>Screen</Type><ID>5</ID></Trigger><Action><Type>
LaunchURL</Type><URL>http://epi.acme.com/help/screen.html?id=5
</URL>
</Action>
</InterventionContext>

The desktop observer module 557 running on the user desktop can compute the “screen ID” of a screen the end user is interacting with for each event. The process assistant module 640 on the user desktop can look up the screen ID in the context map and see if there is an intervention context specified for that screen ID. If there is, the process assistant module 640 running on the user desktop performs the associated action, which for example may be to launch a specified URL linking content available on the content service running in the process server 639. In a preferred embodiment, this may be accomplished using the ShellExecuteEx Windows function.

Data Repository

Referring to FIG. 5, the database repository 606 in accordance with the present invention includes a database 608 and storage for images of screens 607. The repository 606 comprises the raw data store 370 and the process data master store 372. The data layer is preferrably implemented using Hibernate 518. Separate scripts are used for indices. Portability is achieved using Hibernate as the ORM layer. The granularity of the data respository schema is preferrably maintained at the process unit level rather than at a step level to reduce the storage requirements for the data warehouse 606. Real-time OLAP requires ROLAP storage of the updated fact partition while query performance is faster in MOLAP. A domain object name is appended with DEFN for a metadata object describing a domain object.

All data and reports within the repository are available for viewing inside web pages as well as for export to various output formats such as CSV, XML, pdf, Excel, or SVG. This allows for built-in analytics to be extended in a progressive fashion. By allowing for import of process data into multiple other tools, the process analytics can leverage the analytical capabilities of other tools rather than having to duplicate that effort itself.

Raw Data Repository

Referring to FIG. 1, the data store or warehouse 370 resides on a database server node and provides the storage of dimension and fact tables for OLAP and reporting. The data store 370 also provides storage of multidimensional data for analysis and management purposes.

The data warehouse 370 is preferrably housed in a leading database product such as Oracle, DB2, SQL Server or MySQL.

Process Data Repository

The process data master store or repository 372 comprises two components. A content repository resides on the server file system and contains document centric artifacts such as images and HTML files. The process data master repository 372 includes an OLTP database that resides on a database server node and which provides relational storage of various business entities and system configurations. The OLTP database allows querying of business data for report generation and presentation. The OLTP database includes extensive storage of OLTP programs that allow real-time inputting, recording, and retrieval of data to or from a networked system. The process data repository 372 is preferrably housed in a leading database product such as Oracle, DB2, SQL Server or MySQL.

In a preferred embodiment, captured data includes screen shots. The data concerning a user interaction may be associated with the actual active screen that was displayed on the user's workstation when the associated user interaction occurred. Thus, reports generated by the system may include an image of the user's screen associated with captured user interaction data. Additionally, data available for analysis may include an image of the user's screen associated with captured user interaction data.

Business Process Specification

It is not simple to create specifications for business processes. In contrast to manufacturing, where strict adherence to a process yields the required product, the opposite is true for business processes. For example, in telesales, an insistence on first creating the customer record before checking product availability may only succeed in irritating the customer. There is often more than one way to accomplish a task. For instance, some customers want to specify the mode of shipping, others simply choose the cheapest way. Business processes that are too rigid are brittle. They inhibit adaptation to inevitable change and waste the power of precious human resource. Specification, however, is an absolute requirement for outsourcing and necessary for process improvement. The solution to this problem is not trivial.

Business processes may be decomposed into well-structured tasks, but the tasks may be accomplished using various behaviors. A process is better stated as a combination of functions to be accomplished than as a string of tasks. Each function is accomplished by one or more task behaviors. A set of functions connected by a common thread such as “insurance claim” or “customer support case” forms the horizontal process to be managed; “insurance claims processing” or “customer support”, specifies the business goal of the process.

A business process specification consists of task specifications and thread specifications. A task specification is preferrably done as a task SCXML that provides a specification of how an business task (or activity) is accomplished. A task instance is comprised of individual event instances, such as screen-flows and data entry, that gain business relevance from the completion of the task. Tasks are discovered by pattern-matching rules that apply an SCXML artifact to match the observed event data-set and report matches as task instances. A task may be a single screen being traversed, a collection of screens that occur in tight logical connection for executing a task, or other simple rules that can be implemented in task SCXML.

A suitable task specification that will be readily understood by a skilled programmer is set forth below:

A thread specification may be a set of tasks that share a common business object, such as an SKU number or a purchase order (“PO”) number. A thread instance is comprised of individual task instances. For example, a procure-to-pay thread instance may consist of a set of procure-to-pay task instances that address the life-cycle of the same purchase order from procurement to payment. Threads are discovered by pattern-matching rules that apply common or shared identifiers to match the data-set of observed task instances and report matched sets as thread instances

In practice, process identification may start during the initial deployment of a system in accordance with the present invention at a company. Various aspects of the processes under observation (such as supporting applications or performers) are identified through dialogs with appropriate individuals at the company. Once the process performers are set up on management workstations 644, an analyst tries to look at the event data through studio 376 and tries to visually identify a process start and end, correlating input from the dialogs. Studio 376 has a learn by example mode where, once a process start and end steps have been identified, they can be demarcated and saved as a process definition.

Once this is done, all future occurrences of the process that comprise the same set of start and end steps will be automatically identified without any further configuration. Such an approach works best when the fashion in which the underlying process is being conducted at the company is fairly static with little or no variability. This approach also works best in situations where the processes and their supporting IT applications are well understood.

In cases where the process may be conducted in a highly variable fashion, for example if there are multiple points in an application or a variety of applications, the notion of a process is broken down into activities and activity threads. An activity is a collection of a set of screen entries and exits with all intervening events encompassed between the occurrences of the screen entries and exits. Thus an activity identifies user actions at the lowest level of granularity after screens.

A launch screen method of process identification may be used in accordance with the present invention. Candidate launch screens are identified by measurement of their “out degree,” i.e., the number of screens that were reached with the screen under consideration as the starting point. The “out degree” measure is restricted to the same application so that all the launch screens are identified for a given application. This view is now overlaid with a time sequence to identify the screen transitions and their corresponding count. A candidate termination point is identified. A termination point is characterized by either a return to a launch screen, or termination of an end screen without further transition into any other screen. A candidate for process identification is identified based on launch screens and corresponding termination points. Process identification will specify as a business process the chain of data capture that followed in a time sequence occurring after a launch screen and up until a termination point was reached.

There are important parallels between business and manufacturing process specification. A manufacturing process specification has work instructions that correspond to task behaviors in a business process specification. Work centers correspond to performers (people). Routings correspond to contracts (fewer path restrictions).

The major differences are that business processes can, and should, be executed using any allowable task behavior and any combination of functions that satisfies the contract. In practice, attempts to impose mechanistic requirements to follow manufacturing-style process specifications to the letter are undesirable. In business processes, the fundamental sources of variability are much higher than in manufacturing processes. Manufacturing processes deal with variability in the product (bill of materials), worker, and technology (machines, material handling, etc.), while business processes deal with the work-item (case or claim), worker, technology (applications, communications, etc.), as well as customer behavior (requests).

The observation system provided by the present invention may be deployed not only within the four walls of a single enterprise, but it may reach across the boundaries of multiple enterprises to partners, suppliers, and customers. This allows for extended visibility into the moving object. Thus far, enterprises have had limited visibility into an order or a shipment once it leaves the enterprise and becomes ready for processing by a partner. With the extension of observation system to a partner enterprise performing further services or additional steps in connection with a business process, the same level of visibility into the movement of the object can be maintained across multiple enterprises.

Business Process Catalog

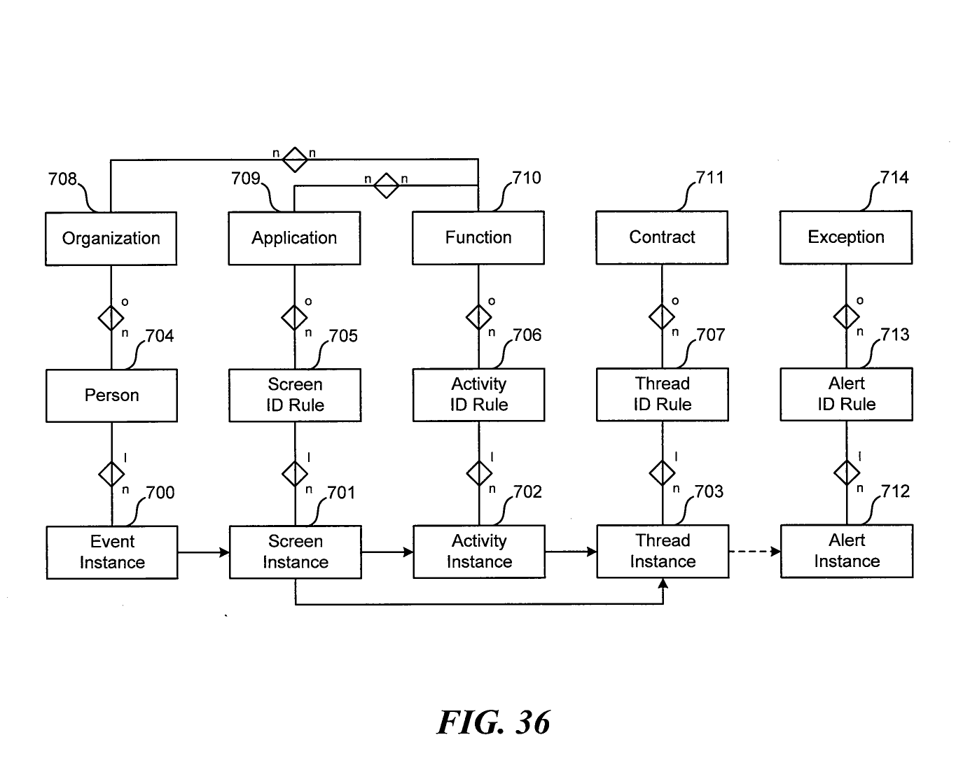

Referring to FIG. 36, the data obtained from the observers 600, 601 and 602 include observer agent installation, event instances 700, screen instances 701, task or activity instances 702, and thread instances 703. This data is used as the basis for a catalog that has various perspectives that key off of the observed data. The catalog supports a multi-tenancy model of use through the use of OrgID column. Since every row in the table as an associated organization a record can easily be attributed to an organization.

Observer agent installation provides information relating to PC hardware, operating system profile, and machine identifier. Event instances 700 correspond to a performer 704, i.e., a person who performed the event instance. Screen instances 701 correspond to a particular software application 709. Task instances 702 correspond to a process decomposition or function 710. Thread instances 703 correspond to horizontal processes 711. Each perspective has a hierarchy, where the observed data serves as leaves.

The PC data serves as a leaf to OS version hierarchy and hardware profile hierarchy. The person 704 provides an organization hierarchy 708 (sets of people). Screens 701 provide an application hierarchy 709 (sets of screens). For example, SAP>R3 v4.6>Materials Management>MMO1 Transaction>MMO1 Screen.

Tasks 702 relate to process decomposition hierarchy (sets of tasks) such as “process claims”>“assess claims”>“retrieve claim data”.

Threads 703 provide horizontal processes hierarchy (sets of threads) such as “Quote to Cash”>“Order to Ship”>“Take Order”.

Reference Model

The catalog supports a multi-tenancy model of use. A business entity such as a customer or a partner can create a reference model from the catalog that is a subset of the catalog. Each tenant's reference model has selected nodes of the catalog hierarchy and the leaves of the specification. It can also be loaded with additional data about any node in the hierarchy, such as:
(1) Performance targets for cycle time, throughput, first-pass yield, or capacity. For example, a person may be expected to process 8 claims per hour. Performance data may be repeated to include baseline, target, and benchmarks. Metrics can be associated with the process specification on any dimension at any level in the hierarchy, for example allowing for local settings of performance targets for call centers in Jacksonville and Bangalore as well as global performance tracking from the merged results.
(2) Resources that are consumed or applied when an instance of the node is observed
(3) Content such as any file, document or image, including “best practice”documentation
(4) Expected cross-connections between perspectives, such as the order-to-ship process is executed by the sales and fulfillment organizations and by the Siebel and SAP applications.
   Business Process Discovery and Inspection

Task and thread specifications are stored in a reference model. Task and thread specifications are loaded into the process discovery engine 633. The process discovery engine 633 creates task and thread instances. Task and thread instances are inspected against the reference model to determine, for example, any variance against predetermined performance targets, or any variance against expected cross-connections between perspectives, such as the order-to-ship process is executed by the sales and fulfillment organizations, not by a procurement clerk.

Task and thread instances are also inspected against similar task and thread instances. Nodes may be compared in the reference model (sets of task and thread instances observed and allocated to the node). This inspection may lead to the gereration of reports on the equivalence or difference in specification as compared to performance. In addition, a selected task and thread instance may be compared against another selected task and thread instance. This inspection may lead to the gereration of reports on the equivalence or difference in specification as compared to actual performance.

Business process discovery and inspection may include functionality for the assignment of costs, compliance, control point discovery by object traversal, best practice identification, security and privacy. Each of these functions is described in more detail below.

Assignment of Costs

Observations capture the interactions of end users with their desktops down to the millisecond. Since granularity of observation is very fine, it is possible to compute times associated with various unit of activities. At the time of performing the tasks, observer tries to automatically assign the task to a given activity based on task attributes (application name, IE URL, etc.). This is presented as the “current” task to the user. If the user wants to attribute the task to another activity she or he can do so through the presented user interface. Costs per employee (or process performer) in the enterprise can be attributed to per unit time measures (hourly rate, annual salary etc.). This information is commonly available in most HR applications and can be tapped into through direct interfaces (web services, APIs) or batch data import (export to CSV or other format e.g.). With the information about cost per unit of time, it is possible to compute the cost per unit of activity through a multiplication of activity time and associated cost per unit of time.
Cost of Activity=Time duration of Activity*Personnel Cost per unit of Time
Compliance

Compliance with regard to conduct of an activity can be translated into occur rent of specific events with regard to a given application screen. Thus, for example, a compliant contract approval scenario should involve actual perusal of entire contract from start to end rather than a mere approval without looking inside the content. A non-compliant instance of the observation would be characterized by missing observations around viewing of the contract document. This can be identified by the process identification step and reported as a non-compliant instance so compliance can be enforced.

Control Point Discovery By Object Traversal

In most organizations the processes are characterized by movement of a key object of interest such as purchase order or shipment through various supporting applications. The object is sufficiently core to the functioning of the organization that in most cases the control points which need to be enforced by the business around the movement of the object are observed on the desktop as screens. Through the observability of screens all control points along the object traversal path can be discovered and reported upon.

Best Practice Identification

Once a process is identified, an instance can be associated with quality metrics and cycle time metrics (duration). Based on this an aggregate measure of goodness of the instance can be assigned to it. All identified instances can then be sorted in the decreasing order of measure of goodness. Once this is done the instance at the top of the list can be identified as the “best” practice. This best practice instance can then be characterized by the details of the screens and intervening user interface interaction events. Now all performers who were not best practitioners can follow this best practice to increase the quality of their business process performance.

Security

Option for encrypted communication from Desktop to Server over HTTPS.

The Server and all its components are security-hardened.

Data is stored in a secure database in the Server with no outside access except for the Epiance application.

Server and data remain under physical control of organization.

Role Based Access Control with row-level data security.

Privacy

The Desktop Agent provides multiple levels of configuring what data is gathered to provide maximum flexibility to the organizations to take care of their privacy needs.

The options include:

Inform/Do not inform user when observation is in progress.

Encrypt/Do not encrypt the user name. While the encrypted name can be used as a unique identifier it cannot be decrypted.

Observe/Do not observe a specified list of applications and URLs (White list/Black list).

The white list and black list provide you with a configuration capability to list the applications, web sites, and fields that are, or are not, observed from the desktop. For example, you may not want to observe a user's chat sessions, or certain branches of a web site.

White list: A list of applications, web sites, and fields that are always observed from the desktop.

Black list: A list of applications, web sites, and fields that are always ignored from the desktop.

Web example: You want to observe web site activity, but only as it relates to specific URLs within a web site. You list the main URL (www.mycompany.com) in the black list to exclude the entire site from being observed. Then, in the white list, you list the specific branch (base URL) within the site where you want to observe activity (www.mycompany.com/myapplication). In this example, the only URLs (pages) that are observed are the ones on the “base URL” that begins with www.mycompany.com/myapplication.

Application example: You want to observe all desktop applications except MS-Outlook email and Yahoo Messenger. In this case you list Outlook and Yahoo Messenger in the black list.

Using black lists and white lists allows certain fields and sensitive screens or web pages (based on URLs) to be excluded from observation, and prevent sensitive data in those screens/pages from being sent to the server.

An example of the configuration of black lists and white lists is described in the code provided below:

```
<!-- blacklisted apps, urls and other information-->
  <blacklist>
  <add key=“Apps”
          value=“(EPISTICK.EXE)”/>
  </blacklist>
      <!-- whitelisted apps, urls and other information-->
  <whitelist>
      <!--<add key=“Urls”
          value=“(google)|(http://mail.yahoo.com)”/>-->
      <!--add key=“Apps”
  value=“(IEXPLORE.EXE)|(MOZILLA.EXE)|(ORACLE_APPS)|(NOTEPAD.EXE)|(java.exe
)”/-->
      <add key=“Urls”
          value=“ ”/>
      <add key=“Apps”
          value=“ ”/>
  </whitelist>
  <!-- blacklisted events for exe-->
  <blacklistevents>
      <add key=“iexplore.exe”
  value=“(MSAA_SCREENDATA_ENTRY)|(MSAA_SCREENDATA_EXIT)”/>
      <add key=“outlook.exe”
  value=“(IE_SCREENDATA_ENTRY)|(IE_SCREENDATA_EXIT)|(BHO_SCREENDATA
_ENTRY)|(BHO_SCREENDATA_EXIT)”/>
  </blacklistevents>
  An example of an implementation of black lists and white lists is described in the code
provided below:
  if(Config::IsBlackListedExe( ) == TRUE)
  {
      return CallNextHookExWrapper(g_mouseHook, nCode, wParam, lParam);
  }
BOOL Config::IsBlackListedExe( )
{
  //
  // Find out whether the process in which the current code is running
  // is a black listed executable
  //
  BOOL bRetVal = FALSE;
  WCHAR szExeName[MAX_SIZE];
  GetModuleFileName(NULL, szExeName, MAX_SIZE);
  WCHAR * szExeNameWithoutPath = CFileHandler::GetFileName(szExeName);
  if(szExeNameWithoutPath != NULL)
  {
      WCHAR szPaddedExeName[MAX_SIZE];
      StringCchPrintf(szPaddedExeName, MAX_SIZE, L“,%s,”, szExeNameWithoutPath);
      MSAAUtil::WriteToLog(L“Hooks”, szPaddedExeName, cLOG_INFO);
      MSAAUtil::WriteToLog(L“Hooks”, szExeName, cLOG_INFO);
      MSAAUtil::WriteToLog(L“Hooks”, g_szBlackListExes, cLOG_INFO);
      WCHAR * szUprBlackList = wcsupr(g_szBlackListExes);
      WCHAR * szUprPaddedExe = wcsupr(szPaddedExeName);
      if(wcsstr(szUprBlackList, szUprPaddedExe) != NULL)
      {
          bRetVal = TRUE;
          MSAAUtil::WriteToLog(L“Hooks”, L“Blacklisted”, cLOG_INFO);
      }
      else
      {
          MSAAUtil::WriteToLog(L“Hooks”, L“Not Blacklisted”, cLOG_INFO);
      }
  }
  return bRetVal;
}
```

Business Process Catalog Usage Examples

Use of a business process catalog may involve: adding new entries to the catalog, using the catalog for process discovery and inspection, and composing new end-to-end processes from the elements in the catalog.

a. As a customer, in a single-tenant (private) usage scenario.

b. In a multi- tenant (shared) usage scenario.

i. Public use in an “open source” metaphor.

ii. Rental use of an instance operated and owned by a third party.

iii. Community use of an instance operated and owned by the community

iv. Master/slave use where one entity can apportion processes to other performing entities and can observe end-to-end performance.

In all cases, there is a consistent mechanism to define and characterize processes as tasks and threads at the leaf level. Therefore nodes can be compared and contrasted on a consistent and objective basis.

Studio Module

The studio desktop component 376 shown in FIG. 1 may include a user interface component that resides on end-user desktops 622 and provides expert user functionality through various subcomponents such as a Process Workbench, Modeler Workbench, Alerts Workbench, Content Workbench, Integrator Workbench, and Reporter Workbench.

The Process Workbench enables an expert user to design (edit, modify, delete), deploy and activate process identification rules, and to manually assign observations to processes. It may also be used to replay selected observations. The Modeler Workbench describes a reference model of relationships among users, applications, processes, business entities, organization hierarchies, contracts and locations.

The Alerts Workbench defines rules for events that trigger alerts requiring action. The Alerts Workbench follows actions through to resolution.

The Content Workbench creates, modifies, and deploys documentation and guidance content based on standardized best practices. The Content Workbench also manages context and content for providing task-specific just-in-time content to users.

The Integrator Workbench defines and manages relationships with other systems by providing XML-based import and export of observations, processes, reference model elements, and reports. The Reporter Workbench defines and executes standard, extensible, and custom multi-dimensional tabular and graphical reporting of observations and processes in the context of the reference model.

Communication between the server 375 and the studio 376 may be implemented using web services as shown in FIG. 5.

Console

The console 373 is a browser based user interface component 373 that resides on one or more end-user desktops 623 and includes two subcomponents. An administration console subcomponent provides configuration and administration of both system services and business entities in the application. The administration console subcomponent provides alerting and notifications of critical events and actions through desktop metaphors such as icon trays. A business console subcomponent provides the presentation of information obtained within the application in both localized and personalized format. The business console subcomponent provides a presentation of reports for analysis and enactment, and allows a manager or user to drill down by various dimensions.

Screen Identification

A screen is defined as an application window on a Windows® or graphical user interface workstation, for example a PC running a Microsoft Windows® operating system such as Windows® 2000 or Windows® XP. A screen has various attributes such as caption or title, input controls (text boxes, combo boxes, and buttons), and other visual controls such as labels. During end user interactions with screens, various elements might be set to different values. For instance, someone adding a contact through a web form might fill in different first and last names in contact fields provided on a screen as compared to someone else.

Screens are of particular interest in all human interactions with Windows® desktops as screens constitute the primary means of delivering application functionality to end users. Most applications consist of a set of core screens strung together in various ways (menus and button clicks) to enable the underlying capability being delivered by the application.

Most screens are characterized by a structure that inherently distinguishes one screen from another. For instance, the set of controls (control names and types, not their values) that comprise a screen is usually unique between one screen and the other. In accordance with the present invention, screen identification is accomplished by iterating through the controls on a particular screen, and applying a hash function to generate a unique identifier for each screen.

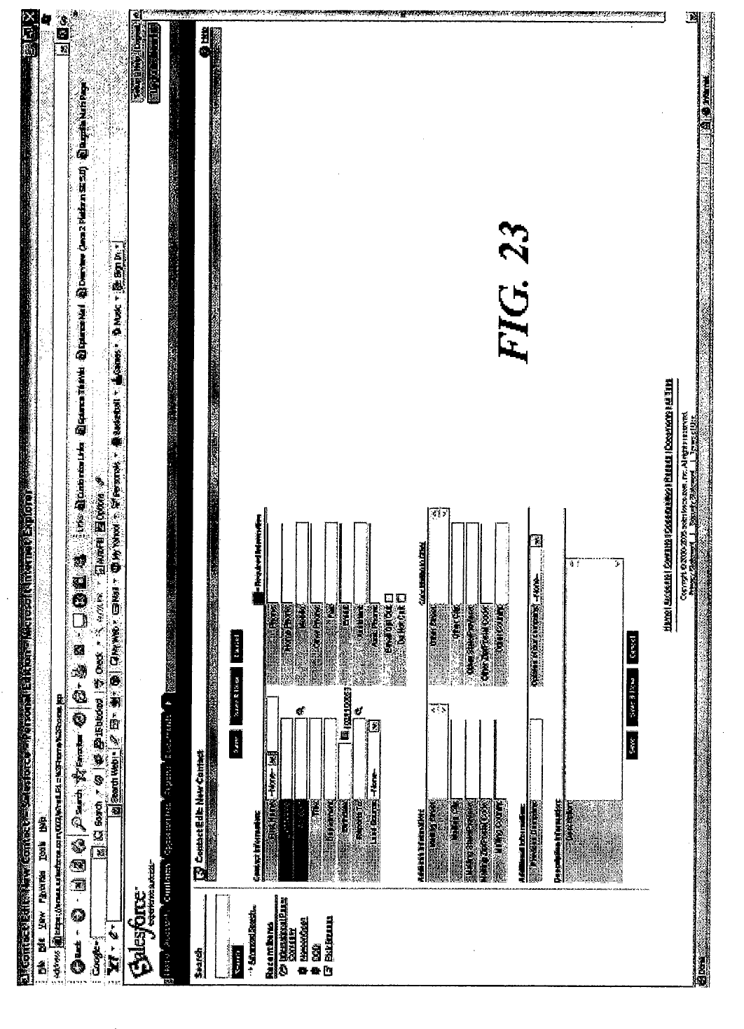

For example, a web application such as Salesforce®, which is available on the salesforce.com web site, may be used to illustrate how a screen signature or unique identification is determined in accordance with the present invention. A contact add screen from the Salesforce® web application is shown in FIG. 23. The control array and associated values for this screen example are as follows:

<EventData><Event><Name>IE_SCREENDATA_EXIT</Name<URL>https://
emea.salesforce.com/home/home.jsp</URL><Controls><Control><Name>whats
new</Name><Val>TrytheAppExchange</Val><Type>button</Type><State>0</State>
</Control><Control><Name>sbstr</Name><Val></Val><Type>text</Type>
<State>0</State></Control><Control><Name>search</Name><Val>Search</Val>
<Type>submit</Type><State>0</State></Control><Control><Name>newEvent</Name>
<Val>NewEvent</Val><Type>button</Type><State>0</State></Control><Control>
<Name>newTask</Name><Val>New</Val><Type>button</Type><State>0</State>
</Control><Control><Name>tasklist_mode</Name><Val>7</Val><Type>select-one
</Type><State>0</State></Control></Controls><UserLatency>0</UserLatency>
<SystemLatency>0</SystemLatency></Event></EventData>

All control values that may change between different instances of the same screen should be removed or stripped out from the control array. It is desirable to be able to uniquely identify a particular screen, and different instances of the same screen (which may have different control values) should be considered to be the same screen. Therefore, the variable information relating to control values should be removed from consideration in the determination of a screen signature. For similar reasons, URLs are also removed from the control array. With all variables (control values and URL) stripped out of the example control array through a simple XML stylesheet transform (“XSLT”) in a manner known to those skilled in the art, the array for the screen shown in FIG. 23 looks like the following:

<EventData><Event><Name>IE_SCREENDATA_EXIT</Name><Controls><Control>
<Name>whatsnew</Name><Type>button</Type><State>0</State></Control>
<Control><Name>sbstr</Name><Type>text</Type><State>0</State></Control>
<Control><Name>search</Name><Type>submit</Type><State>0</State>
</Control><Control><Name>newEvent</Name><Type>button</Type><State>0
</State></Control><Control><Name>newTask</Name><Type>button</Type>
<State>0</State></Control><Control><Name>tasklist_mode</Name><Type>select
-one</Type><State>0</State></Control></Controls><UserLatency>0
</UserLatency><SystemLatency>0</SystemLatency></Event></EventData>

For all future occurrences of this same screen, the control array (with all variable control values and URLs stripped out) will remain the same. This permits the identification of this screen each time it occurs, even though the actual values entered by the user might be different for different occurrences of the same screen. For purposes of this invention, a control array for a screen that has the control values and URL information removed is referred to as a “stripped control array.” From this point on in a process in accordance with the present invention, screen identification is accomplished by hashing the stripped control array with the Java function of String.hashcode( ). That is, the following stripped control array is hashed with the String.hashcode( ) java function to produce a hash code for this screen:

<Controls><Control><Name>whatsnew</Name><Type>button</Type>
<State>0</State></Control><Control><Name>sbstr</Name>
<Type>text</Type><State>0</State></Control><Control>
<Name>search</Name><Type>submit</Type><State>0</State>
</Control><Control><Name>newEvent</Name><Type>button</Type>
<State>0</State></Control><Control><Name>newTask</Name>
<Type>button</Type><State>0</State></Control><Control>
<Name>tasklist_mode</Name><Type>select-one</Type>
<State>0</State></Control></Controls>

The resulting hash code now becomes a unique screen signature or unique screen code for this screen. This hash code or unique screen code can reliably identify all future occurrences of the same screen across all desktops.

It should be noted that the hash code for a screen may vary between different versions of a software application if changes are made to the screen in a new version of the software. If the screen in a new version of the software application is considered to be essentially the same for purposes of a particular business process as the old version of that screen, a method of screen identification in accordance with the present invention may use a screen equivalence table that is checked for each unique screen hash code. Hash codes for one or more screens that should be considered as equivalent for purposes of a business process are associated with each other in the screen equivalence table. Thus, screens that are associated in the screen equivalence table may be assigned the same screen identification value. All subsequent processing based upon screen identification will equate the various screens that are associated with each other in the screen equivalence table.

Standard Screen

A screen is used in a variety of use cases. For example, a mail composition can be used to write personal communication, an order entry related issue communication, or any similar purpose. Within observation space, all unique screen occurrences are characterized by the notion of a “standard” screen. A standard screen is a canonical representation of various flavors of usage of a screen. In the example above, the standard screen would be a mail composition screen, and it would be identified by a set of unique controls that comprise this screen. The advantage of characterizing screens as such is mainly in the ability to decompose a complex set of collected screen observations into a smaller more manageable set. Once this is accomplished, business processes can be composed of standard screens rather than having to deal with a large number of separate instances of each screen individually.

Activity Identification

The function set forth in Table 1 extracts process instances based on screen IDs. Table 1 is a computer program listing submitted as a separate text file, and is incorporated herein by reference. The process starts with the step of removing all existing process unit instances. The next step is to define the process unit definitions for each screen ID. Process instances are extracted by reading the events in user ID/event ID order. The last step is to break the process unit instance whenever a new screen ID, username, or new recording session starts.

As described in Table 1, an incoming event is processed by a process identification engine. Events are sorted to arrive in the order of user ID/event ID combination. For each event, if it is a SCREENDATA event, a screen ID is computed. SCXML runtime starts iterating through transitions of state charts one by one based upon a predefined defined sequence of screen IDs and the ones that are seen in incoming data. Once an entire sequence of screens defined in the process definition for a given instance occur, the process is declared instantiated.

Table 2 embodies a method for submitting a report request based upon an activity ID. Table 2 is a computer program listing submitted as a separate text file, and is incorporated herein by reference. A process is defined in XML format using SCXML state charts. A state chart consists of states and transitions. For instance, in the example described in Table 2, there are five states (state 99 being the end state that declares the process instance occurrance). For every transition, a collection of event attributes is specified, and whether the attribute values need to be matched against specified values.

Table 3 is the same as Table 2, and is another example of a similar method for use in ajava environment. Table 3 is a computer program listing submitted as a separate text file, and is incorporated herein by reference.

Contextual Intervention

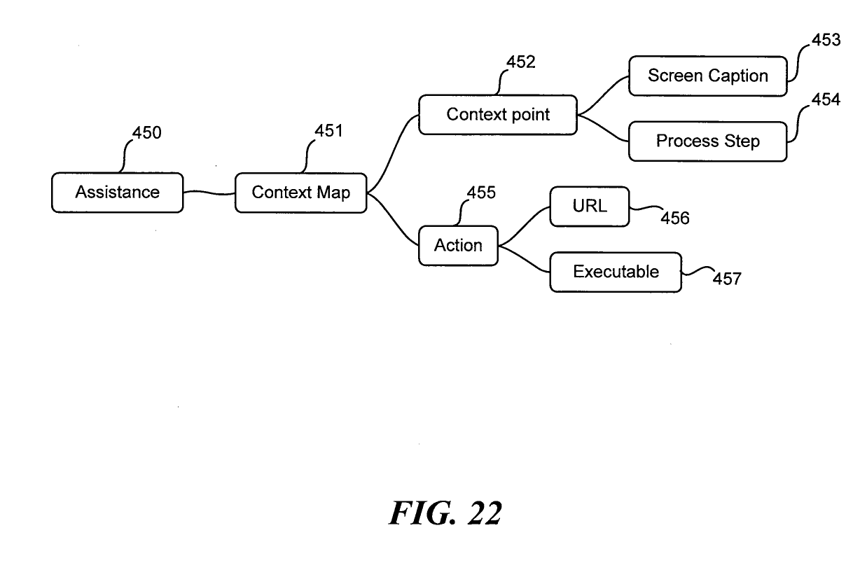

Contextual intervention may be better understood in connection with FIG. 22. Contextual assistance is delivered through the listener fabric provided by the listeners 401. During initialization, an agent running on the user desktop 350 downloads a map 451 of contexts and associated content. During user interactions, whenever a mapped context is triggered, it launches the associated content. For example, a mapped context may be triggered and launch a help screen for the user to assist the user with instructions for performing a particular business process.

A frequently occurring context for a context map is a screen. When a user is on a given screen (identified by the screen identification method described herein), it may be desirable to provide certain assistance of information to a user in the context of particular business processes associated with that screen. For example, consider the following context:

<InterventionContext>
<Trigger><Type>Screen</Type><ID>5</ID></Trigger>
<Action><Type>LaunchURL</Type>
<URL>http://epi.acme.com/help/screen.html?id=5</URI>
</Action>
</InterventionContext>

This context is specified in the server repository 372 through a user interface 376 and saved to a database table. Once specified, this context is automatically downloaded via the content server 374 onto a user desktop 354 upon start-up of the workstation 350. In accordance with the present invention, the module 354 running on the user desktop 350 can compute at any given time the screen code or screen ID of a screen the end user is interacting with. The module 354 on the user desktop 350 can look up the screen ID and see if there is an intervention context specified for that screen ID. If there is, the module 354 running on the user desktop 350 performs the associated action, which for example may be to launch a specified URL linking content available on the content server 374. In a preferred embodiment, this may be accomplished using the ShellExecuteEx Windows function.

Threading

In the system and method according to the present invention, it is desirable to thread together events that refer to common data across multiple users and multiple applications. A common variable value rule is used to perform a threading function in the present invention. The common variable value rule may be expressed as follows: unit process U1 is threaded to unit process U2 in the context of a bigger process P if and only if every instance of unit process U2 has a variable with name V2 that is equal in value to the variable with name V1 in the corresponding instance of unit process U1. This may be expressed as:
U1<<U2 in P iff V1Î U1Ù V2Î U2 Ù value(V1) @value(V2)

A significant specialization of the common variable value rule is that every unit process belonging to the process P contains the same variable name which has the same value in every unit process belonging to P.

A significant generalization of the common variable value rule is the common multiple variable value rule. The common multiple variable value rule deals with more than one variable agreeing in value. The common multiple variable value rule specifies that multiple variables have the same value in the two unit processes belonging to P. This may be expressed as:
U1<<U2 in P iff (V11, V12, V13, . . . V1n) Î U1 Ù (V21, V22, V23, . . . V2n) Î V2 Ù for each i in (1,2,3, . . . ,n) value(V1i) @value(V2i)

Without loss of generality, the value could be the “as is” value or a derived value such as a prefix or suffix or a simple function of the real value.

In the context of a particular embodiment of the invention, it is sufficient to implement the common variable value rule and its variants. This may be better understood with reference to an example use case in the context of SAP. In this example, a sales order entry process in the context of SAP has order number as the common threading variable. In this example, there are four unit processes in sales order entry in SAP. All of the unit processes have order ID as the common threading variable.

Other threading rules that may be advantageously used in alternative embodiments include the variable correspondence rule. The variable correspondence rule is similar to the common variable value rule, except that instead of value equality, there is a lookup of values in a third party application or a third party application table. That is, the pair (value(V1),value(V2)) belongs to a lookup table or a verification API used in connection with the variable correspondence rule for threading. An example of associated values in a lookup table is the purchase order ID from a customer corresponding to the sales order ID in the internal CRM/ERP.

Threading rules that may be advantageously used in alternative embodiments also include the fan-out rule. This rule expresses a common variable between a parent unit process and the several child unit processes it forks out. An example is splitting of a sales order line items into several individual shipments for delivery, potentially from different warehouses or distribution centers.

Threading rules useful in alternative embodiments include the fan-in rule. This rule expresses a common variable between each previous individual unit process and the combined unit process that results from joining the individual unit processes. There may be a different variable for each of the individual unit processes. An example is the combination of several order shipments into a single delivery package. In this example, the line items are collated in the bill of lading.

### Example Operation of the System to Output Information Concerning a Business Process

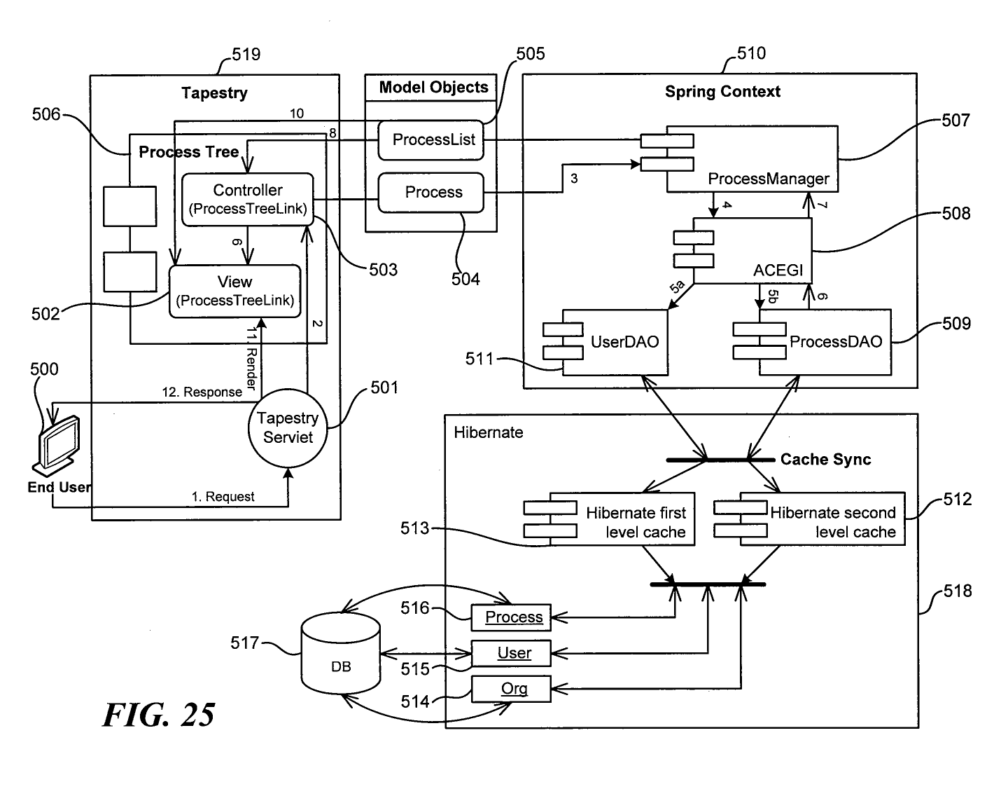

FIG. 25 illustrates an example of a process tree 506 being displayed at the request of an end user 500. In this example, the user 500 clicks on a link, which requests a page to render a process tree 506. In response, a Tapestry servlet 501 maps aJWCID or window identifier data of the process tree 506 to the process tree component and loads or initializes the component specification class.

A controller 503 updates a model object process 504 with the view properties (if applicable). To provide the processList model 505 to a component template, the controller 503 sends a request to the business layer ProcessManager 507 that includes information identifying the ‘process’ object root node corresponding to the relevant process tree. The ProcessManager 507 implements a ‘code to interface’ strategy in the object layer that exists in the Spring object management context 510.

The ProcessManager 507 has methods, which are configured for ACEGI security 508 to provide user role-based access to data using Spring aspect-oriented programming (“AOP”). ACEGI security 508 is an open source project that provides comprehensive authentication and authorization services in a declarative manner for enterprise applications based on the Spring framework 510. ACEGI security 508 protects methods from being invoked and deals with the objects returned from the methods. Included implementations of after invocation security can throw an exception or mutate the returned object based on access control lists.

In this example, the security system is role and privilege based. A user 500 has a predetermined role based upon the user's position in the business enterprise, and privileges are assigned based upon the user's role. To retrieve a list of processes for the relevant process tree from the data store 517, ACEGI 508 subsets the processList 505 based on the user role. ACEGI 508 is configured as a Spring aspect-oriented program so the process manager 507 methods will not be aware of ACEGI security.

ACEGI 508 will command or request a UserDAO 511 to get the user role 515 and a ProcessDAO 509 to get the list of processes 516. DAOs are also implemented with code to interface patterns. All DAOs exist in the context of the Spring object management 510. ACEGI 508 will subset the processes 516 in the process list to which the user 500 does not have access based upon the privileges assigned to the user role. ACEGI 508 then returns the process list information to the ProcessManager 507. To improve performance and minimize database queries, Hibernate 518 has an optimization technique of using a first level cache 513 and second level cache 512 for object caching. First level cache 513 is turned on by default, but only lives in a particular open Hibernate session. Second level cache 512 can be used to cache heavy objects. Second level cache 512 supports clustering and transactions. Second level cache 512 is also used to do result set caching or query caching.

The controller 503 retrieves the processList model 505. The controller 503 then invokes the view component 502 to render or translate the retrieved data into a view suitable for a graphical user interface. The view component 502 pulls the model object processList 505 set by the controller 503. The parent component or Tapestry servlet 501 renders the view. A response is sent to the software client running on the end user desktop 500 by the Tapestry servlet 501. Thus, a report is generated at the request of user 500.

### Example Operation of the System Sychronizing Data Capture with Video or Audio Recroding

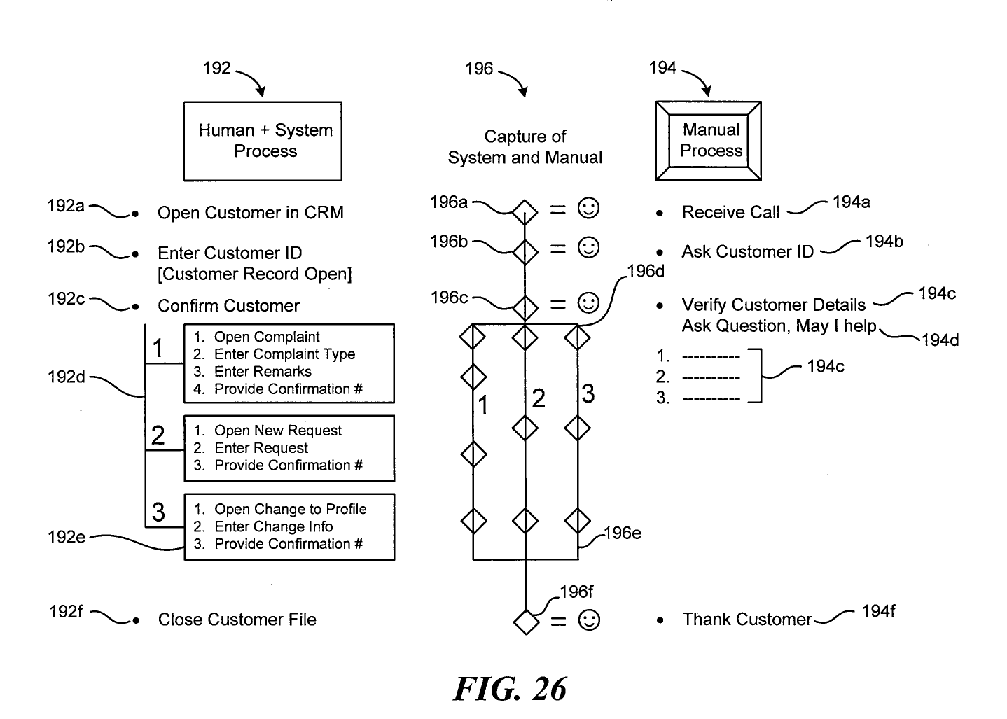

FIG. 26 illustrates the synchronization of the capture of the computer process steps and the manual process steps. In the illustrated example, a human/system interaction aspect is shown in column 192, a manual process is shown in column 194 and a capture of the system and manual process steps is shown in column 196. In the manual process 194a, the user receives a call from a customer, which is recorded via audio, video or both. The user opens a CRM (customer relations management) application on the computer at 192a. These are captured at 196a on the system. At 194b, the user asks the customer for the customer's identification, which is entered into the computer at 192b, causing the customer record to open. These actions are captured at 196b. The identity of the customer is confirmed by verifying customer details at 194c, that is confirmed on the computer at 192c and captured at 196c. The user asks the customer the question, “May I help you?”, at 194d, to which the customer replies in this example by voicing a complaint (1), requesting new a service or product (2), or changing the customer information (3), as shown at 194e. These three categories of responses cause the user to select a corresponding screen or link on the computer at 192d, opening follow-up steps at 192e for each of the categories of response. This is captured as one of three paths 196d with a corresponding number of steps, at 196e. At the completion, the user thanks the customer, at 194f, and closes the customer file, at 192f that is captured at 196f. The computer steps 192 are captured at the same time that the audio and/or video files of the manual process 194 are captured, and the audio and/or video files are tagged with identifications of the corresponding computer steps 192.

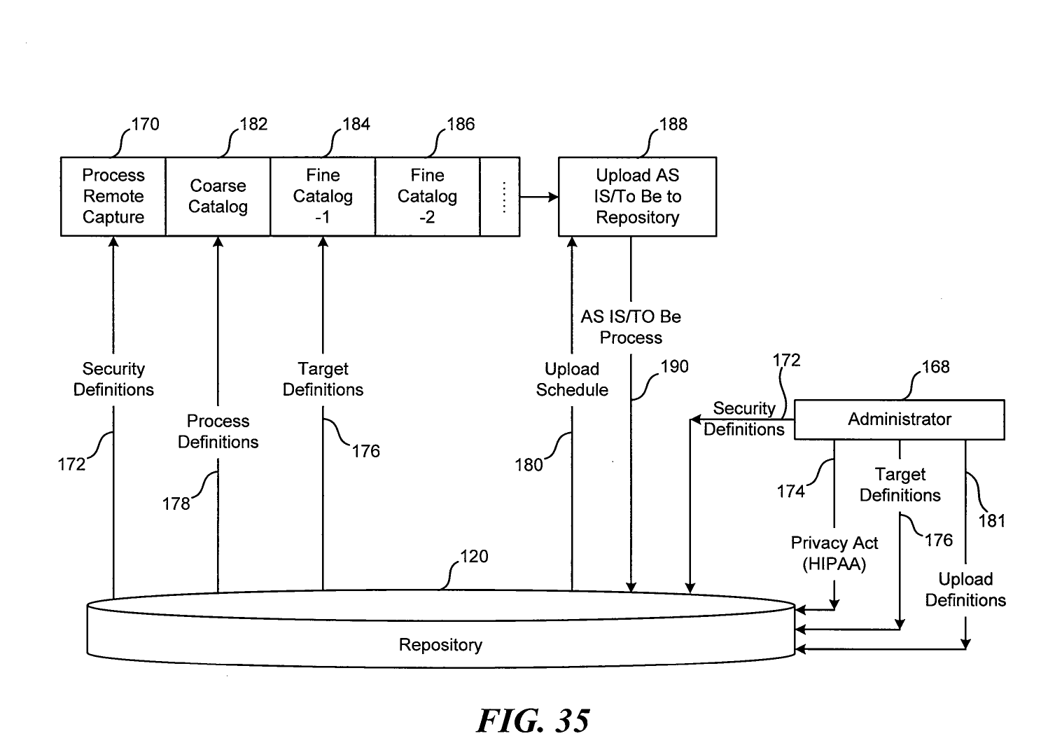

FIG. 35 provides further information on the remote process capture system. User actions are captured, catalogued, and stored in a repository 120. The diagram depicts various definitions that may be set by an administrator 168. Security definitions 172 include parameters that should not be captured by the remote process capture. Information such as passwords or other sensitive information can be removed from the process capture system. Privacy act information 174, for example information covered by the Health Insurance Portability and Accountability Act of 1996 (“HIPAA”), may be designated as sensitive information which should not be made available. Other information that may be excluded from data capture by security definitions 172 include social security numbers and certain specific patient information (for health care applications).

Target definitions 176 are used to define the source and target of the process remote capture. Target definitions 176 specify on which users' desktops capture will be active and when data will be captured. A capture schedule may be defined to automatically activate data capture on predetermined dates and at predetermined times. Target definitions 176 may also be used to identify specific applications to be captured. Data capture can also be enabled for or limited to specific events. Target definitions 176 may be used to configure when capture data will be sent. Typically the destination for captured data is the repository 120.

Process definitions 178 are process strings used to uniquely identify a business process. Process definitions 178 are defined using the process analyzer 56. Business processes are cataloged using the process definitions 178. Process definitions 178 are preferrably defined by example. Alternatively, process definitions 178 may be defined by an analyst's examination of captured files and marking out key steps required for the process definition. Alternatively, an analyst may go directly to an application and mark out predetermined steps that are required for a particular process performed using the application.

The administrator 168 may provide upload definitions 181. Upload schedule definitions 180 specify when process files should be uploaded to the repository 120. Captured data can be uploaded when the system is idle or can be uploaded at specified intervals. Data may be characterized in a coarse catalog 182, or a plurality of fine catalogues 184 or 186. The catalogued data is uploaded to the repository 120.

### Example of Embedded Observer

An observer 354 may be embedded inside other software and its functionality can be accessed, for example, by OEM partners. A detailed description of an embodiment of an embedded observer is provided in the code listed below:

using System.Reflection;
using System.Runtime.CompilerServices;
using System.Runtime.InteropServices;
using System.EnterpriseServices;
// General Information about an assembly is controlled through the
following
// set of attributes. Change these attribute values to modify the information
// associated with an assembly.
[assembly: AssemblyTitle(“DesktopServer”)]
[assembly: AssemblyDescription(“ ”)]
[assembly: AssemblyConfiguration(“ ”)]
[assembly: AssemblyCompany(“Epiance”)]
[assembly: AssemblyProduct(“DesktopServer”)]
[assembly: AssemblyCopyright(“Copyright © Epiance 2005”)]
[assembly: AssemblyTrademark(“ ”)]
[assembly: AssemblyCulture(“ ”)]
// Setting ComVisible to false makes the types in this assembly not visible
// to COM componenets. If you need to access a type in this assembly
from
// COM, set the ComVisible attribute to true on that type.
[assembly: ComVisible(true)]
// The following GUID is for the ID of the typelib if this project is exposed
to COM
[assembly: Guid(“DCCDA464-76BC-4156-BA6B-DD09CB3C5882”)]
// Version information for an assembly consists of the following four
values:
//
// Major Version
// Minor Version
// Build Number
// Revision
//
// You can specify all the values or you can default the Revision and
Build Numbers
// by using the ‘*’ as shown below:
[assembly: AssemblyVersion(“1.0.0.0”)]
[assembly: AssemblyFileVersion(“1.0.0.0”)]
//[assembly: AssemblyKeyFile(“..\\..\\DesktopServer.snk”)]
//[assembly: ApplicationName(“DesktopServer”)]
//[assembly: ApplicationActivation(ActivationOption.Server)]

Graphical Technique for Identifying and Displaying Processes

It is desirable to have a graphical technique for displaying business processes in a manner in which such processes can be easily visualized. Such a graphical technique is also useful in identifying business processes.

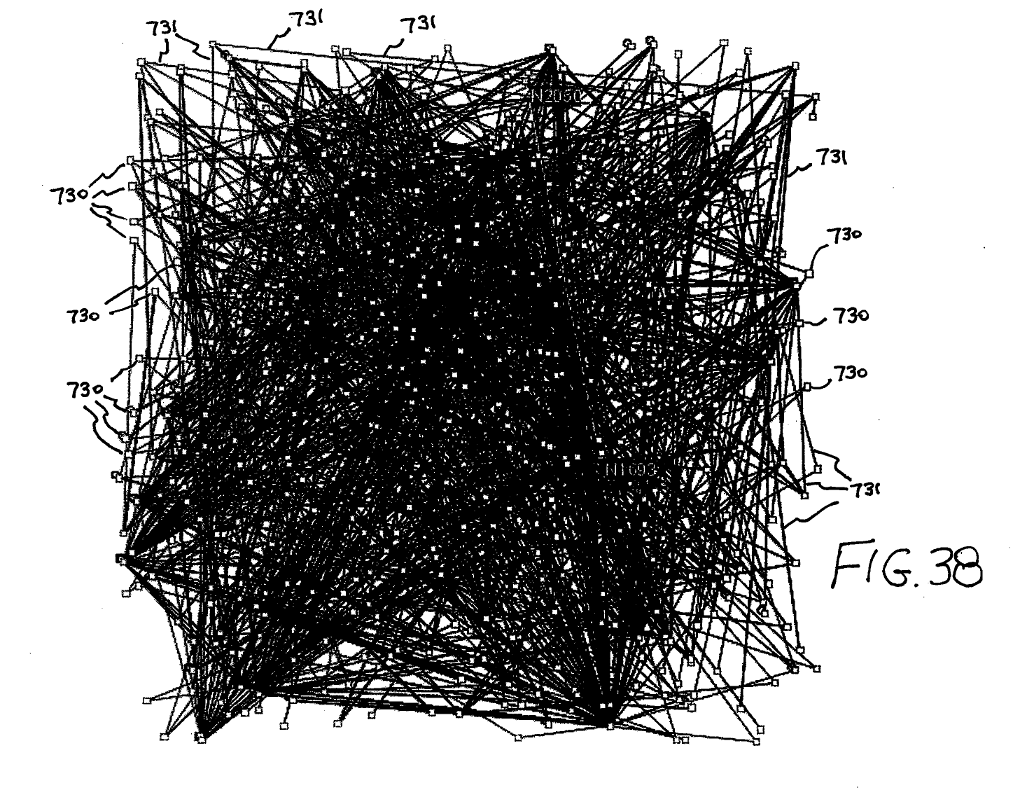

FIG. 38 depicts a graphical representation of data captured in accordance with the present invention. In practice, the graphical representation shown in FIG. 38 may be displayed on a computer screen of an administrator, analyst, or user studying or identifying business processes. This illustration graphically shows all of the screens visited by several users executing business processes using multiple applications over a period of three days. The illustrated example summarizes more than 60,000 events observed by desktop observer agents 557. Each node or square 730 represents an application screen that was visited at least one time by at least one user. Each line 731 connecting nodes 730 represents one time that a user navigated from one screen to another. For the sake of clariety, only some of the nodes are identified by reference numeral 730, and only some of the lines are identified by reference numeral 731, it being understood that this description applies to all such nodes and lines. In the example graph shown in FIG. 38, there are a total of 472 screens and 3122 navigations between screens. Each screen node includes information about the screen that is useful for identifying processes, including the application name, user name and screen caption, and such information may be displayed by a mouse-over information box when the user's mouse is placed over the corresponding node 730. Optional information that may be displayed in an information box includes the name of any files or web pages that were used by the corresponding screen.

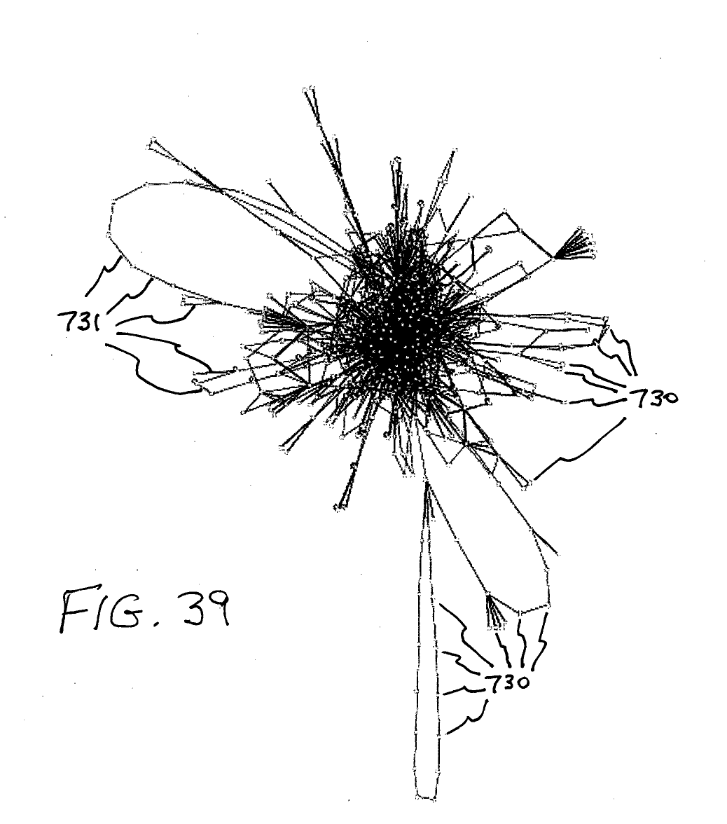

FIG. 39 is a graph showing the same screens and navigations as shown in FIG. 38 after application of a GEM graph layout algorithm to the data. The GEM algorithm is one of a number of approaches to arranging the nodes 730 and edges 731 in a graph to allow visual identification of patterns of interest. Again, only some of the nodes are identified by reference numeral 730, and only some of the lines are identified by reference numeral 731.

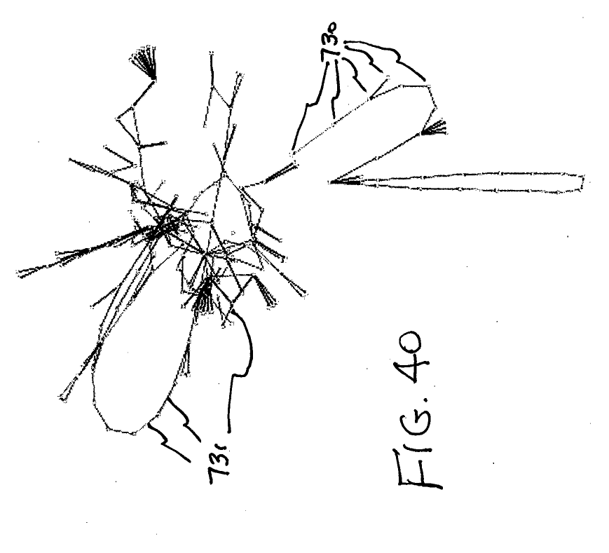

Many business processes are executed primarily within one or a small number of application programs. It is therefore useful to initially analyze how users interact with the screens of heavily used applications. FIG. 40 shows a graphical representation of an example of a query for screens associated with the Oracle application. In this example, 195 of the 472 screens were part of the Oracle application suite, making it the most heavily used application for all of the observed events. In order to more easily visualize the way the users used the Oracle screens, the graph was automatically modified by selecting only screens with application name equal to ORACLE_APPS and not displaying screens from other applications. The application name was originally generated automatically by the desktop observer software 557.

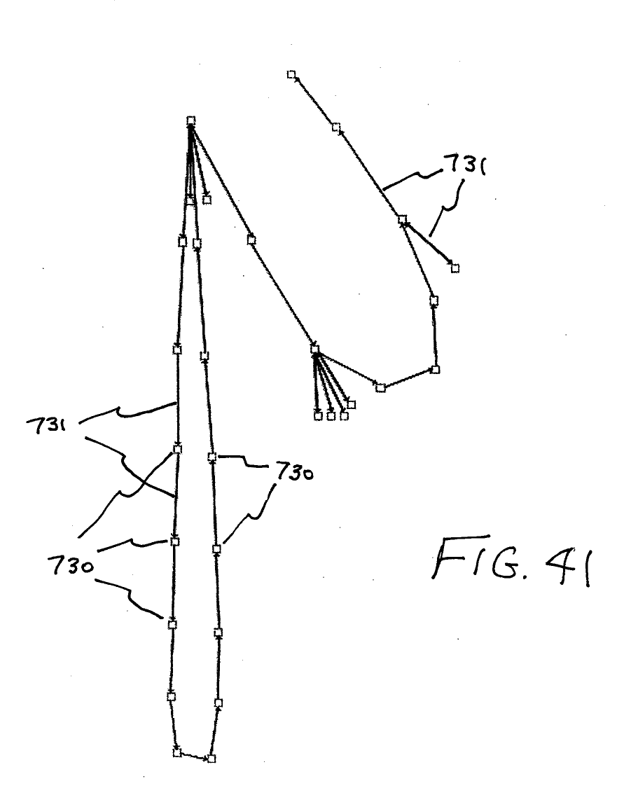

A pattern of interest is identified in the Oracle application screens as shown in FIG. 41. The pattern is isolated by selecting the screen nodes 730 with the computer mouse and zooming in close enough to allow the process analyst to see detail such as the screen names.

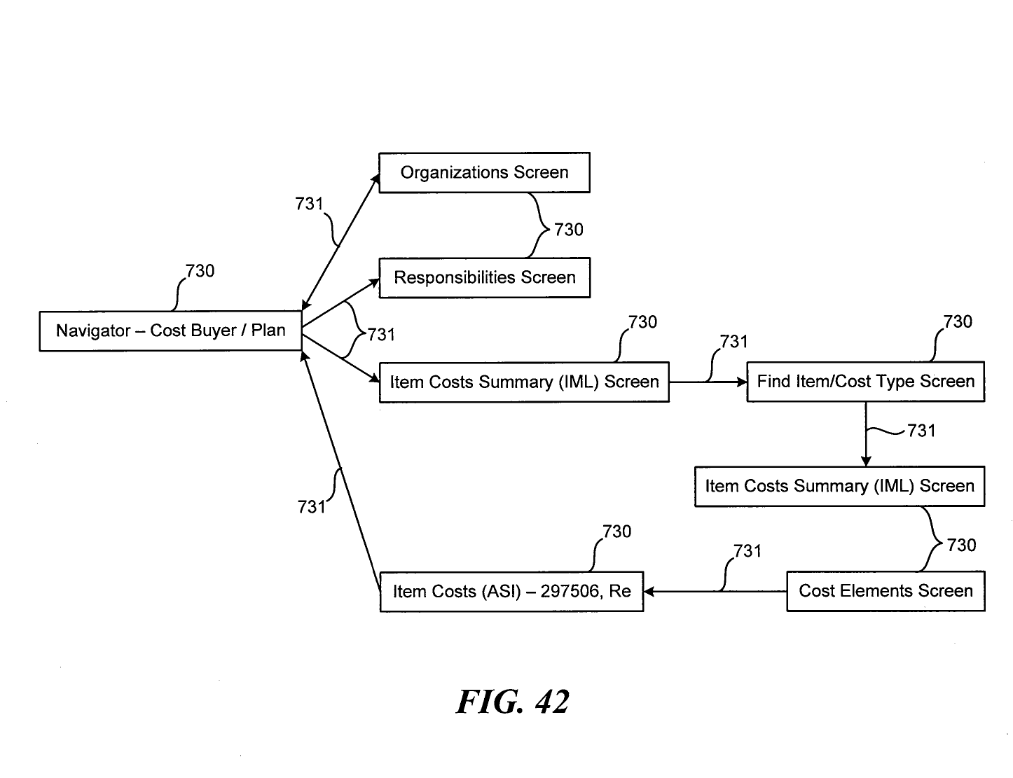

FIG. 42 depicts screen names that have been added to the nodes for the screens in the pattern of interest. The process analyst uses knowledge of the purpose of the screens to simplify the graph by removing redundant screens or those that are not in the main path of the processes represented by the screens.

Sequences of screen navigation are automatically generated by the software, starting by highlighting the screen 730′ that has the navigation edge 731 with the earliest time stamp in the pattern of interest shown in FIG. 42. Successive screens 730′ are highlighted by querying the graph data for the navigation edge 731 with the next greater time stamp, until a navigation edge 731 is encountered that either returns to the first highlighted screen 730′, or goes to a screen 730 in a different application. The highlighted screens 730′ represent a path that was taken by a user in executing a business process using the application. The analyst may then choose to define a process based on the sequence of highlighted screens 730′.

Thus, a technique is provided that presents a readily understood and visualized graphical representation of capture data obtained from desktop observers 557, and which may assist in analyzing the capture data for the identification of business processes.

### Additional Embodiments

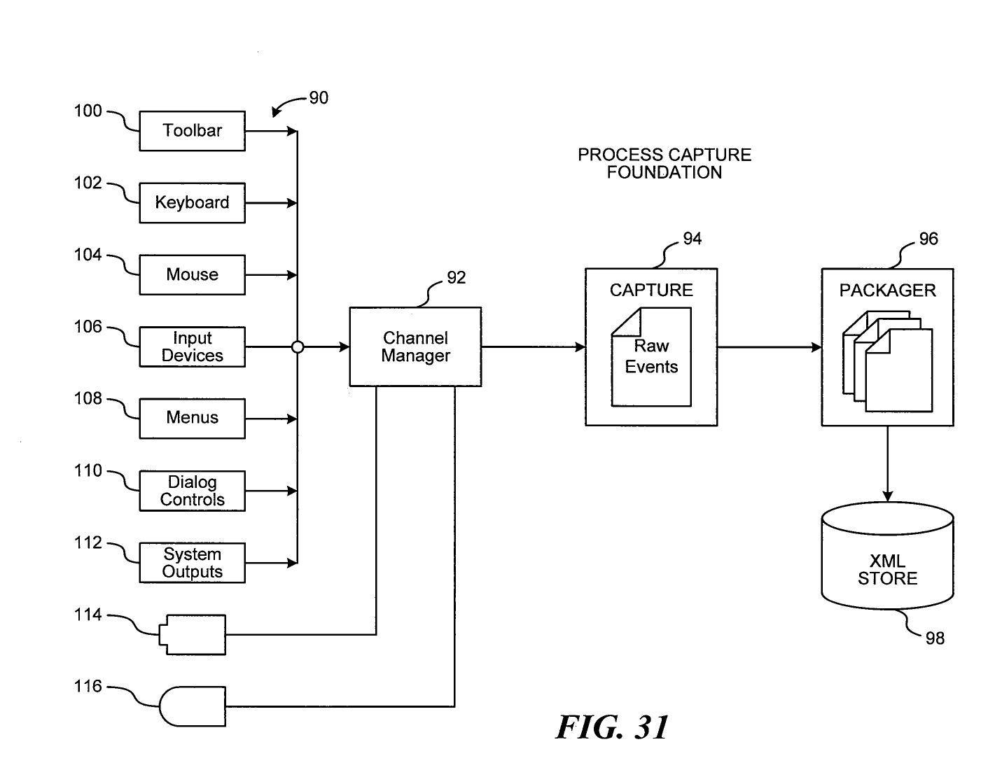

FIG. 31 illustrates an alternative embodiment of a remote process capture system 54 that uses a channel manager 92. User interaction information may be obtained from a number of sources indicated generally by reference numeral 90. For example, data may be captured based upon user interaction with a toolbar 100, a keyboard 102, a mouse or cursor pointing device 104, menus 108, and dialog controls 110. In addition, other input devices 106 may provide data representative of user actions in performing one or more business processes. Data may be obtained from system outputs 112. For example, when a mouse click from a mouse 104 is detected, associated information from system outputs 122 may be captured, such as the active screen, or information from which a value corresponding to a button or control associated with the mouse click may be included.

In the illustrated embodiment, a channel manager or data manager 92 may be provided to selectively couple signals from the various sources of data input, or to multiplex the input sources. Data from the channel manager 92 is transmitted or coupled to a capture unit 94. The capture unit 94 receives raw information representative of mouse clicks, key actuations, and so forth, and provides such raw information to a packager 96. In a preferred embodiment, the raw data is assembled or packaged into an XML format and stored in a memory 98. The menus 108 and dialog controls 110 are elements of the software applications being used by the user during the capture of the business process. In addition, audio may be simultaneously recorded from an audio input 116 while user interactions are occurring and user interaction data is being captured. For example, a user engaged in a business activity involving receiving telephone orders and entering information obtained from a caller into a database on a computer may have audio 116 from the telephone conversation recorded in addition to the user interaction data from the various input devices 100, 102, 104, 106, 108, and 110. Similarly, video depicting the user's activities may also be recorded by a camera 114.

Alternatively, each of the input devices 90 may be monitored by listeners, which forward the data to the channel manager 92. However, the channel manager 92 in this embodiment may be used without listeners. The capture unit 94 receives the output from the channel manager 92 in the form of raw events. The raw events are packaged in the packager unit 96 and forwarded to the storage device 98. The storage device 98 stores data in the form of XML scripts or sentences.

A user working at a task on a workstation will activate one or more of the input devices 90 in the course of performing the task. The input devices capture all control information on the screen, the control data, screen images, and control images. The captured process information is provided through the channel manager 92 for recording (capture) 94, packaging 96, and storage 98. The channel manager 92 decides what channels are used for what events as the message data is streamed through the various channels.

The capture technology uses XML scripts within and across a plurality of business applications to capture the user's interactions. For example, the menus 108 and dialog controls 1 10 and toolbars 100 are common elements across many business software applications. User interaction data may be captured from such common elements provided in a plurality of applications used by the user without requiring a separate capture interface for each application. Standard APIs can be used to capture user interaction data from third party applications without requiring programming access to the source code of the applications. The common elements of the capture interface are shared as between applications. Data capture may be triggered remotely on designated target user's desktop computer, or selectively invoked for certain preselected applications, by an administrator or by the user.

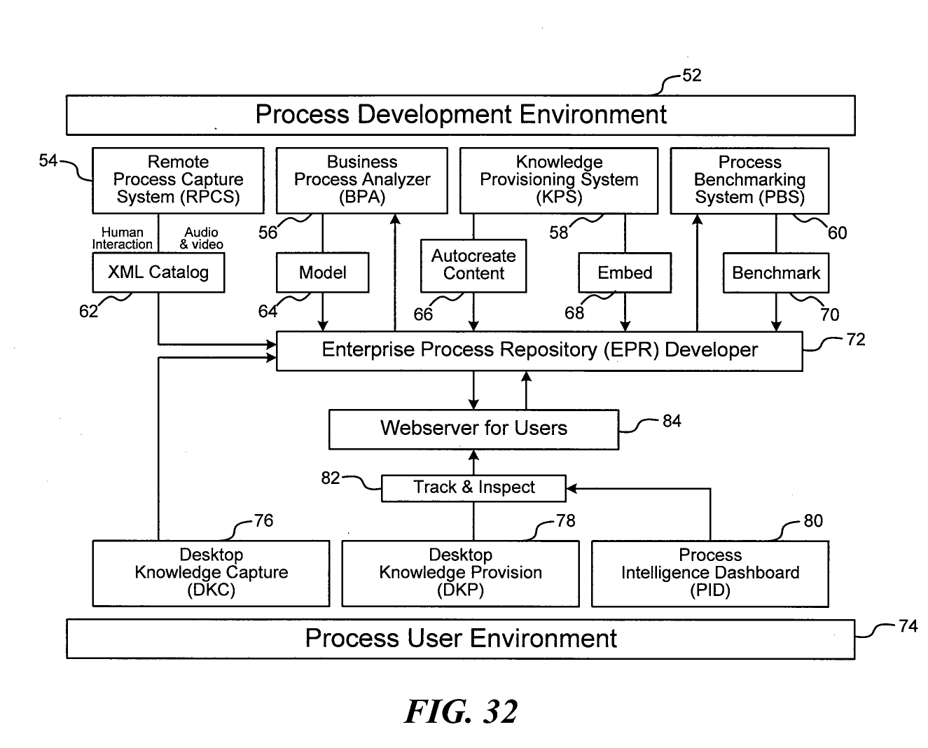

Turning now to FIG. 32, the illustrated alternative embodiment includes a remote process capture system 54, a business process analyzer 56, a knowledge provisioning system 58, and a process benchmarking system 60. These elements of the system operate together to allow a business to accurately measure the efficiency and performance of the company's business methods and procedures, collectively referred to as business processes, and to analyze such measurements in a way that permits the business to identify and implement improvements to those business processes.

The remote process capture system 54 shown in FIG. 32 provides for the automated capture of information relating to user processes by detecting and recording data representative of human interactions with a user's computer workstation, desk top computer, or laptop. Captured user interaction data is preferrably converted to extensible markup language (“XML”) elements that are stored in a XML format in a catalog 62. In addition to capturing information such as mouse clicks and actuations of a user's keyboard, screen shots and active windows on a graphical user interface are also recorded. The remote process capture system 54 is preferrably implemented with a component or agent operative on each user's PC or workstation, and may be used to collect user interaction data from all users in a company, and across all software applications in use at the company. User interaction data from the remote process capture system 54 is stored in an enterprise process repository 72.

The business process analyzer 56 identifies business processes based on the user interaction data captured by the remote process capture system 54. Process identification is facilitated using learn by example techniques described more fully below. The business process analyzer 56 includes the functionality of analyzing business processes for improvement. The analyzer generates models 64 of business processes. The business process analyzer 56 provides process intelligence and business logic rules based upon capture data. The business process analyzer 56 can link subprocesses to high level process definitions and implementation models. Business process model information from the business process analyzer 56 is stored in the enterprise process repository 72.

The knowledge provisioning system 58 automates the generation of content 66 from the analysis performed by the business process analyzer 56 based upon data captured by the remote process capture 54. The knowledge provisioning system 58 may be used to produce business process documentation and e-learning content 66 that is maintained in the enterprise process repository 72. The knowledge provisioning system 58 eliminates a significant portion of the human effort required to create and maintain content. Content may be embedded into an enterprise's applications and systems, as indicated generally by the reference numeral 68.

The process benchmarking system 60 is used to quantify measurements of business processes being performed in a business enterprise, and to provide benchmarks against which the development and implementation of improved business processes can be measured. Benchmark testing may be used to establish process performance requirements. Benchmark data is stored in the enterprise process repository 72.

FIG. 35 provides further information on the remote process capture system. User actions are captured, catalogued, and stored in a repository 120. The diagram depicts various definitions that may be set by an administrator 168. Security definitions 172 include parameters that should not be captured by the remote process capture. Information such as passwords or other sensitive information can be removed from the process capture system. Privacy act information 174, for example information covered by the Health Insurance Portability and Accountability Act of 1996 (“HIPAA”), may be designated as sensitive information which should not be made available. Other information that may be excluded from data capture by security definitions 172 include social security numbers and certain specific patient information (for health care applications).

Target definitions 176 are used to define the source and target of the process remote capture. Target definitions 176 specify on which users' desktops capture will be active and when data will be captured. A capture schedule may be defined to automatically activate data capture on predetermined dates and at predetermined times. Target definitions 176 may also be used to identify specific applications to be captured. Data capture can also be enabled for or limited to specific events. Target definitions 176 may be used to configure when capture data will be sent. Typically the destination for captured data is the repository 120.

Process definitions 178 are process strings used to uniquely identify a business process. Process definitions 178 are defined using the process analyzer 56. Business processes are cataloged using the process definitions 178. Process definitions 178 are preferrably defined by example. Alternatively, process definitions 178 may be defined by an analyst's examination of captured files and marking out key steps required for the process definition. Alternatively, an analyst may go directly to an application and mark out predetermined steps that are required for a particular process performed using the application.

The administrator 168 may provide upload definitions 181. Upload schedule definitions 180 specify when process files should be uploaded to the repository 120. Captured data can be uploaded when the system is idle or can be uploaded at specified intervals. Data may be characterized in a coarse catalog 182, or a plurality of fine catalogues 184 or 186. The catalogued data is uploaded to the repository 120.

Referring to FIG. 32, a process development environment 52 enables a business to improve the business processes for that enterprise. The process development paradigm permits technical users and specialists to use process capabilities and functions to design business process solutions. The process development environment 52 transforms disparate applications into context and process aware applications. The application context awareness is leveraged to establish a business process goal awareness and link to specific context points in the applications.

A process user environment 74 shown in FIG. 32 provides business users and analysts and strategists with a single environment for obtaining real-time business knowledge, best practices, process information, front-end automation and intelligence of real world business processes that are used. The process user environment 74 automatically transforms context aware applications into context interactive applications by tracking user context to assemble just in time and real time information, interfaces and resources as needed.

The elements of the process user environment include the desktop knowledge capture (“DKC”) 76 which enables tracking and inspection of a business user's processes, a desktop knowledge provision (“DKP”) 78 that provides a simplified process based user interface with real time knowledge fused into the process, and a process intelligence dashboard (“PID”) 80 that provides process intelligence for key personnel of the enterprise. The desktop knowledge capture forwards data to the enterprise process repository developer 72, whereas the desktop knowledge provision 78 and process intelligence dashboard 80 forward their data though a track and inspect step 82 and a webserver for users 82 that interfaces with the enterprise process repository developer 72.

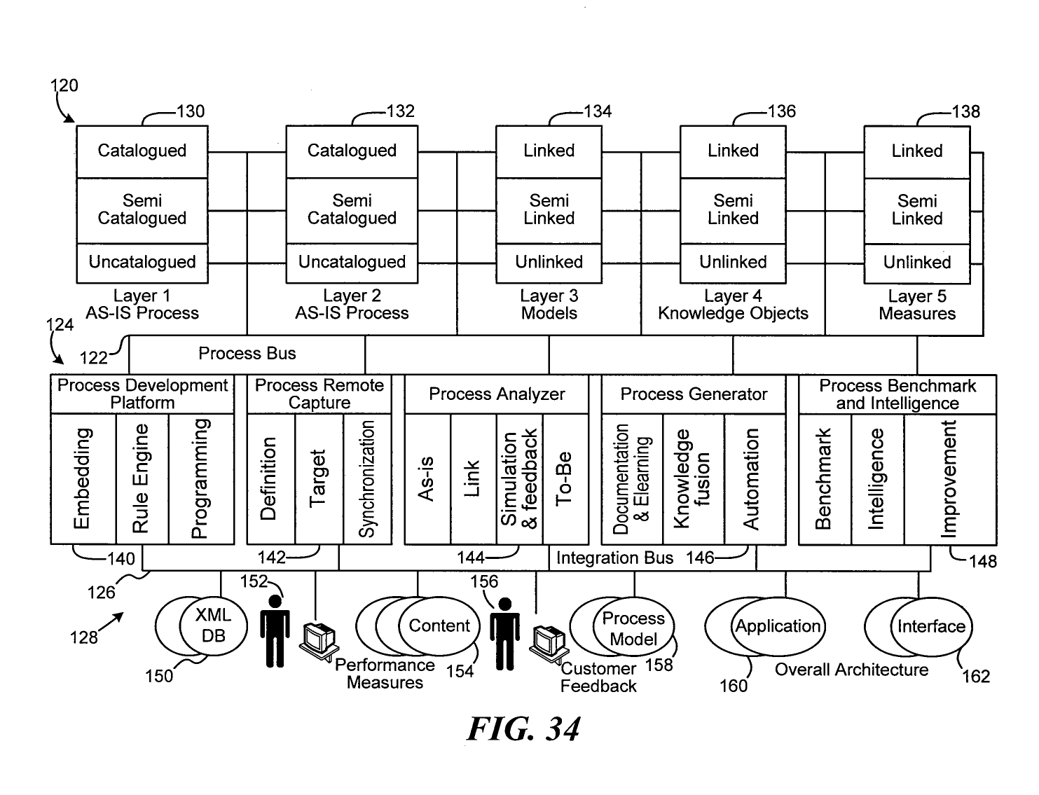

Referring to FIG. 34, the remote process capture technology is used to capture “as is” processes and “to be” processes. So called “as is” processes are those that are in place at the beginning of the analysis, or otherwise at a predefined time or as a redefined standard against which progress is measured. The “to be” process are those which have been modified or improved through the application of the present technology as well as other analysis, adjustments, tweaking and changes. The “to be” processes may be the result of changes outside the present method and system, but which are the result of problems identified using the present technology, such as identification of bottlenecks and duplication. The “to be” processes are useful to measure whether a return on investment may be realized by make the change or whether the goals sought by the organization are realized. The “to be” processes are used in the benchmarking process as will be discussed in greater detail.

The “as is” and “to be” processes are catalogued and stored in a repository 120 in FIG. 34, which may be or may include the storage 98 of FIG. 31 or which can be separate therefrom. Process generators can be used to generate and autolink knowledge objects and content with the “as is” and “to be” processes. Based on the “as is” process, process analyzer technology analyzes the process and gives the necessary information for the analyst to design the “to be” processes. Later, when the actual “to be” processes are implemented, the remote process capture technology can be used to record the complete “to be” processes. Process benchmarking technology can be used to measure and compare the implementation of “to be” processes with the best practices. Process benchmarking technology can also suggest a revised best practice. Gaps in existing processes and broken processes can be identified using the process benchmarking technology. Process intelligence technology is use to notify specific events to users.

As shown in FIG. 34, the main technology components of the system are the repository 120, a process bus 122, a developer and process user layer 124, an integration bus 126 and external interfaces 128. In the repository 120 is stored the process models (both “as is” and “to be” process models), central content derived from the process models, and central definitions necessary to drive other modules. The illustrated repository has five layers corresponding to “as is” process models 130, “as is” process content 132, models 134 (which may be the “to be” process models), knowledge objects 136 and measures 138.

The process models, such as the “as is” process models 130 and the corresponding content 132, themselves can be catalogued, semi-catalogued or un-catalogued, as indicated by the divisions within the repository layers 130 and 132. As users perform various processes, the remote process capture identifies the processes the users are performing and catalogs and stores them accordingly. The known processes are stored as cataloged processes in that part of the repository. In some cases, the processes that users are performing cannot be identified with precision. In some cases, some fuzzy parameters can be identified and weightings may be given (i.e., 50% possibility that process A is being carried out and 50% possibility that process B is being carried out). Of course, other percentages are used when applicable. The fuzzy parameters are applied based upon the likelihood that a process definition can be applied. If the process matches more than one process definition, the fuzzy parameters (fuzzy logic) are applied, with the values reflecting the likelihood of a match to the corresponding process. In such cases, the processes are stored along with these weightings in the semi-cataloged portion of the repository. The conflicts or questions over what process is being performed are resolved at a later stage. These processes are called as semi-catalogued processes. Finally, some processes cannot be categorized at all, such processes are dumped as a blob in the un-cataloged portion for further analysis.

In some cases, the intention may be to capture but without categorization. In such cases, the captured information may be stored without any kind of cataloguing and so the storage would take place in the un-catalogued portion of the repository 120.

While cataloguing business processes, pieta data and information about the processes may be stored along with the captured processes. These are used for discovery and search purposes. The repository also contains definitions (including process definitions and target definitions) and other information common to the enterprise. The remote process capture and other modules use this information. The repository 120 in the models 134, knowledge objects 136 and measures 138 has linked, semi-linked and unlinked portions. Each of the repository 120 portions is connected to the process bus 122.

The developer modules 124 are also connected to the process bus 122. The developer modules 124 automatically generates content and knowledge objects based on the processes that are catalogued and captured and then stores them in the repository portions 132 and 136. The knowledge objects 136 and content 132 are auto linked with the processes. These are also maintained in the enterprise repository 120.

The process bus 122 is a set of APIs (Application Program Interface) and an interface to the repository 120 as well as to other systems. Using the process bus 122 and the process development system 122, external modules can search for processes or read process information from the repository 120. They can also access the APIs of the individual systems of the present invention.

The developer and process user tools 124 provides automatic generation of content and knowledge objects using these modules. For example, a process developer platform component 140 has embedding, a rules engine, and programming portions, the remote process capture component 142 has definition, target and synchronization portions, the process analyze component 144 has “as is”, link, simulation and feedback and “to be”components, the process generator 146 has documentation and e-tearing, knowledge fusion and automation portions, and the process benchmarking and intelligence component 148 has benchmarking, intelligence, and improvement portions.

The integration bus 126 provides the communication link between the developer layer 124 and the interface layer 128. The integration bus 128 sets a specific XML protocol which uses the modules to converse with the outside world.

The external interface technology 128 includes external interfaces to configuration management systems, databases and external process modeling systems. The external components shown are XML database 150, performance measures 152, content 154, customer (user) feedback 156, process models 158, applications 160 and interfaces 162.

The process model technology analyzes the process file and deduces decisions points, branches and loops. It does this by comparing all the process variations and uses heuristic rules, to construct the process model. At the end of the analysis, a process model is captured which may be around 80% accurate. The analyst can then change the process model and correct inaccuracies if any at 316.

Without the present system the effort required to construct such process models are time consuming. The analyst would have spent a two-week interviewing various users and the recording manually the steps that the users perform. On the basis of this the analyst would have to create a process model. About 80% efforts are spent on creating a first cut process model. All these tasks are eliminated by the present technology. The present technology automates the automatic capture of processes and the automatic generation of a business process model given a set of process variations.

Once a process model is obtained, the analyst can create business process abstractions and business process hierarchies. Process abstractions are application independent definitions or specifications of a business process. The present technology allows an analyst to create multiple hierarchy of a business process model. For example, at the top most level, a main business processes such as “respond to customer call” can be identified and specified. At a more detailed level this business process can be broken up or subdivided into subprocesses. At the lowest level, a business process may translate into or be specified as specific interactions by a user or employee with a particular RM/SCM application or manual decision points.

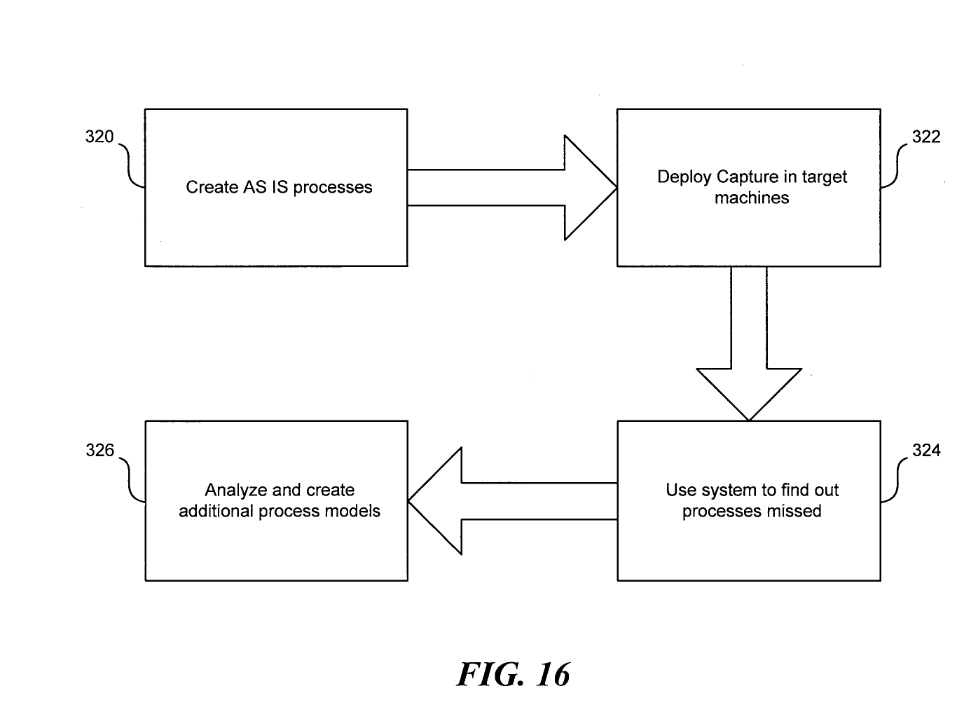

An example is shown in FIG. 16. Typically in an organization it is very difficult to find out all the processes that are being used. Without the present technology, it would be impossible for the analyst to determine all the processes that are used in the organization.

Using the present technology, the analyst first chooses the department or set of users for which the analyst wants to find out the processes at 320. The capture duration is then set and the remote capture is then pushed to the users machines automatically at 322.

Once the capture is completed, the captures files are stored in a central repository. Using the processes already modeled, the analyst uses the present technology to find out the events that are not a part of any process at 324. This is called as un-catalogued process. Sometimes this may be as high as 50% of the total process. The analyst then can go through the uncataloged process file and find out all the processes at 326. This is in part a manual job and the present technology helps in only showing the interactions that users performed with the application.

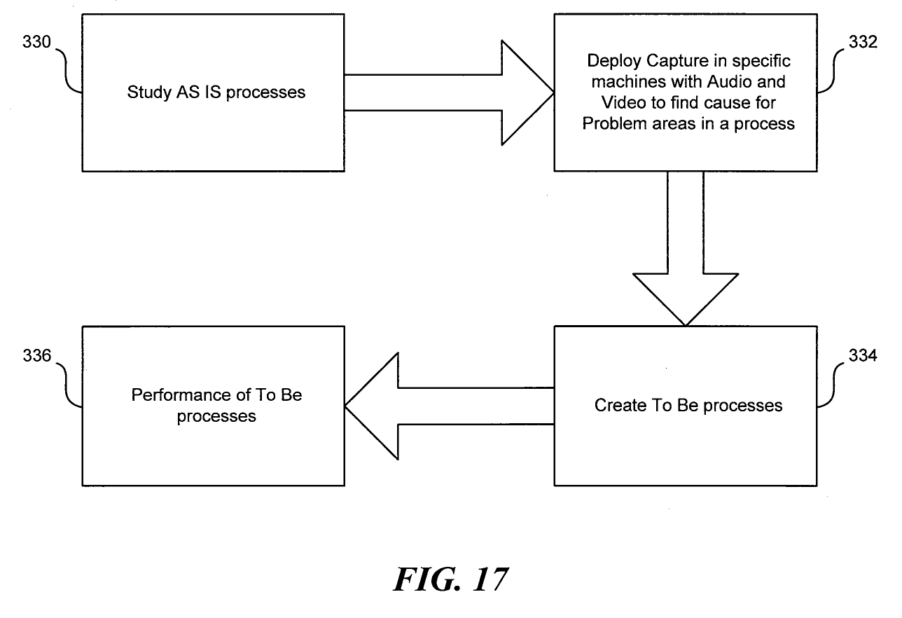

Referring to FIG. 17, once the “as is” process have been identified at 330, the next step is to analyze the existing process and see how they can be improved. So far the analyst had captured only the user interactions. To do a proper study of “as is” process, the analyst may want to study the user actions in more details. The analyst would require not only interactions with the application but also manual tasks. The analyst therefore elects a smaller target group whose process is going to be monitored. Remote capture is then deployed at 332, this time with Audio and Video on. The complete user interactions and the audio and video is shown in an integrated manner by the present system. For example the present technology will show the audio and video between the second and the third step of a process. Using this analyst can find out the exact reasons for process inefficiency. This forms the basis of the “to be” model at 334.

Once the “to be” process is created the business user can benchmark users and compare “as is” and “to be” process performance at 336. To do this, the business manager again deploys remote capture on certain users machines. The processes captured are catalogued automatically by the process modeling technology. Various key parameters such as, time to perform a process, cost of a process, and error rate of a process are compared between the “as is” process and the “to be” process. The business manager can advantageously compare performance of users between any two points in time. Such comparisions may include a comparision of a user's performance between two specific periods. This will establish the efficacy of specific remedial actions. For example the business manager can compare the performance of a user or a set of users before training was given and after training as give. If the performance improves this forms the basis of a ROI of the training program. Such comparisions may include a comparision of performance between “as is” and “to be” processes. A comparision may be made of measured performance between two versions of a process. Such comparisions may include a comparision of performance amongst a group of users. Such comparisions may also include a comparision of performance within a group, and average, mean, and/or median performance measures may be determined.

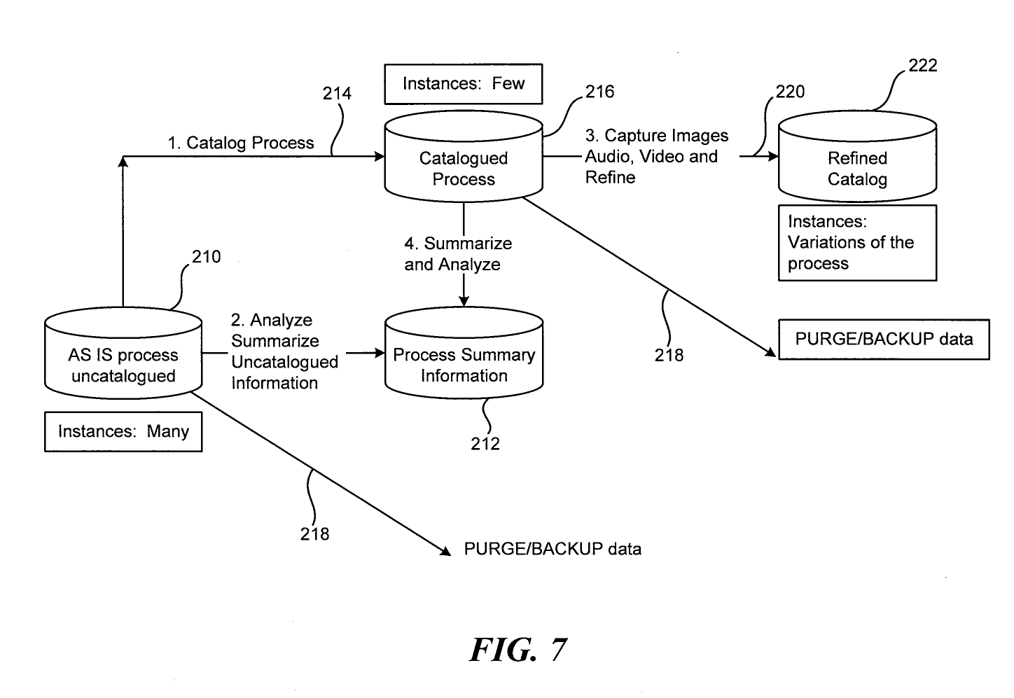

The lifecycle of the captured data is illustrated in FIG. 7. The initial “as is” processes 210 that are captured are condensed into a summary table 212 and exported to any database. The summary information includes the details of processes used along with time taken and other metrics. The processes are also catalogued and refined further as shown at 214. At this stage 216, a few instances of the processes have been captured. The remaining information can be purged or archived for future use as shown at 218.

The captured data analysis determines the context of the captured data on the basis of the current dialog or control that the user is interacting with and by the history of the dialog or controls that the user has interacted with. The captured data can be considered as virtual footprints of a business process. A “virtual footprint” may be defined as captured data representative of data in data fields on a screen that was used by a user in the performance of a business process, a screen identification value determined based upon control array information corresponding to such screen, and optionally data representative of key actuation events and mouse click events that took place while the user was using such screen. Application virtual footprints are virtual footprints associated with a user's use of a particular software application. Interapplicational virtual footprints are virtual footprints associated with a one or more users' use of a plurality of software applications in connection with a single business process.

Once a list of cataloged processes 216 has been obtained, it may be necessary to study manual or other aspects of the process. Images, sound and video are captured at 220 from a select few users according to some embodiments of the invention and the captured process are further condensed into a set of existing practices for the process, as shown at the refined catalog 222. Other information may be purged or archived at 218.

Manual processes can be captured as well. These manual processes surround the machine-related human interaction processes and are mainly unstructured content such as telephone discussions and physical activity. The activity is captured using audio recording, video recording and text capture. In one example, a video recorder 114 is provided for recording the video component of the capture and a microphone 116 or other audio pick up is provided for the recording of the audio data, as shown in FIG. 31. Although a standard video camera using magnetic tape or other magnetic media or solid state media maybe used, the present invention utilizes in a preferred embodiment a digital video camera connected to a computer for recording onto the computer hard drive. Suitable video recording devices include web cams, although other varieties of video recording cameras and detectors are readily useable in this application, including stand alone and built in cameras. Still cameras may also be used in the capture of the visual data, primarily for reasons of increased clarity and image integrity, although the timing of the still images must correspond to the actions of the user to be captured. Several video recording devices may be provided as needed. For purposes of the present invention, video data includes both still images and moving images.

The audio portion of the capture may be by a standard microphone 116 located wherever convenient to the user's activity. A built in microphone on the computer may be used, or a separate one can be provided. Due to the limited range and distance of detection for microphones, several microphones may be included. Since important information regarding the process to be captured may be discussed by the user via telephone, the audio detector 116 may be implemented as a telephone pickup transducer coupled to the user's telephone, which preferably records both sides of the user's conversation.

The stored audio and video data from the video recorder 114 and audio detector 116 in one embodiment are stored as compressed files, such as MP3 files, WAV files or other Windows Media Player compatible file formats. In a preferred embodiment, the Windows Media Player is used to record and store the video and audio files. Of course, a user may define his or her own format for recording the media data.

The audio and video files are played back in segments that are tagged for identification with the corresponding steps recorded as input to the computer work station. The segments show the analysts exactly what has happened between each step.

The study of the manual aspects of the process involves human review of the video and audio and are used to generate the refined processes. While capturing processes, the following may be captured: human interactions on the software application, audio around the user workstation, and video around the user workstations. All these can be richly integrated and provided to the analysts. In particular, the audio and video files are marked with tags corresponding to tasks and or steps in the process. Using the present technology, all of these are presented in an integrated fashion. For example, the analyst can find out what the user was doing after executing second step in an application but before executing the third step. In this way, specific bottlenecks in a process can be identified and removed.

The present processes and their analysis and definition can include: linear or non-linear steps to be performed in an application; workflow elements involving branching and looping; manual tasks or legacy content; and hierarchy of steps.

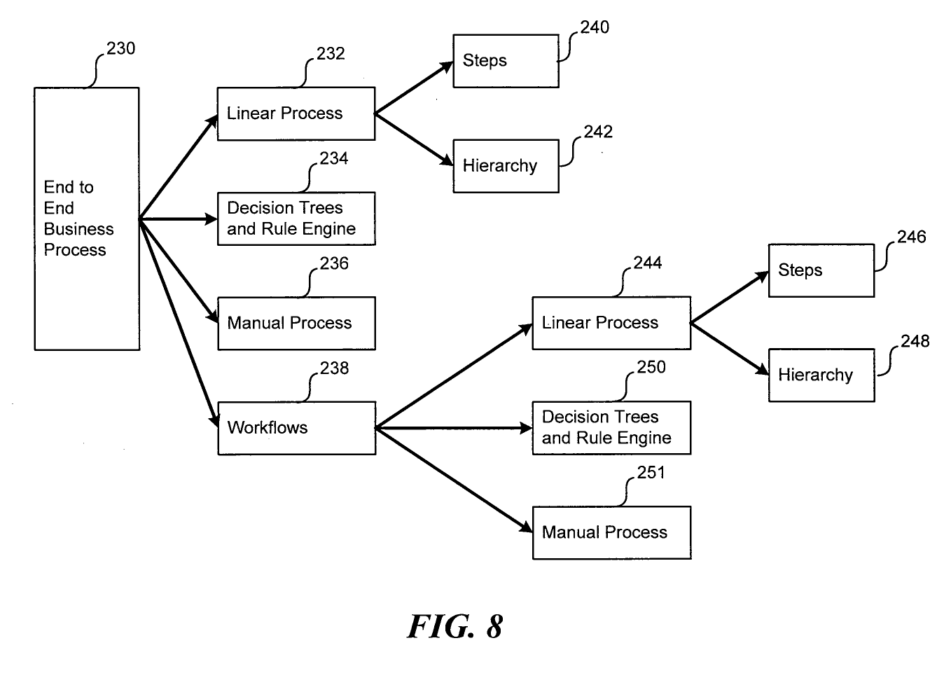

For example, the present method and system may combine the first ten steps of a process and group it under a sub-process, for example the sub-process “enter order information”. Tracking and content automatically inherits the hierarchy definition of the process. FIG. 8 shows the elements that can be used in a process definition.

The diagram of FIG. 8 illustrates that a process can also include branching elements. For example a recruitment process may have one path for temporary workers and one for permanent employees. An entire process can thus be modeled using the elements of branching/looping. These decision points are made even more powerful with the ability to invoke rules engines. These processes may be performed at one or more employee or customer nodes. For example, workflows can string processes across multiple nodes with simple linear processes, decision trees, and manual flows.

In FIG. 8, an end to end business process 230 may be broken into a linear process 232, decision trees and a rules engine 234, manual processes 236 and workflows 238, The linear process may include steps 240 and a hierarchy 242. The workflows 238 may also include linear processes 244 that are made up of steps 246 and a hierarchy 248, decision trees and a rules engine 250 and manual flows 252.

The process analysis performs a analysis of uncataloged information and performs and analysis of cataloged information. In both cases, the process analyzer gives information on what processes are being used by whom, how much time does it take to perform a process, what are the errors, performs a comparison against the best practice, determines the efficiency of performance etc. Process modeling is however used to model a “to be” or an “as is” process. The analyst may use the process analyzer report to fine tune or improve a process. Thus, process modeling and process analysis go together.

The process modeler is a set of tools are provided to model various components of a process. Modeling can be done at a very high level such as supply chain management processes or at lower level where an exact process can be described at the operation level. Process definitions are defined only for processes that use software applications. A process model is a combination of processes that use software applications and manual tasks. Any process, which uses at least one application process, can have a process definition.

The process modeler provides various elements for modeling branching and looping elements. As a result, any of the process elements can be modeled and create a WYSIWIG (What You See Is What You Get) flow using decision points and looping constructs.

Legacy content is used in the modeling process in two ways. Legacy content can be linked to a process context. This way whenever the user wants assistance, the legacy content can be shown along with the generated content of the present method. In the modeling process, legacy content can be attached to a particular process. If a particular process is a manual task and needs reference to a manual which is a legacy content, this can be done. Using the process modeler, linkages can be provided to any IITML or pdf legacy content.

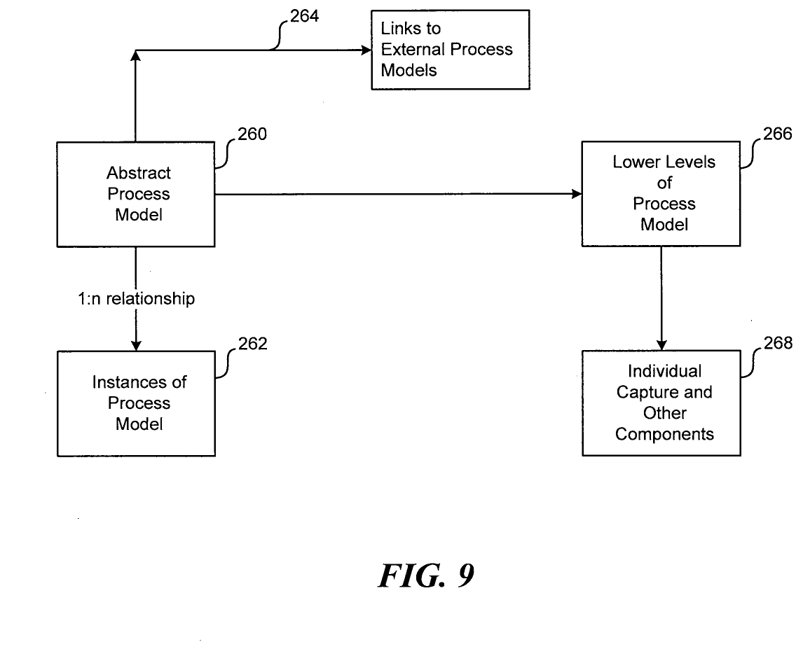

FIG. 9 illustrates an abstract process model 260 that defines variations of all processes. There may be multiple instances 262 of an abstract process model. An abstract process model may have linkages 264 to external process models or may drill down into lower level processes 266. At the lowest level is the capture file 268.

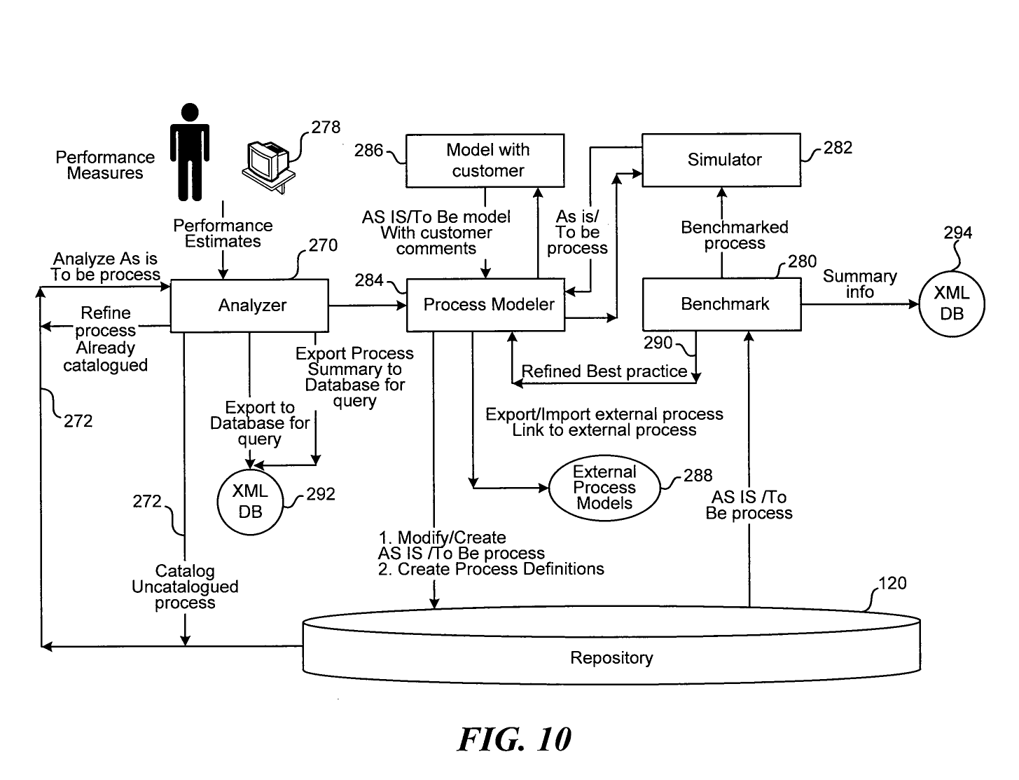

In FIG. 10 is shown the main components of the process analyzer. The main functions of the process analyzer 270 are to: analyze “as is” and “to be” processes 272 and generate reports on process usage (duration, errors etc.); help analysts to refine the “as is” processes and catalog the processes or the variations of the processes used; and catalog process capture files that have not been catalogued at 276.

As noted above, once a process definitions are defined the process analyzer can run through the entire captured process in one pass. The process analyzer is involved in cataloging of un-cataloged capture files and cataloged capture files. The semi-cataloged files generally must be manually refined before they can be analyzed.

The analyzer 270 can also accept as input information about performance measures 278 of the process. This can be used both by the analyzer 270 and the benchmarking part 280 of the present system, which may use a simulator 282.

The process modeler 284 is used to model the “as is” process and based on the user profile or usage of current processes; design the “to be” model of the process. The process modeler 284 can also be used to model the process and send it to end users and customers 286 and obtain their feedback regarding the process. This can be used to revise the process model.

The process modeler 284 can also export the process models to external models 288. A process model can also have linkages to external process models 288. The process can be simulated using the present simulator 282 and the statistics gathered can be fed back into the existing “as is” /“to be” process models.

The benchmark system 280 benchmarks: actual usage against the “as is” process model; benchmarks actual usage against the “to be” process model; performs a comparison of the “to be” process model and the “as is” process model; and benchmarks actual usage against the best practice. As a result of the comparisons, the best practice itself may have to be revised at 290.

The analyzer 270 and benchmark component forward data to XML database(s) 292 and 294. Of course, the present system interacts with the repository 120. A part of the process analysis includes the generation of reports of the findings by the process analyzer.

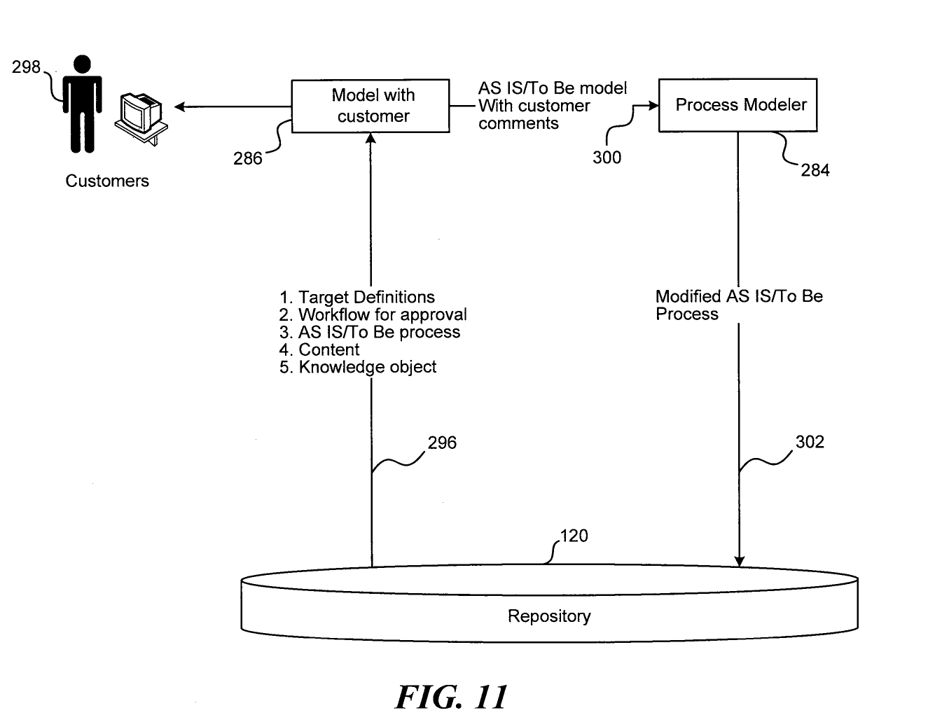

The process analyzer 270 interacts with the modeler 284 to deploy the “as is/to be” processes content to the customers for feedback. This is shown in greater detail in FIG. 11. In particular, the repository 120 provides the target definitions, workflow for approval, “as is” and “to be” processes, content and knowledge objects 296 to model the process 286 with the user or customer 298. Feedback 300 is received with user/customer comments and forwarded to the process modeler 284, which then modifies the processes and forwards the modified process 302 to the repository 120 for storage.

A workflow mechanism can also be set such that the comments, corrections and reviews can be tracked to closure. The process XML flies will contain the track of all comments made.

The simulation technology using process models helps analysts in performing various if-then-else condition analysis. For example, the analyst can change a small part of the “as is” process and find out the implications of this in the overall performance of the “to be” process.

The present method and system provides an automated process for generating an XML database representative of business processes, optionally including audio and video data. This eliminates the time, expense and effort of data gathering. This further ensures complete reliability since the entire population of users may be covered and all biases of the data gathering personnel are eliminated. Data may be captured by listeners, which may be optionally implemented as plug-ins. In addition to utilizing standard listeners for most 32-bit Windows® applications, the present invention also encompasses having separate specific listeners for particular software applications. The method of capturing information may vary from one application to another, and the format of information provided may be different in different applications. In one implementation of the invention, the listeners may include plug-ins for server application programming (“SAP”), browser based applications, Java based applications, and Windows® based applications.

Listeners may have a notification mechanism. Various external clients can register themselves with the listeners and can request to be notified. Notification can be requested for specific user actions, specific user actions on a UI control, or all user actions.

The process information, time stamp, audio data, and video data across multiple users may be automatically extracted in XML and cataloged for easy grouping and analysis. The XML information can be analyzed with any conventional data base for patterns, and to identify inefficiencies and broken processes.

The core technology provides capture functionality, inspection functionality, notification functionality, and playback functionality. A system processor product may use these functions to capture events and images. Third party programs can also request the services of these components. Programming interfaces to the system provide external access permitting use of the capabilities of the system components by third party applications. For example, programming developers can use the system processor, documentor, animator, or analyzer functionality within their own third party programming environment.

The interface to the system XML files includes APIs providing access to the system XML files. The XML files include a capture XML file and a Knowledge Object XML file, resulting in an objective and comprehensive view of the processes in use. The present method provides an objective and a rapid method to exhaustively list and identify precise interactions between applications in processes in use. The illustration also shows a mostly automatic “as is” model development 348, providing an efficient and accurate model development cycle. A highly efficient system and method (with an audit nail) provides a means of securing user feedback and acting on them. The “to be” model development includes simulation of performance improvement potential for different scenarios, helps to objectively decide the best projects (what program to use, for what processes, to give what process improvement), and develops a business case for justifying choices that tend to reduce project costs and maximize the achievement of intended benefits.

A computer product is provided for performing the method described herein. The computer product may be supplied as software on computer readable media or via a computer communication such as a network or the Internet.

The process analyzer catalogs the un-cataloged processes based on the process definitions. Summary statistics are created for the cataloged and un-cataloged process information. The summary information and process information may be exported to external databases for query and viewing. For processes that have been auto-cataloged, a refining process may be performed. For processes that have been automatically cataloged, further refining can be carried out. A summary of statistics may be created for automatically cataloged processes. The analyzer may also import performance statistics from expert users and from external databases.

The analysis of the “as is” processes, even those that are complex, is facilitated, to permit identification of areas of weakness. A model of the current system is developed using extensive and objective data analysis. Data reusability is provided, as is monitoring of the continuous process improvement. New processes are developed as “to be” processes, mid decisions on the purchase or manufacture of software programs is made to deliver the functionality of the process models. Objective measurements are made, simulations are run and estimates provided, all with automated process analysis.

In the process modeler, model charts are created for “as is” and “to be” processes. Charting is performed with multiple hierarchy and the ability to zoom in and out. The “as is” and “to be” process models maybe viewed at any level. External processes can be linked to the models and third party models can be imported and exported. Further, the present models can be exported to a database.

The modeler permits the simulation of “as is” and “to be” processes and the prototyping of the “as is” and “to be” process models. The modeler facilitates feedback from the user of the present invention. Another advantage is that the work cycle can be reviewed based on workflow.

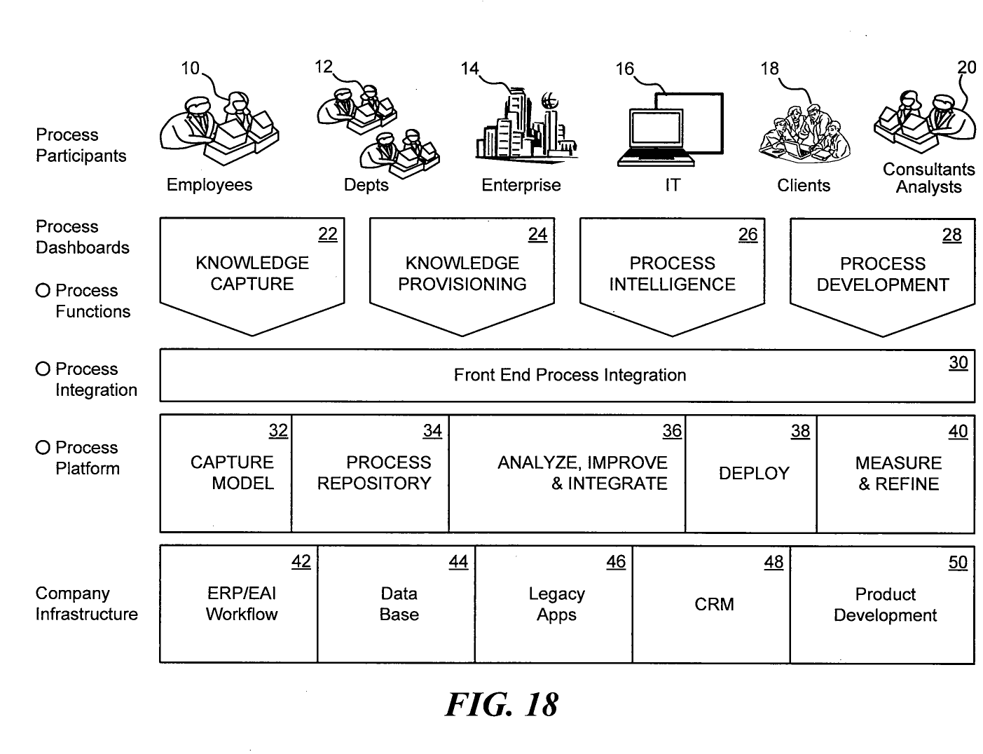

FIG. 18 illustrates the participants which can utilize the present method and system particularly as it relates to a business, including employees 10, departments 12, the entire enterprise 14, the information technology (“IT”) department 16, clients or customers 18 of the company, and consultants and analysts 20. While the present invention is being described in conjunction with a company or business, it is also foreseeable that it may be used with government agencies, non-profit institutions, and other groups, organizations, enterprises, and entities; and the scope of the invention encompasses and is applicable to any organization or entity. In FIG. 18, the process functions performed according to various embodiments and features of the invention include knowledge capture 22, knowledge provisioning 24, process intelligence 26 and process development 28. These lead to a front end process integration 30, which in turn is based upon a platform of capture and model 32, providing a process repository 34, analyze, improve and integrate the process 36, deploy the process 38, and measure and refine the process 40. This works with the company infrastructure including enterprise resource planning (“ERP”) and enterprise application integration (“EAI”) workflow 42. The company databases 44 are used as well as the legacy applications 46 in use at the company. Other departments/components of the company involved in this process can include customer relations management and product development 50 departments.

A comprehensive business process performance platform is thereby provided which incorporates front-end process integration solutions, efficiently linking business processes that people use to disparate software applications. FIG. 18 illustrates how the present system may be incorporated into the existing enterprise services architecture (“ESA”). Utilization of these improvements provides increases in personnel productivity through reduced process complexity while establishing, measuring and testing of process benchmarks.

Correlator and Pruner

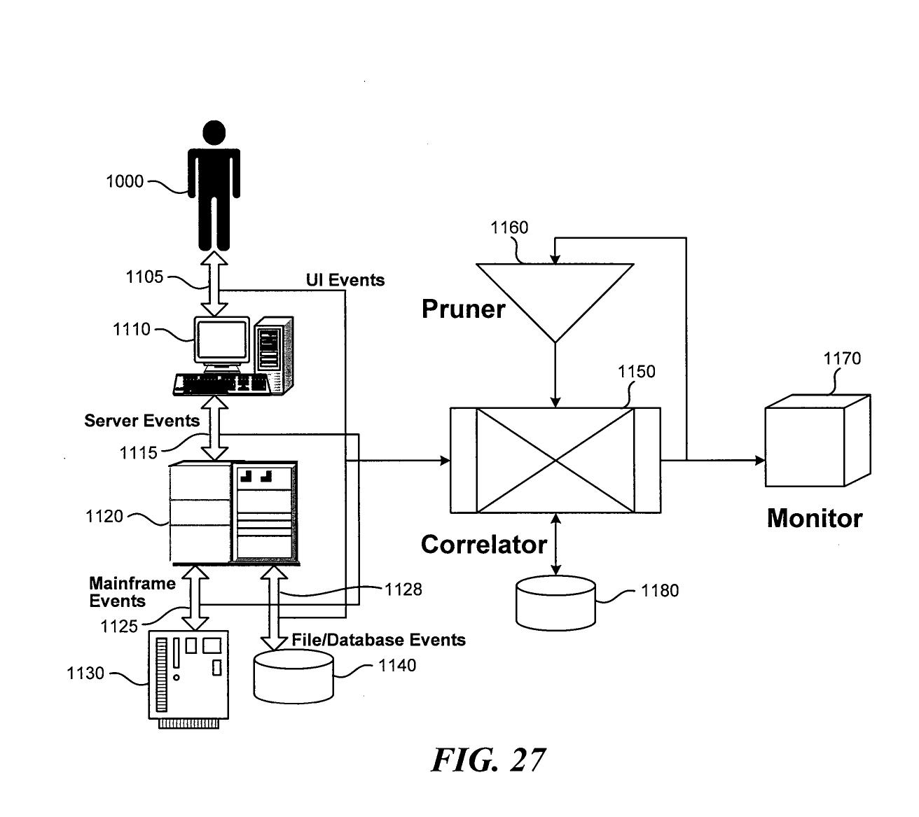

FIG. 27 is a block diagram of an embodiment that includes a correlator 1150 and a pruner 1160. A server 1110 is connected to a network. In addition, a user 1000 is connected to the network. Those skilled in the art will appreciate that the network may comprise the Internet, or a local area network, or a wide area network, or any combination thereof.

The illustrated embodiment includes one or more observer modules. The observers are placed at various points where events generated by a process are observable. The observers capture data representative of events, and the data may be stored in a data store 1140. The event data in the data repository 1140 may be sequenced or correlated by time, by application, and by user.

The correlator 1150 matches sequences of events against known or learned profiles of processes. Event sequences that closely match the profile of a process being monitored are reported to a monitor component 1170. Partial matches are retained for completion if that happens within a reasonable time interval of the last matched event; otherwise they are treated as incomplete processes. The specific time interval can be fine tuned to specific situations by practitioners of the art.

Process instances matched completely or partially by the correlator 150 form the basis for monitoring. A monitor component 1170 selects matched or partially matched process instances and checks with the data store to see if the process it is tied with is under monitoring. If it is not being monitored, a log entry to that effect is made. If it is being monitored, the contextual information and inferred information is added to the data associated with the process instance. This step adds plausible additional information that can be computed, if it is not readily available with the process instance. Then alert rules registered in the data store for the process that are in effect are matched. These rules consist of condition-action pairs. The set of matching rules is computed, prioritized and the actions associated with these rules are executed in the order of priority. The conditions can include specific process types, effective dates, predicates, comparison/boolean functions on process instance variables, etc. The actions can include any computable functions, including setting process instance variables, computing inferred data values, rule priorities, etc. Practitioners of the art can utilize any of the well known rule based systems, including OPS5, KLIPS, etc.

In the example shown in FIG. 27, a user 1000 operates a desktop computer 1110 that communicates with applications running on server 1120, which in turn communicates with mainframe computer 1130 and file store 1140. In this embodiment, observer 1105 captures data for user interface events between the user 1000 and desktop computer 1110. Observer 1115 captures data for events between the desktop computer 1110 and the server 1120. Observer 1125 captures data for events between the server 1120 and the mainframe 130. Observer 128 captures data for events between the file store 1140 and the server 1120.

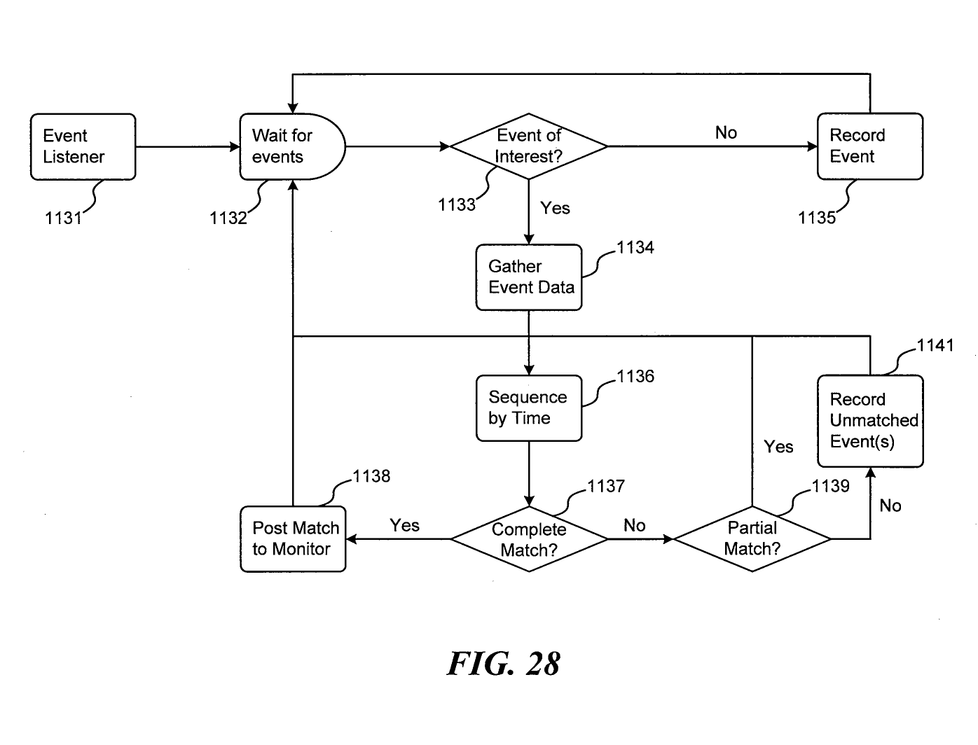

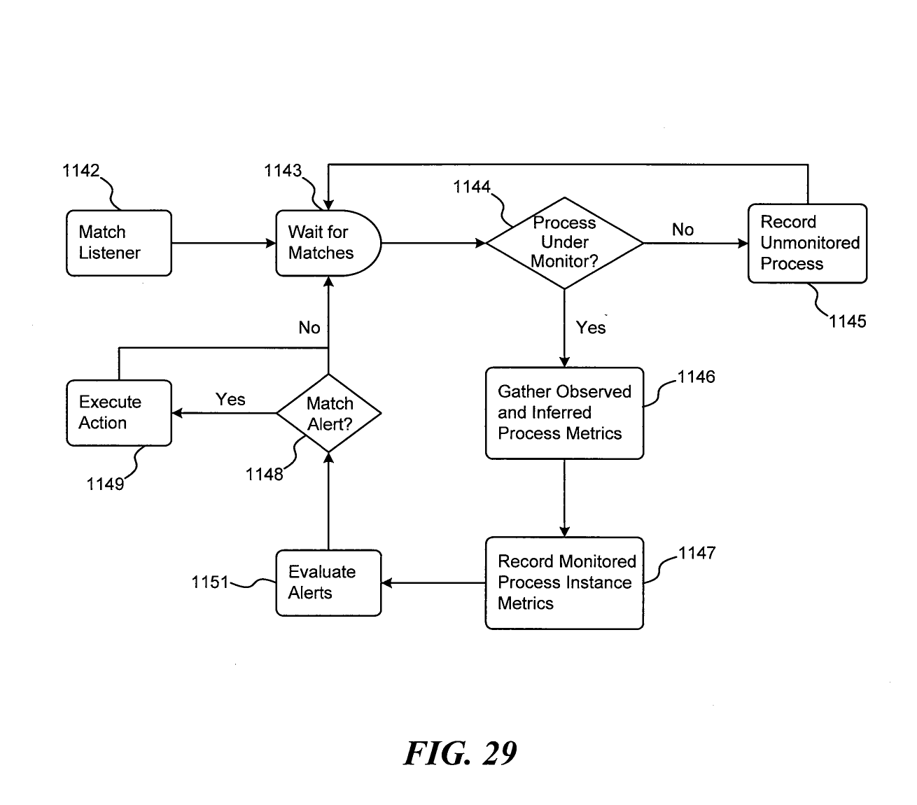

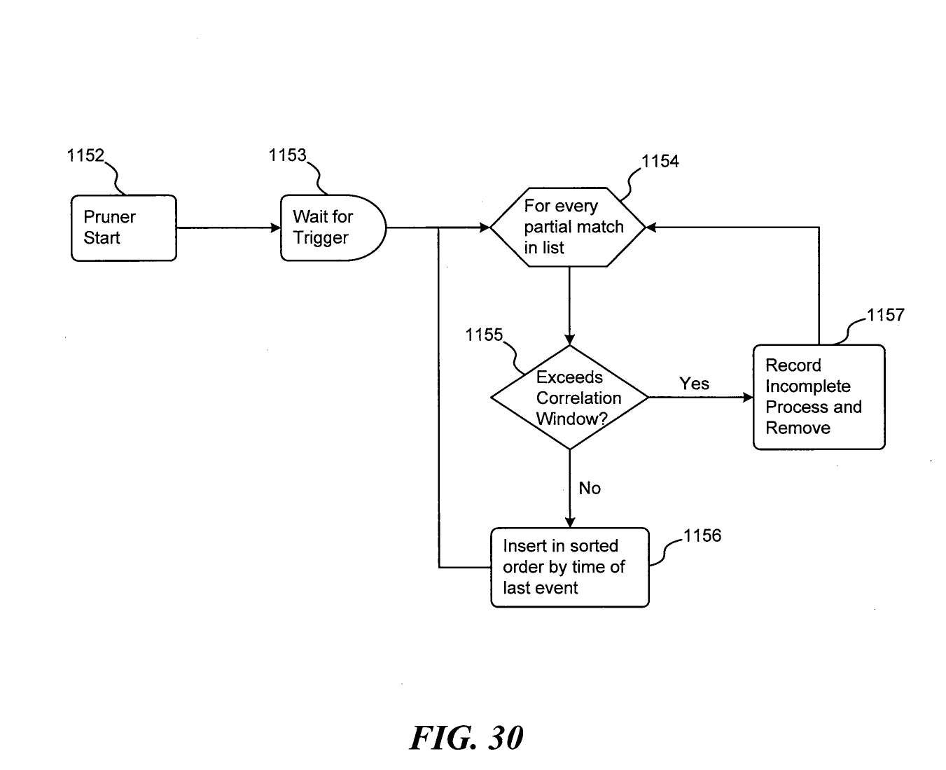

The observers and the server components maintain an accurate clock and attach the time of observation to each event that is recorded using conventional algorithms. The correlator 1150 gathers event data from various sources and sequences the data using time stamps. The correlator 1150 uses a matching algorithm illustrated by means of a flow chart in FIG. 28. The results of matches are passed to the monitor 1170, that uses the monitoring algorithm illustrated in the flow chart of FIG. 29. A pruner 1180 uses a time window based pruning algorithm illustrated in FIG. 30. This is an optimization to limit the processing time and resources spent on incomplete processes that are unlikely to complete. In this embodiment, the correlator 1150, the pruner 1160, and the monitor 1170 run in parallel using a fair interleaving technique and share the data store 1180 to store intermediate results of their computation.

A method of matching and correlating events is illustrated in the flow chart shown in FIG. 28. An event listener in step 1131 is provided for capturing user interaction data. The listener waits for event data in step 1132. When event data is received, the data is tested to determine whether it is of interest in step 1133. If it is not of interest, the event may be logged or recorded in step 1135, and the method returns to the wait state 1132. If the event is of interest in step 1133, the event data is gathered in step 1134 and placed in the most appropriate event sequence in step 1136 by using a time stamp based sort. This sequence is tested for a match against process models or known process profiles in step 1137. If there is a complete match, it is posted to a monitor in step 1138, and the method returns to the wait state 1132. If there is no complete match in step 1137, a determination is made in step 1139 of whether there is a partial match. If there is a partial match in step 1139, the method returns to the wait state 1132. If there is no partial match in step 1139, then the event is recorded as unmatched in step 1141, and the method returns to the wait state 1132. The specific algorithm for matching that is used in step 1137 or step 1139 can be one of several known techniques, including string matching, subsequence matching, matching with equivalences, etc.

A method of operation for the pruner 1160 of FIG. 27 is depicted in the flow chart shown in FIG. 30. The pruner algorithm starts in step 1152 and waits for the next triggering of its processing loop in step 1153. When the pruner 1160 is triggered in step 1153, the pruner 1160 inspects in step 1154 partially matched process instances (see step 1139) for the time duration for which they were dormant. The dormancy time is the elapsed time between the time stamp of the last event added to an instance sequence and the current time. The correlation interval is the maximum time interval within which events are to be correlated. It is a preconfigured parameter. If the time interval between two events exceeds the correlation interval in step 1155, then the incomplete process is recorded and removed in step 1157. The partial match is pruned from the partial match list to save further processing resources and the method loops back to step 1154. In step 1155, if the elapsed time is less than the correlation interval, the partial match is inserted in sorted order by time of last event in step 1156. By making the list in this order, pruning can stop when the first partial match occurring within the correlation window is found, further optimizing the computational resources.

### SUMMARY OF ADVANTAGES

The capture technology employed in the present invention uses XML scripts within and across a plurality of business applications to capture the user's interactions. For example, the menus, dialog controls, and toolbars are common elements across many business software applications. User interaction data may be captured from such common elements provided in a plurality of applications used by the user without requiring a separate capture interface for each application. Standard APIs can be used to capture user interaction data from third party applications without requiring programming access to the source code of the applications. The common elements of the capture interface are shared as between applications. Data capture may be triggered remotely on designated target user's desktop computer, or selectively invoked for certain preselected applications, by an administrator or by the user.

The present method and system provides improvements which previously were too costly to implement. The conventional methods costs about five times the time and effort to capture what is possible using the present approach. Further, certain interactions such as what exactly was done on an application is very difficult to do using only video or audio technologies. Very often questionnaires that were used missed out crucial pieces of information that are now available with the present method. The present method also allows automatic analysis and finding out who did what processes without human intervention.

The automatic process of the present method provides a cost savings of about 80% over previous approaches, automatic analysis and finding out which users performed which processes, finding out process bottlenecks much faster, digital cataloging of processes in an XML format and usage with other tools, automatic generation of content for end users. This would not have been possible but for automation of the business process capture function.

In an example of the present system applied to a large organization, the capital expenditure by the organization for enterprise applications may be on the order of about 35%. Roughly 37% of that amount may be spent on annual maintenance and updates of these applications. Of this, a rough estimate of amounts spent in various phases may be 20% for business analysis and determination of current processes, 10% for the development of “to be” processes, 40% for development and testing, 10% for deployment, and 20% for training and support.

Utilizing the present capture, analysis and modeling system gives significant savings in costs associated with business analysis and development of “to be” processes. By automatically capturing and cataloguing the processes, the present system removes the burden of manually capturing the processes. Also, the present system provides more accuracy and captures all of the information, which would not have been possible otherwise. The present system provides significant savings in the development of “to be” process through the application of the analysis and modeling technology.

The present invention contextualizes the content with the user context in an application. In other words, the user's actions are placed into context with the operations being performed on the software application so that an understanding of what is being done by the user is possible. Since actual business processes being performed by a user are captured, the accuracy of the process is never in doubt. There is no need to rely on interview and questionnaires since the actual event is being recorded. If the user's interactions accomplish what the user set out to do, the user can be sure that what has been captured is an accurate step-by-step recording of the process.

The whole interaction is available in XML format and represents a complete and detailed transcript of the process. The audio and video recording is marked with markers indicating the steps being performed and the media files between steps may be played back to determine what occurred between each captured step. The collective XML information is analogous to a relational database of financial data. Extraction and reconstruction of interactions, creation of multi-dimensional analysis and presentation of information can be performed in a myriad of ways based upon the raw data that is available as a consequence of the relentless and complete data capture provided in accordance with the present invention.

According to the invention, the data is captured once and may be rendered many times. The XML record may be used to generate several different types of output. An autogenerate function may provide a simplified process user interface that automates a human interaction with applications by asking key human fed data once. A live-in application guide may be generated. The XML record provides a complete documentation of the business process. Further, it may be used as a complete animation, simulation and test for the business process.

A further use of the XML record is to apply the content and other business logic to process context and goals. In another embodiment, the XML record is used to apply language style sheets and templates to present content in a variety of formats and languages. In yet another aspect, the XML record is used to apply benchmark tags or event notification tags to report real time process events.

The business user's processes are tracked in a desktop knowledge capture system. Business users as well as analysts and specialists obtain real time business knowledge, best practices and process information as well as front end automation and intelligence of real world business processes that are used. Context-aware applications are transformed into context-interactive applications by tracking user context.

Once a business process is captured, it can be rendered in different formats for different purposes using specific editors. By separating content from logic and presentation, flexibility in creating a rich range of content is enhanced. The invention can scale to capture any business process on any Windows® platform and can extend business process execution in a way that is agnostic of the platform, applications, or devices. It is foreseen that the present invention can envelope complex end-to-end process (cross-enterprise, multi-platform environments) execution literally at a touch of a button through new and practical user interfaces across small form factor devices or larger desktops.

In the present invention, the capture technology preferrably includes listener components. Sophisticated listeners may be advantageously provided which can listen to data exchanges within and between various kinds of applications (IE-based, Windows Applications, Java applications). The data may include Windows standard data, 16-bit data, Windows MSAA data, Java data, IE data, and SAP data. Third party applications can also use listeners to gain access to capture data or to collect information concerning selective user interaction events.

The system may utilize what is termed “deep capture” to model complex processes and workflows. High fidelity data capture may be implemented in which virtually every keyboard event and mouse event are captured, if desired. Information concerning all controls in a screen may be captured, if desired. A process definition can model even the most complex processes, and can include: linear or non-linear steps to be performed in an application; workflow elements involving branching and looping; manual tasks or legacy content; and hierarchy of steps.

The present method and system provides for the organization of capture data and information derived therefrom in a hierarchical fashion. Processes may be broken up into sub-processes, and this may be done while capturing itself. For example, the first ten steps of a process can be combined and grouped under a sub-process “enter order information”. Tracking and content automatically inherits the hierarchy definition of the process. In addition to the capture, the present technology also includes process modeling, auto generation of content, auto generation of performance support components, auto generation of a process from process interactions, auto creation of a process model given a set of processes carried out by the users, and WYSIWIG complex content creation (including decision points).

The above description has sometimes been with reference to to user workstations and/or desktops. It should be appreciated by those skilled in the art that a workstation or desktop may alternatively be a personal computer, a laptop, a notebook computer, a terminal, a PDA, a cellphone with computational capability, a programmable calculator, or any other computational tool capable of running applications and being used to perform business processes.

There are several embodiments of our invention possible based on the context of use. Such embodiments can be custom tailored to handle a single application on a particular computer or a class of applications on a class of computers. The most interesting embodiments are those covering a variety of applications on a variety of computers, such as the alternate embodiment described above. Practitioners of the art can realize several such embodiments based on the coverage needed in specific situations.

The above-described specific embodiments of the invention are provided as examples only, and the principles of the present invention may be applied to many variations of the systems for monitoring semi-automated processes involving humans using computer applications. Practitioners of the art can derive several embodiments and domains of applicability of our invention. It will be apparent to practitioners of the art who have the benefit of the present disclosure that the present invention may be advantageously applied to a number of alternative embodiments.

The preferred embodiment may be used in connection with an operating system having a graphical user interface or a Windows® based operating system, in Internet Explorer® based applications, in Java based applications, and in SAP (Server Application Programming) applications. In addition, specific applications such as CATIA (Computer-Aided Three-Dimensional Interactive Application), Solidworks and Pro Engineer may be utilized in connection with the present invention. The principles of the present invention are not limited to the operating system or any particular software application, and can be applied to nearly any software application and/or business process. A software development kit of application programming interfaces or APIs may be provided to allow easy programmatic extension to any application environment. The principles disclosed herein for the present invention can also extend to an application which does not have a graphical user interface.

The use of an XML format for process information is particularly useful in the present method and system. The XML format is self descriptive, and lends itself to extensive manipulation by modeling and programming, or to examination and analysis through database querying, mining or pattern searching. Other languages or process definitions for the process capture and manipulation are of course possible and are envisioned for use in connection with the present invention.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in a digital storage medium. Any suitable computer-readable storage medium may be utilized, including hard disks, CD-ROM, optical storage devices, magnetic storage devices, and/or the like.

Those skilled in the art will recognize that other configurations of a server and network may be utilized. For example, a plurality of servers may be employed in a distributed network. Separate servers may be used for web sites, or an independent service provider may host the web sites. A first server may be employed for resources visible to users of the Internet, and a separate server used which is accessible only by users of an internal network or intranet. The network may comprise one or more local area networks or LANs connected to the Internet. Software functionality illustrated as residing on a server may instead be implemented in the computers used by the users.

The present invention is described herein with reference to block diagrams (e.g., systems) and flowchart illustrations of methods according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine or system, such that the instructions which execute on the computer or other programmable data processing apparatus are configured to perform the functions specified in the flowchart block or blocks.

The flowcharts, illustrations, and block diagrams of the above-described figures illustrate the architecture, functionality, and operation of possible implementations of apparatus, systems, methods and computer program products according to various embodiments of the present invention. In this regard, each block in the flow charts or block diagrams may represent a module, electronic component, segment, or portion of code, which comprises one or more executable instructions for implementing the specified function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

As will be appreciated by one of skill in the art, aspects of the present invention may be embodied as a method, data processing system, or computer program product. Accordingly, aspects of the present invention may take the form of an entirely software embodiment or an embodiment combining software and hardware aspects, all generally referred to herein as a device. Furthermore, elements of the present invention may take the form of a computer program product on a computer-usable storage medium having computer-usable program code embodied in the medium. Any suitable computer readable medium may be utilized, including hard disks, CD-ROMs, optical storage devices, flash RAM, transmission media such as those supporting the Internet or an intranet, or magnetic storage devices.

Computer program code for carrying out operations of the present invention may be written in an object oriented programming language such as Javae, Python or C++, or in conventional procedural programming languages, such as the “C” programming language or Perl. The program code may execute entirely on the user's computer, partly on the user's computer, as a stand-alone software package, partly on the user's computer and partly on a remote computer/server, or entirely on the remote computer or a plurality of computers. In the latter scenario, the remote computer(s) may be connected to the user's computer through a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks, and may operate alone or in conjunction with additional hardware apparatus described herein.

It should be appreciated that the particular implementations shown and described herein are illustrative of the invention and include its best mode known to the inventors, but are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present, for example, in a practical electronic network or transaction system.

Those skilled in the art will appreciate, after having the benefit of this disclosure, that various modifications may be made to the specific embodiment of the invention described herein for purposes of illustration without departing from the spirit and scope of the invention. The description of a preferred embodiment provided herein is intended to provide an illustration of the principles of the invention, and to teach a person skilled in the art how to practice the invention. The invention, however, is not limited to the specific embodiment described herein, but is intended to encompass all variations within the scope of the claims appended hereto.

What is claimed is:

1. A system for capturing information representative of user interaction with a desktop computer and analyzing said capture data to identify business processes, comprising:
a listener in operative association with a desktop computer, the listener being operative to capture information representative of user interaction with the desktop computer, the listener being operative to produce digital capture data corresponding to said information;
a desktop observer in operative association with a desktop computer, said desktop observer being coupled to the listener to receive said digital capture data, the desktop observer being coupled to a communication link for providing said digital capture data to an intelligence server;
a temporary store coupled to the desktop computer for storing said digital capture data received from the desktop listener;
an intelligence server coupled to the communications link for receiving digital capture data from the desktop observer, the intelligence server comprising a process discovery module for analyzing said digital capture data to identify business processes performed by said user interaction, the intelligence server providing an output information relating to said business processes.
